(19) United States
(12) Patent Application Publication
(10) Pub. No.: US 2024/0189980 A1
(43) Pub. Date: Jun. 13, 2024

(54) EXOSUIT DEVICE AND METHOD FOR EXOSUIT MODELING AND DESIGN

(71) Applicant: Board of Regents, The University of Texas System, Austin, TX (US)

(72) Inventors: Nicholas Fey, Jonestown, TX (US); Ross Neuman, Austin, TX (US)

(21) Appl. No.: 18/359,521

(22) Filed: Jul. 26, 2023

Related U.S. Application Data
(60) Provisional application No. 63/369,462, filed on Jul. 26, 2022.

(51) Int. Cl. B25J 9/00; B25J 9/10; B25J 9/16

(52) U.S. Cl. CPC B25J 9/0006; B25J 9/1045; B25J 9/1694

(57) ABSTRACT

Aspects of the present invention relate to methods for informing the design of exosuits using modeling and optimization methods, and a soft exosuit device including a belt having a plurality of loops attached thereto, and a plurality of attachment regions between each loop on the belt, configured to be positioned around a subject, one or more brackets slidably attached to the belt and positionable within the one or more attachment regions, each bracket having one or more belt attachment points, at least one brace having one or more brace attachment points configured to be positioned around a body part of the subject, at least one element having a first fastener at a proximal end removably attached to a belt attachment point and a second fastener at a distal end, removably attached to a brace attachment point.

### CROSS-REFERENCE TO RELATED APPLICATIONS

This application claims priority to U.S. Provisional Application No. 63/369,462, filed on Jul. 26, 2023, incorporated herein by reference in its entirety.

### STATEMENT REGARDING FEDERALLY SPONSORED RESEARCH OR DEVELOPMENT

This invention was made with government support under Grant no. CMMI2054343 awarded by the National Science Foundation. The government has certain rights in the invention.

### BACKGROUND OF THE INVENTION

Exosuits are an emerging technology with potential applications in a range of areas for both healthy and patient populations. Currently, exosuits are being used in manual labor, such as factory work, to reduce biomechanical stresses and prevent injury. In healthcare applications, exosuits are being investigated for mobility assistance in the elderly, neurological patient populations (Parkinson's, multiple sclerosis, stroke, TBI), and amputees. Exosuits are also being developed for increasing the ability of healthy individuals by lowering the metabolic cost of various tasks including lifting, load carriage, and running.

Soft exosuits are assistive devices that can augment a user's movements while maintaining a clothing-like form factor. Soft exosuits are flexible, providing assistance with fewer restrictions to range of motion and user size and shape when compared to rigid designs. However, complications often arise when providing soft exosuits sized and configured for individuals with different needs. The biomechanical goals of the individual produce variables with numerous considerations and design choices. In order to design and optimize soft exosuits capable of targeting an individual's specific biomechanical goals and needs, it is important to develop methods for efficiently configuring and sizing the components.

Thus, there is the need in the art for a soft exosuit device, and a method for configuring and sizing the soft exosuits devices that best address the individual and their biomechanical goals. The present invention meets this need.

### SUMMARY OF THE INVENTION

Aspects of the present invention relate to a soft exosuit device including a belt having a plurality of loops attached thereto, and a plurality of attachment regions between each loop on the belt, configured to be positioned around a subject, one or more brackets slidably attached to the belt and positionable within the one or more attachment regions, each bracket having one or more belt attachment points, at least one brace having one or more brace attachment points configured to be positioned around a body part of the subject, at least one element having a first fastener at a proximal end removably attached to a belt attachment point and a second fastener at a distal end, removably attached to a brace attachment point.

In some embodiments, the belt has a base layer and an outer belt, both extending the length of the belt, the base layer having the plurality of loops, and the outer belt passing through the loops of the base layer, with the brackets slidably attached to the outer belt, each bracket positioned within an attachment region.

In some embodiments, the one or more brackets include a first bracket positioned in a medial attachment region on the belt providing a medial belt attachment point, and a second bracket positioned in a lateral attachment region on the belt providing a lateral belt attachment point. In some embodiments, the one or more attachment points on the brace have a left lateral brace attachment point and a right lateral brace attachment point.

In some embodiments, the at least one element includes a first element attached to the medial belt attachment point and the right lateral brace attachment point, and a second element attached to the lateral belt attachment point and the left lateral brace attachment point. In some embodiments, the device further includes a pair of adjustable suspenders fixedly attached to the belt and configured to be positioned over shoulders of the subject.

In some embodiments, the elements are elastic resistance bands having a stiffness ranging between 1 N/m and 1000 N/m. In some embodiments, the elements have elements selected from the group consisting of: elastic bands, resistance bands, linear actuators, motor-actuated cables, springs and struts. In some embodiments, the belt has a total number of loops ranging between 2 and 40 loops. In some embodiments, the base layer includes neoprene and the outer belt includes nylon.

In some embodiments, the belt has one or more adjusters along the length of the belt configured to adjust the length of the belt. In some embodiments, the elements have one or more adjusters along the length of the elements configured to adjust the length of the elements. In some embodiments, the fasteners are selected from the group consisting of hooks, clips, buckles, clasps, buttons, snaps, toggles and hook and loop.

Aspects of the present invention relate to a method of designing a soft exosuit device having the steps of providing one or more biomechanical goals for a subject, providing any exosuit device of the present invention, positioning the one or more brackets to one or more attachment regions along the length of the belt, adjusting the elements to achieve the one or more biomechanical goals.

In some embodiments, the step of configuring the device includes adjusting the position of the device on the subject vertically or rotating the device mediolaterally. In some embodiments, the step of positioning the one or more brackets to the one or more attachment regions includes positioning a first bracket to a medial attachment region on the belt, and a second bracket to a lateral attachment region on the belt.

In some embodiments, the step of adjusting the elements includes applying a preload to the elements. In some embodiments, the step of adjusting the elements includes any of adjusting the stiffness, elongation, or rest length of the elements. In some embodiments, the step of adjusting the elements includes adjusting the length or width of the bands.

In some embodiments, the one or more biomechanical goals are selected from the group consisting of: a kinematic goal, influencing the kinematics of a limb, influencing a desired motion in a limb, increasing/decreasing flexion of a joint, increasing/decreasing extension of a joint, modulating internal/external rotation of a joint, increasing/decreasing kinematic asymmetry between the limbs, increasing/decreasing inter-limb muscle activation asymmetry, reducing the metabolic cost of movement in the subject, and reducing the swinging of a limb on the subject.

Aspects of the present invention relate to a method of fabricating an exosuit for assisting at least one movement of a subject having the steps of generating an estimated surface mesh of a subject, calculating an estimated controlling skeleton within the surface mesh, comprising a set of joint vertices and edges, calculating a set of poses which, performed successively, form the at least one movement, calculating a set of lines of action, each having a first and second attachment point on the surface mesh and a corresponding moment arm about a corresponding joint vertex of the set of joint vertices, calculating a maximum power generating ability of each line of action, selecting a desired line of action from the set of lines of action having the maximum power generating ability about the corresponding joint vertex across the poses in the set of poses, and building an exosuit having an element attached at the first and second attachment points of the desired line of action.

In some embodiments, the element includes a hip flexion element, a spring, a linear actuator, a motor-actuated cable, an elastic band, or a strut configured to assist in movement of a hip of the subject. In some embodiments, the exosuit is configured to be anchored to a waist of the subject. In some embodiments, the at least one movement is a stride. In some embodiments, the stride is selected from a level stride, an inclined stride, or a staircase climbing stride. In some embodiments, the first and second attachment points are on a waist and a thigh of the subject, respectively.

An exosuit produced by any disclosed method, further including at least one motor configured to dynamically modulate the first or second attachment position. In some embodiments, the at least one motor is configured to dynamically modulate the first or second attachment position during ambulation of the subject.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1 is a diagram of a computing device.

FIG. 2 is a diagram of an exosuit device (in some examples referred to as a passive hip flexion orthosis) according to aspects of the present invention. Shown in the diagram are exemplary attachment points for elements of the exosuit device according to aspects of the present invention. In some embodiments, the device is modelled in OpenSim 4.1 using bilateral linear spring elements whose force-elongation curves are informed by human shape modelling. In some embodiments, the attachment points remain static in the analysis, and only the rest length and elongation (of the elements) are changed. In some embodiments, a generic 23-degree-of-freedom, 54-muscle musculoskeletal model is scaled to match the experimental data gathered from each user.

FIG. 3 are graphs of moment arm about the hip created by an element and element length against BMI and hip angle. FIG. 3A shows a graph for the moment arm about the hip based on BMI and hip angle. FIG. 3B shows a graph for the element length based on BMI and hip angle. The moment arm and element length predictions are based on user BMI and hip angle. Gaussian process regression was used to train predictive models outputting the moment arm (FIG. 3A) and the element length (FIG. 3B) for the given hip angle and BMI percentile. The shown models were trained for female subjects with the exosuit device in a fixed position.

FIG. 4A is a schematic diagram of an exemplary method of the disclosure according to aspects of the present invention. Shown in the diagram and method is an optimization framework overview. In some embodiments, experimental data is used to inform musculoskeletal and human shape modeling pipelines, which are fed to the static optimization algorithm in order to estimate muscle activations. In some embodiments, activation asymmetries are the cost function that the Bayesian optimization algorithm attempts to minimize by adjusting the resting length and stiffness of each contracting element in the exosuit device. In some embodiments, Bayesian optimization treats the problem as a black box, i.e., no information about the modeling process is fed to the optimizer.

FIG. 4B is a diagram of exemplary attachment points for an exosuit device relative to a simulated skeleton according to aspects of the present invention.

FIG. 4C are various exemplary attachment points for an exosuit device relative to simulated skeletons having different body shapes.

FIG. 5A is a diagram showing human shape factors in exosuit device design according to aspects of the present invention. FIG. 5B and FIG. 5C are graphs of actuator (or element) and moment arm length against gait cycles for various body types. FIG. 5B is a graph of actuator (or element) length against gait cycle. FIG. 5C is a graph of sagittal moment arm length against gait cycle.

FIG. 6A, FIG. 6B, and FIG. 6C are graphs of cost function values for each iteration of an exosuit device. The costs are calculated at each objective function evaluation following seeding. Both estimated minimum objective (green) as calculated by the acquisition function, and minimum observed objective (blue) are shown.

FIG. 7A depicts an exemplary exosuit device according to aspects of the present invention. FIG. 7B through FIG. 7E depict an exemplary belt for an exosuit device according to aspects of the present invention. FIG. 7F depicts exemplary elements for an exosuit device according to aspects of the present invention. FIG. 7G depicts an exemplary brace for an exosuit device according to aspects of the present invention. FIG. 7H depicts exemplary suspenders for an exosuit device according to aspects of the present invention.

FIG. 8 shows plots for an overview of band (or element) conditions results. Shown are peak flexion and extension angles, average positive, negative, and net work, and average muscle activity. Orange blocks indicate results significantly greater than N1 condition, blue blocks indicate results significantly less than N1, great blocks represent no significant difference. Empty blocks are due to unusable EMG signals.

FIG. 9 shows plots for an overview of baseline conditions results. Shown are peak flexion and extension angles, average positive, negative, and net work, and average muscle activity. Orange blocks indicate results significantly greater than N1 condition, blue blocks indicate results significantly less than N1, grey blocks represent no significant difference. Empty blocks are due to unusable EMG

FIG. 10A and FIG. 10B show graphs of joint trajectories for multiple sclerosis (MS) subjects vs control subjects. FIG. 10A shows time-normalized joint trajectories for MS plotted over the gait cycle for hip, knee, and ankle. FIG. 10B shows control subjects plotted over the gait cycle for hip, knee, and ankle.

FIG. 11A and FIG. 11B show graphs for hip energetics for multiple sclerosis (MS) subjects vs control subjects. FIG. 11A shows hip power curves over gait cycle and corresponding positive, negative, and net work results for the MS subject group. FIG. 11B shows hip power curves over gait cycle and corresponding positive, negative, and net work results for the control subjects group.

FIG. 12 shows graphs for inter-limb peak hip flexion comparison. The graphs show the difference in degrees between the unassisted and assisted leg peak hip flexion angle across all trials for the MS subject group. Bars indicate pairwise significant difference from N1 trial.

FIG. 13 depicts an adjustable staircase setup wherein strides are defined as shown. Transition (TR) strides are those which only ascend or descend the height of a single step. Feet in this picture are oriented to depict stair ascent, but the TR and stair walking (SW) strides are defined the same way in either direction.

FIG. 14 shows the results from statistical parametric mapping (SPM) analysis of walk-to-stair transitions. Solid lines indicate the mean joint angle trajectories of the n=10 subjects for level walking (LW), walk-to-stair TR, and SW, plotted over a full gait cycle. Foot-off is indicated by the dotted line. Shaded regions indicate statistically significant (p<0.05) differences between stride types as determined by paired SPM t-tests. Green regions indicate differences between level walking and transition strides, while blue regions represent differences between transitions and stair walking. Areas of overlap between the blue and green regions appear darker green, and represent the areas where transition kinematics are considered unique from either steady-state task.

FIG. 15 show the results from SPM analysis of stair-to-walk transitions. Solid lines indicate the mean joint angle trajectories of the subjects for LW, walk-to-stair TR, and SW, plotted over a full gait cycle. Foot-off is indicated by the dotted line. For the stair descent to level walking results, n=10 subjects, and for the stair ascent to level walking results, n=6 subjects. Shaded regions indicate statistically significant (p<0.05) differences between stride types as determined by paired SPM t-tests. Green regions indicate differences between level walking and transition strides, while blue regions represent differences between transitions and stair walking. Areas of overlap between the blue and green regions appear darker green, and represent the areas where transition kinematics are considered unique from either steady-state task.

FIG. 16A, FIG. 16B and FIG. 16C show the effects of incline angle on stair walking tasks. FIG. 16A shows incline effect on steady-state stair walking. FIG. 16B shows incline effect on walk-to-stair transitions. FIG. 16C shows incline effects on stair-to-walk TR. Solid lines indicate mean joint angle trajectories averaged across all subjects for a complete gait cycle. Average foot-off for each task is indicated by the vertical dotted line. Shaded regions indicate significant p<0.05 main effects due to stair incline as determined by an SPM 1-way ANOVA.

FIG. 17A and FIG. 17B shows gaussian process regression surfaces for various transitions vs strides. FIG. 17A shows the comparison of joint angles predicted by Gaussian process regression models of steady-state stair and walk-to stair tasks across all inclines. FIG. 17B shows surfaces comparing joint angles predicted by Gaussian process regression models of steady-state stair and stair-to-walk tasks. The surfaces shown represent the expected value of the Gaussian process given the incline, gait phase, and task.

FIG. 18 shows model error (root mean square error (RMSE)) in degrees for Gaussian process regressions based on leave-one-stride-out cross validation for ascending (left) and descending (right). Black lines indicate significant (p<0.05) pairwise difference between means as determined by a Tukey-Kramer test. Ankle, knee, and hip joints are grouped by color and differentiated by shading according to the legend.

FIGS. 19A and 19B depict a moment arm comparison for subjects of varying body-mass index (BMI). Shown is the difference in moment arm (green) developed by a contracting element (blue) for subjects with two different BMIs. While relative attachment locations and hip angles are the same, the moment arm is greater in the higher-BMI subject (FIG. 19B) than in the lower-BMW subject (FIG. 19A) due to the subject's surface geometry.

FIG. 20 shows various subject surface models. Shown are images of the surface models used for each subject, along with subject BMI and mass (kg). All male subjects are 1.76 m and all female subjects are 1.62 m.

FIG. 21A, FIG. 21B, FIG. 21C, FIG. 21D, and FIG. 21E show an overview of an exosuit device modeling system according to aspects of the present invention. FIG. 21A shows how joint angles obtained from gait kinematics are used to position the bones of the controlling skeleton (FIG. 21B), which informs the deformation of the surface mesh. FIG. 21C shows how a wrapping algorithm determines the behavior of the contracting element to simulate the compliant mechanics of a soft exosuit device. FIG. 21D shows the element length, and FIG. 21E shows the moment arm it creates about the hip joint are returned for the given pose.

FIG. 22 depicts a naming scheme for attachment points of an exemplary exosuit device according to aspects of the present invention. Shown is an exemplary depiction of a grid that is superimposed upon the areas of interest for attachment points, and how the proximal P(a, b) and distal D(a,b) attachment points are named according to the grid.

FIG. 23 shows plots for attachment location efficacy. Shown are heatmaps depicting the efficacy of all attachment configurations tested, with results averaged over all subjects. Each grid represents all possible terminations for a given attachment point, consistent with the naming scheme in FIG. 22. Proximal and distal heatmaps are complimentary depictions of the same results.

FIG. 24 shows graphs for moment arm and element length vs hip range of motion (ROM) for various proximal attachment points. Shown are the effects on moment arm length about the hip joint, and the length of the contracting element when location of proximal attachment point is vertically modulated.

FIG. 25A and FIG. 25B show various graphs for power-generating ability vs gait and peak power vs BMI. FIG. 25A shows power-generating potential during level walking—the power vs gait phase is plotted for female (left) and male (middle) cohorts, and a comparison of peak power with BMI and sex (right). FIG. 25B shows peak power by sex and BMI for five different locomotor tasks.

FIG. 26 depicts an exemplary device configuration according to aspects of the present invention. In some embodiments, two elastic bands span the hip joint, and their waist anchoring position can be adjusted mediolaterally (ML) or vertically (Z) in the optimization. The potential points are discretized into a grid (8 mediolateral by 4 vertical locations) that is superimposed on each subject's waist between the midline and the frontal plane.

FIG. 27 depicts a diagram of experimental methods for an exemplary modelling and simulation process. As shown, Bayesian optimization forms the outer loop, which treats the modeling and simulation processes (shaded area) as a black box function, and attempts to minimize the estimated metabolic cost of walking. In some embodiments, for both bands or elements on the exosuit device, the stiffness, rest length, medio-lateral attachment, and vertical attachment positions are passed into the function for a total of 8 optimizable variables. In some embodiments, after the simulations are run, the metabolic cost is reported, which is used to update the Bayesian acquisition function, and 8 new parameter values are chosen. In some embodiments, inside the black box function, the shape modeling system takes the device configuration, 3D surface model, and joint kinematics of the user, and calculates the forces contributed by the exosuit. In some embodiments, these forces, along with the musculoskeletal model, ground reaction forces (GRFs), and joint kinematics, are the inputs for computed muscle control (CMC), a muscle-driven dynamic gait simulation technique. In some embodiments, the CMC returns muscle states that are used to estimate the metabolic cost of the motion.

FIG. 28 depicts optimal configurations for an exemplary exosuit device for the respective metabolic goal according to aspects of the present invention. Shown are optimal configurations for each subject based on metabolic cost. Band colors correspond to the combined effects of band stiffness and resting length, where higher forces correspond to “aggressive” on the scale. Stronger/dominant and weaker/non-dominant legs are indicated for each subject.

FIG. 29A and FIG. 29B show average metabolic reductions for MS subjects group and control subjects group. Shown are bar graphs comparing average metabolic expenditure at baseline (FIG. 29B) with the device at optimal configuration (FIG. 29A) (from metabolic optimization).

FIG. 30 shows graphs for metabolic objective function evaluations. Shown are graphs showing cost at each objective function evaluation for each subject.

FIG. 31 shows plots for optimal configurations for a symmetry goal. Shown are optimal configurations for each subject based on muscle excitation symmetry. Band colors correspond to the combined effects of band stiffness and resting length, where higher forces correspond to “aggressive” on the scale. Stronger/dominant and weaker/non-dominant legs are indicated for each subject.

FIG. 32A and FIG. 32B show graphs for asymmetry reductions for MS subjects group and control subjects group. Shown are bar graphs comparing excitation asymmetry at baseline (FIG. 32B) and with the device at optimal configuration (FIG. 32A) (from asymmetry optimization).

FIG. 33 shows graphs for symmetry objective function evaluations for MS subjects groups (top row) and control subjects groups (bottom row). The shown graphs describe cost at each objective function evaluation for each subject.

FIG. 34 shows plots for the correlations between metabolic and symmetry costs. Shown is the correlation between metabolic and symmetry costs for all function evaluation. Datapoints are colored according to their optimization context (i.e. whether they are seed points, called by the symmetry optimization, or called by the metabolic optimization). Each plot reports the Pearson correlation coefficient, r, and the p-value, p, for the correlation.

FIG. 35 shows graphs for the exosuit device hip moment contributions for the MS subjects group. Shown are the hip moments contributed by the exosuit device plotted over the gait cycle (heel strike at 0% and 100%), grouped by the subjects' stronger and weaker sides. Positive rotation indicates external rotation.

FIG. 36 shows graphs for the exosuit device hip moment contributions for the control subjects group. Shown are the hip moments contributed by the exosuit plotted over the gait cycle (heel strike at 0% and 100%), grouped by the subjects' dominant and non-dominant sides. Positive rotation indicates external rotation.

FIG. 37 shows graphs for the metabolic reduction by muscle. Shown are the reductions in metabolic cost for individual muscles when using optimal exosuit configuration. Negative values indicate that the optimal configuration produced a greater metabolic cost than baseline (no-device) for that muscle.

FIG. 38 shows graphs for asymmetry change by muscle. Shown are the changes in excitation asymmetry for selected muscles. Asymmetry is expressed here as (strong leg—weak leg), so bars pointing to the right indicate more excitation in the strong leg. Closer to zero indicates greater symmetry.

### DETAILED DESCRIPTION

It is to be understood that the figures and descriptions of the present invention have been simplified to illustrate elements that are relevant for a clear understanding of the present invention, while eliminating, for the purpose of clarity, many other elements found in related systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of 20%, ±10%, +5%, ±1%, and ±0.1% from the specified value, as such variations are appropriate.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

The terms “patient,” “subject,” “individual,” “user”, and the like are used interchangeably herein, and refer to any animal amenable to the systems, devices, and methods described herein. The patient, subject, individual or user may be a mammal, and in some instances, a human.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PUP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

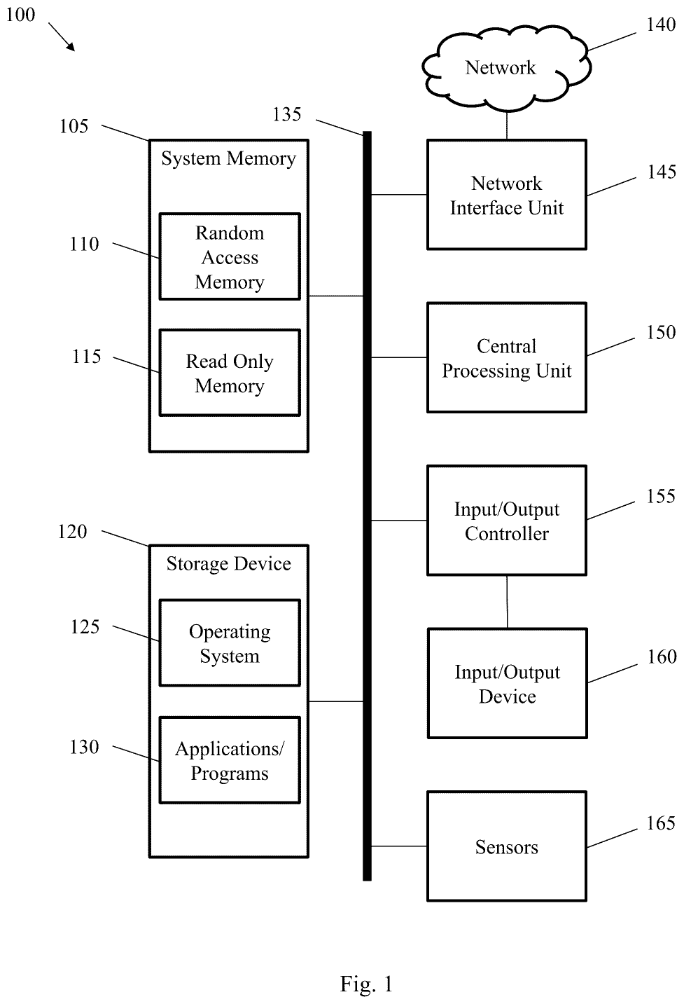

FIG. 1 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 1 depicts an illustrative computer architecture for a computer 100 for practicing the various embodiments of the invention. The computer architecture shown in FIG. 1 illustrates a conventional personal computer, including a central processing unit 150 (“CPU”), a system memory 105, including a random access memory 110 (“RAM”) and a read-only memory (“ROM”) 115, and a system bus 135 that couples the system memory 105 to the CPU 150. A basic input/output system containing the basic routines that help to transfer information between elements within the computer, such as during startup, is stored in the ROM 115. The computer 100 further includes a storage device 120 for storing an operating system 125, application/program 130, and data.

The storage device 120 is connected to the CPU 150 through a storage controller (not shown) connected to the bus 135. The storage device 120 and its associated computer-readable media provide non-volatile storage for the computer 100. Although the description of computer-readable media contained herein refers to a storage device, such as a hard disk or CD-ROM drive, it should be appreciated by those skilled in the art that computer-readable media can be any available media that can be accessed by the computer 100.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 100 may operate in a networked environment using logical connections to remote computers through a network 140, such as TCP/IP network such as the Internet or an intranet. The computer 100 may connect to the network 140 through a network interface unit 145 connected to the bus 135. It should be appreciated that the network interface unit 145 may also be utilized to connect to other types of networks and remote computer systems.

The computer 100 may also include an input/output controller 155 for receiving and processing input from a number of input/output devices 160, including a keyboard, a mouse, a touchscreen, a camera, a microphone, a controller, a joystick, or other type of input device. Similarly, the input/output controller 155 may provide output to a display screen, a printer, a speaker, or other type of output device. The computer 100 can connect to the input/output device 160 via a wired connection including, but not limited to, fiber optic, Ethernet, or copper wire or wireless means including, but not limited to, Wi-Fi, Bluetooth, Near-Field Communication (NFC), infrared, or other suitable wired or wireless connections.

As mentioned briefly above, a number of program modules and data files may be stored in the storage device 120 and/or RAM 110 of the computer 100, including an operating system 125 suitable for controlling the operation of a networked computer. The storage device 120 and RAM 110 may also store one or more applications/programs 130. In particular, the storage device 120 and RAM 110 may store an application/program 130 for providing a variety of functionalities to a user. For instance, the application/program 130 may comprise many types of programs such as a word processing application, a spreadsheet application, a desktop publishing application, a database application, a gaming application, internet browsing application, electronic mail application, messaging application, and the like. According to an embodiment of the present invention, the application/program 130 comprises a multiple functionality software application for providing word processing functionality, slide presentation functionality, spreadsheet functionality, database functionality and the like.

The computer 100 in some embodiments can include a variety of sensors 165 for monitoring the environment surrounding and the environment internal to the computer 100. These sensors 165 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

Aspects of the present invention relate to soft exosuit devices and methods of optimizing thereof. Soft exosuits conform to the body and generate joint moments by developing tension in joint-spanning elements, thus relying on the human body for the mechanical transmission of energy from the device to the targeted joint(s). As a result, mechanical energy delivery of an exosuit is dependent on the specific shape of the user and their movements. The disclosed device and method use information about a user's shape and movements to quantify the power-generating ability for a given exosuit configuration and its actuation, and includes a corresponding method to optimize these device parameters to achieve the desired assistance. In a clinical setting, this method can be used as a tool for informing the initial and final device configuration, facilitating better communications between the clinician's expertise, the engineer's knowledge of the device, and the user's experience. In a non-clinical setting such as in the home, gym or workplace, any disclosed device and method may be used in an analogous manner to enhance or augment the physical abilities of able-bodied individuals.

Aspects of the present invention relate to a soft exosuit device for, in one example, providing passive flexion orthosis to one or more joints on a subject. In some embodiments, the disclosed exosuit device is a flexion orthosis configured to provide unilateral or bilateral assistance to one or more joints on a subject. The disclosed exosuit device is configured to attach to a subject in at least two locations (e.g. around the waist and around the thigh or knee) to create a passive flexion moment (e.g. about the hip joint). In some embodiments, the disclosed exosuit device aids in rotational stability during flexion by providing an assistive moment about the respective joint. In some embodiments, the disclosed exosuit device stores and releases mechanical energy throughout a flexion-extension cycle (e.g. a gait cycle). In some embodiments, the disclosed exosuit device stores energy during extension of a joint (e.g. hip extension in stance), and releases the stored energy to assist flexion (e.g. upon swing initiation of the leg). In some embodiments, the disclosed exosuit device passively augments flexion of an impaired joint (e.g. hip flexion in an impaired gait). Although examples herein may depict exosuit devices assisting the hip joint, it should be understood that any methods and devices disclosed herein may be adapted to assist other joints including, but not limited to, any lower (hip, knee, ankle, lumbar) or upper (shoulder, neck, elbow, wrist, fingers) limb joints.

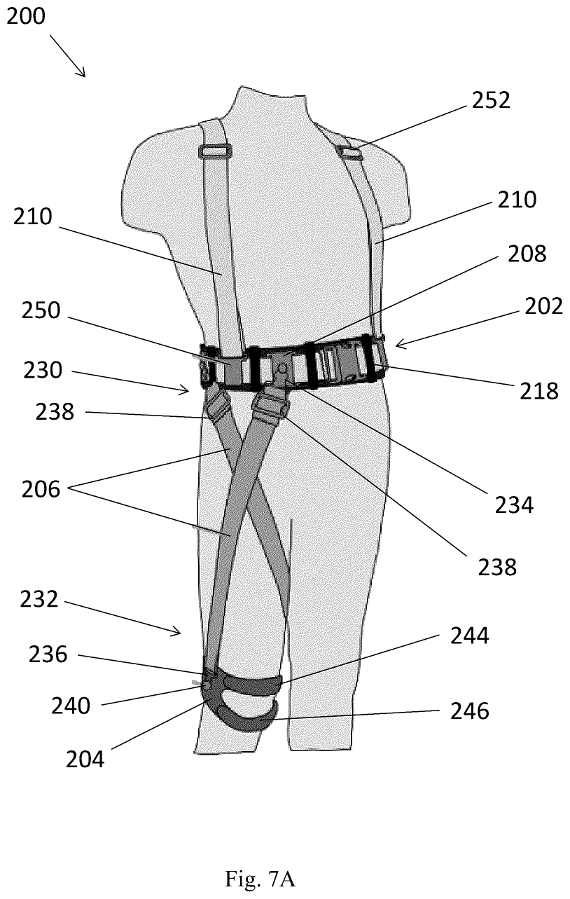

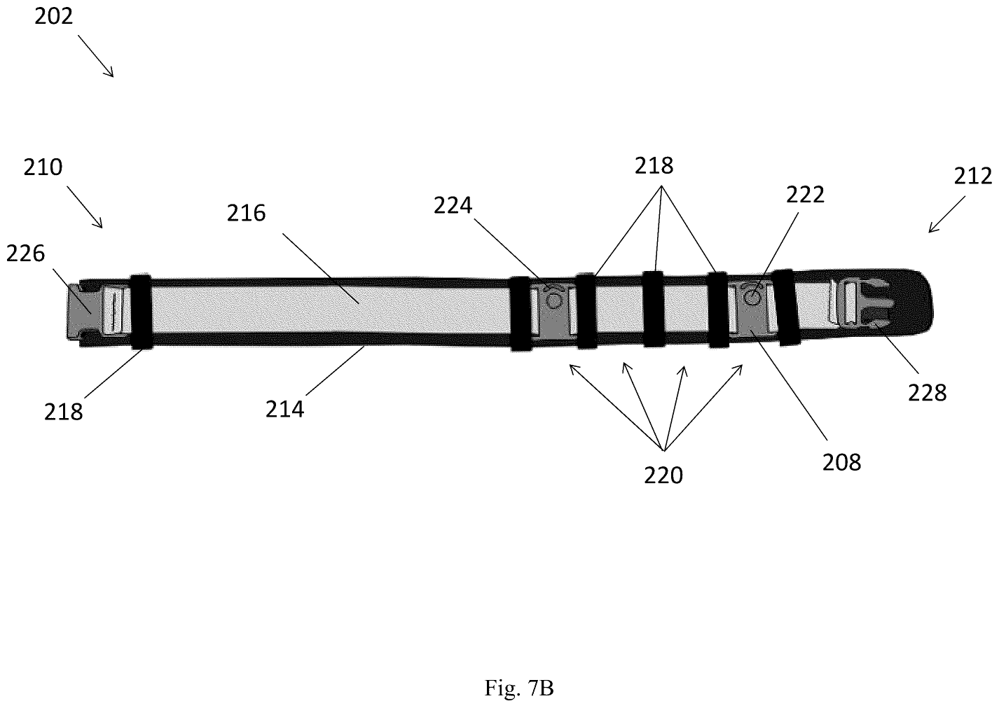

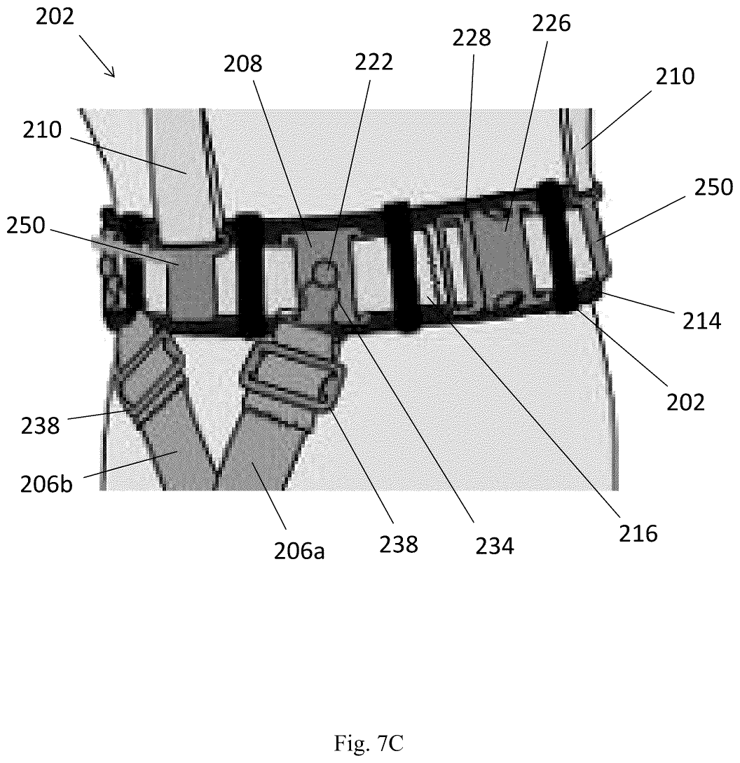

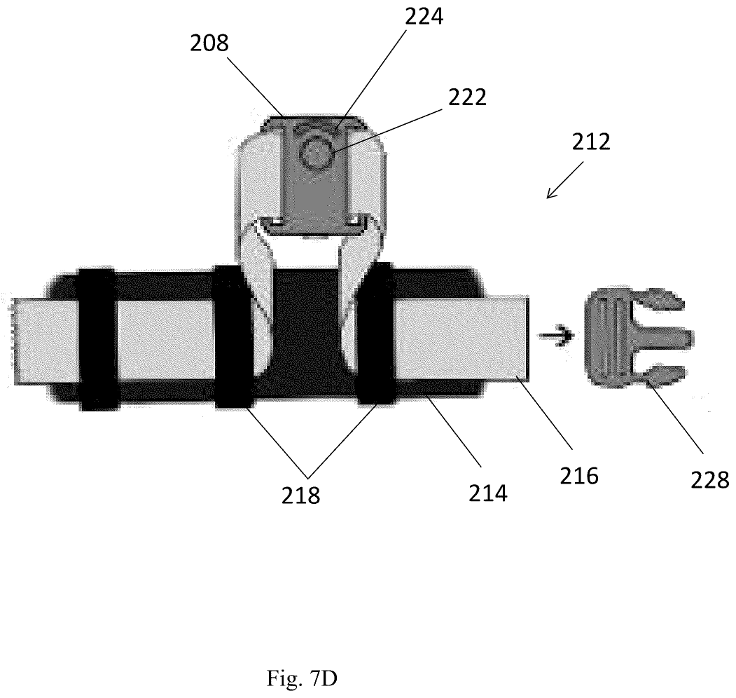

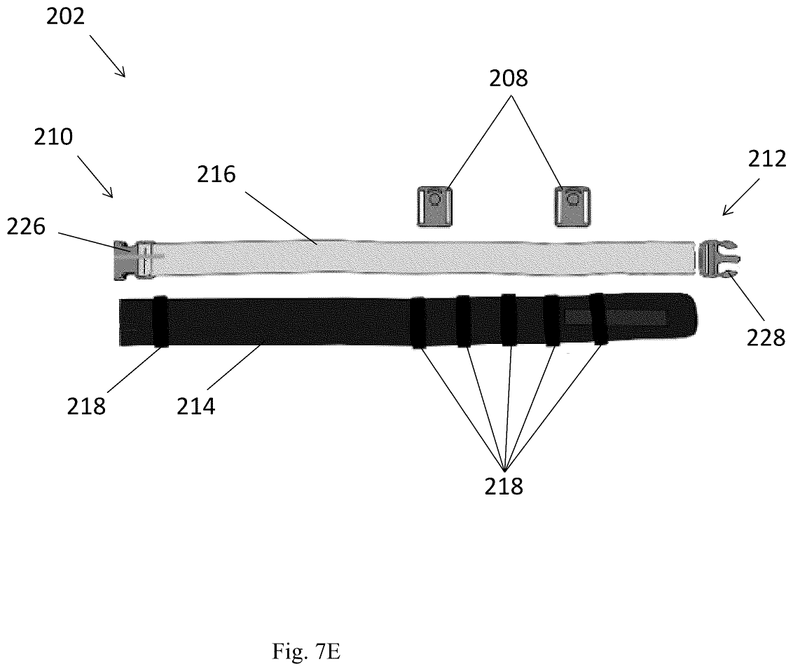

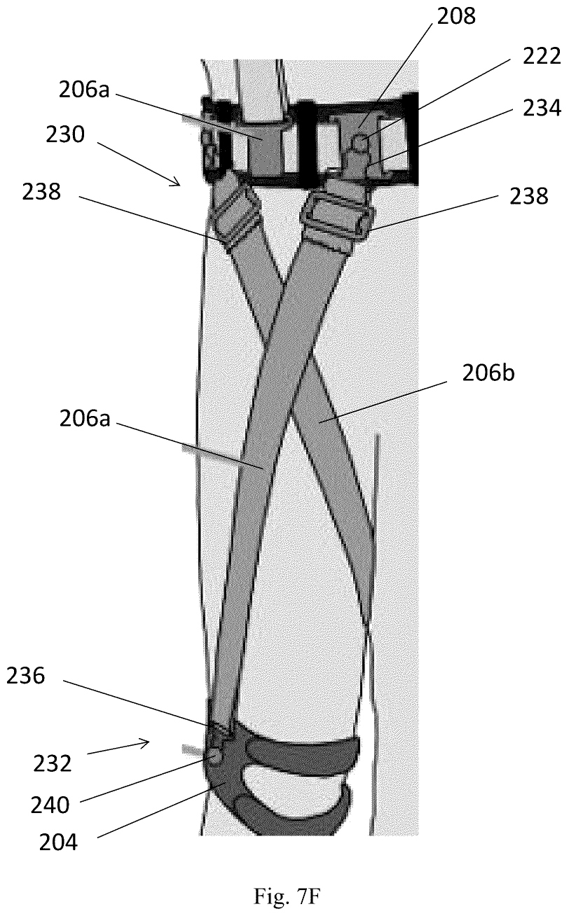

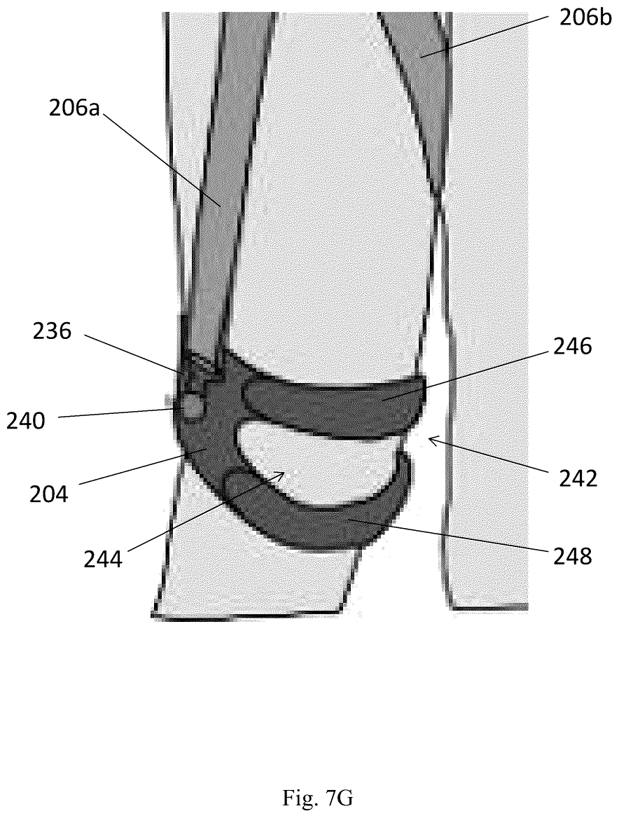

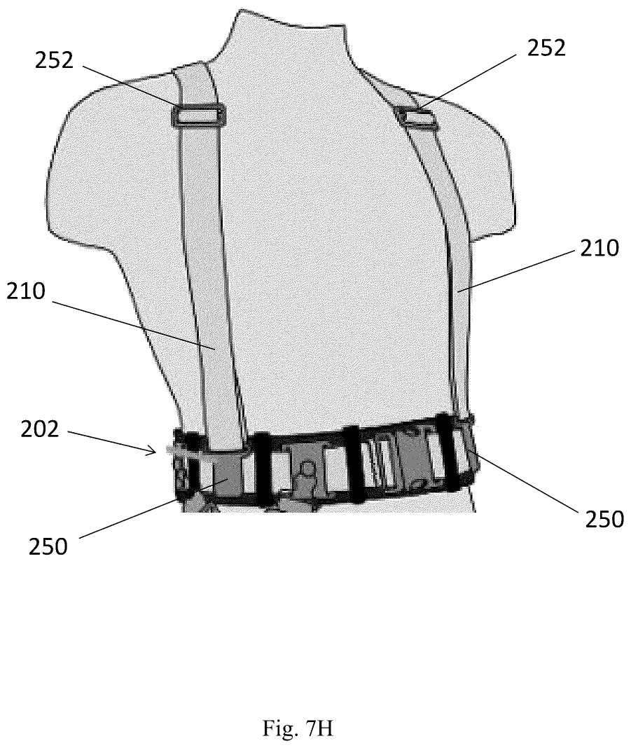

Referring now to FIG. 7A, shown is an exemplary exosuit device 200 according to aspects of the present invention. In some embodiments, exosuit device 200 comprises a belt 202 attached to at least one brace 204 by one or more elements 206. In some embodiments, belt 202 is configured to surround at least a portion of a subject and provide one or more attachment points for elements 206. In some embodiments, the attachment points comprise one or more brackets 208 slidably attached to belt 202 and positionable within one or more attachment regions along the length of the belt. In some embodiments, adjusting the vertical and/or lateral position of belt 202 on the user configures the locations of the one or more attachment regions relative to a position on the user. In some embodiments, brace 204 is configured to surround at least a portion of a subject and provide one or more attachment points for elements 206. In some embodiments, device 200 further comprises one or more suspenders 210 attached to belt 202. In some embodiments, suspenders 210 support belt 202, and distribute tensile forces about the subject (e.g. about the torso).

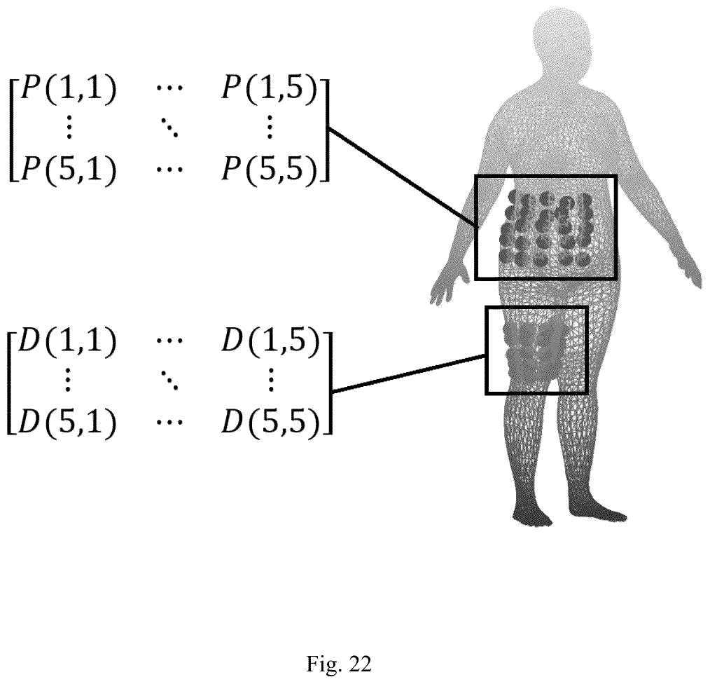

Referring now to FIGS. 7B through 7E, shown is an exemplary belt 202 according to aspects of the present invention. In some embodiments, belt 202 comprises a proximal end 210, a distal end 212, and a length therebetween. In some embodiments, belt 202 provides attachment points for elements 206, wherein the attachment points may be slidably configured and/or positioned along the length of belt 202 within various attachment regions 220. In some embodiments, the attachment regions are positioned along the length of the belt and correlate to anterior, posterior, left lateral and right lateral regions, and regions therebetween, when the belt is placed around the waist of a subject. In some embodiments, belt 202 may be configured and/or positioned (e.g. vertically and/or laterally relative to a position on the user) such that the attachment regions correspond to the attachment regions P(1,1) through P(5,5) as shown in FIG. 22, and described herein. In some embodiments, the ends of belt 202 are affixed together to form a loop, annulus, ring, or the like, to surround at least a portion of a subject.

In some embodiments, belt 202 comprises a base layer 214 and outer belt 216 both extending the length of the belt, wherein base layer 214 is configured to receive at least a portion outer belt 216. In some embodiments, base layer 214 forms an inner sheath for belt 202. In some embodiments, base layer 214 comprises a soft material, and outer belt 216 comprises a more rigid material. In some embodiments, base layer 214 comprises a top and bottom surface, wherein at least one of the surfaces is at least partially covered with hook and loop structure to allow base layer 214 to form a loop around a portion of the user (e.g. the waist). In some embodiments, outer belt 216 comprises a top and bottom surface, wherein at least one of the surfaces is at least partially covered with hook and loop structure. For example, in some embodiments, base layer 214 comprises hook structure on at least a portion of the top surface, and loop structure covering the entire bottom surface. In some embodiments, the hook and look structure of base layer 214 and/or outer belt 216 is configured to affix the ends of the base layer 214 and/or outer belt 216 together to form a loop, annulus, ring, sleeve, or the like.

In some embodiments, base layer 214 comprises one or more sublayers, wherein each sublayer may comprise any fabric or material, or layering of materials, that would be known by one of ordinary level of skill in the art. For example, and without limitation, base layer 214 may comprise any of a cushioning sublayer, waterproofing sublayer, anti-slip sublayer, reinforcing sublayer, antimicrobial sublayer, elastic sublayer, a molded sublayer, a padding sublayer, a rigid sublayer, or the like. In some embodiments, base layer 214 forms a cushion between the user and outer belt 216. In some embodiments, base layer 214 prevents lateral and/or vertical slippage of belt 202 on the user. In some embodiments, hook and loop structure is covering at least a portion of the top and bottom surfaces of base layer 214, such that base layer 214 may be affixed in a preferred location prior to cinching the more rigid outer belt 216, which is tightened to secure the device firmly to the subject (e.g. the waist of the subject). In some embodiments, base layer 214 additionally provides a cushioned and slip-resistant interface with the body of the subject. In some embodiments, there is no adhesive interface between outer belt 216 and base layer 214-outer belt 216 and brackets 208 are simply threaded through belt loops 218, and outer belt 216 is cinched.

In some embodiments, base layer 214 comprises a plurality of loops 218 connected to, and extending out from base layer 214, the loops arranged perpendicular to the length of the belt. In some embodiments, outer belt 216 passes through plurality of loops 218 of base layer 214 to form belt 202. In some embodiments, plurality of loops 218 are configured along the length of base layer 214 to provide attachment regions 220 therebetween, wherein the attachment points may be positioned within each region. In some embodiments, plurality of loops 218 are evenly spaced along the length of the belt. In some embodiments, plurality of loops 218 are configured in any arrangement along the length of the belt. In some embodiments, plurality of loops 218 comprises 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 loops.

In some embodiments, the attachment points comprise brackets 208 slidably attached to outer belt 216, each bracket comprising an attachment pin 222 extending out from the bracket, and a protrusion 224 extending out from the bracket. In some embodiments, attachment pin 222 may comprise a stud, prong, post, button, or the like. In some embodiments, elements 206 comprise end fasteners that fixedly, hingedly and removably attach to attachment pin 222, wherein protrusion 224 restricts the angular movement of the fasteners and/or elements 206 to along an arcuate path. In some embodiments, protrusion 224 comprises a curved dimple extending out from brackets 208 and is configured to prevent fastener 234 from unintentionally popping loose (e.g., when a user sits down, and their thigh pushes fastener 234 upward). In some embodiments, protrusion 224 is configured to limit and/or restrict the angular movement of fasteners 234 and/or elements 206 to an arcuate path. In some embodiments, belt 202 further comprises a fastener comprising a proximal buckle 226 attached to the proximal end of outer belt 216, and a distal prong 228 attached to the distal end of outer belt 216. In some embodiments, buckle 226 and/or prong 228 allow for at least a length of outer belt 216 to pass through buckle 226 and/or prong 228 in order to adjust the overall length of outer belt 216.

Aspects of the present invention relate to one or more elements 206 for exosuit device 200. Referring now to FIG. 7F, shown are exemplary elements 206, wherein each band comprises a proximal end 230 connected to belt 202, and a distal end 232 attached to brace 204. In some embodiments, elements 206 comprise a first element 206a (e.g. a medial band) and a second element 206b (e.g. a lateral band). In some embodiments, first element 206a and second element 206b are arranged antagonistically, or form a cruciform pattern, (e.g. the bands crossing in a medial location along the lengths of each band), attaching belt 202 and brace 204, to aid in rotational stability and maintain a low profile. In some embodiments, each band of elements 206 comprises at least one proximal fastener 234 attached to the proximal end of the band, and at least one distal fastener 236 attached to the distal end of the band. In some embodiments, fastener 234 is fixedly, hingedly and/or removably attached to belt 202, and fastener 236 is fixedly, hingedly and/or removably attached to brace 204. In some embodiments, fastener 234 and/or fastener 236 comprise one or more springs to provide rotational resistance to the fastener. In some embodiments, when the user assumes a sitting position, tension in the elements 206 is relieved, and fasteners 234 and 236 can be easily connected or disconnected. In some embodiments, fastener 234 and/or fastener 236 comprise any of hook and loop, hooks, clips, buckles, clasps, buttons, snaps, toggles or the like. Although some example fasteners are provided, it should be understood that fastener 234 and/or fastener 236 may comprise any fastener that would be known and used by one of ordinary level of skill in the art. In some embodiments, elements 206 comprise one or more adjusters 238 slidably attached to one or more of the bands. In some embodiments, adjusters 238 may be fixedly attached to the end of each band and/or slidably configured along the lengths of the band to adjust the length of the band or modify the positions that the bands of elements 206 cross each other. In some embodiments, adjusters 238 comprise one or more motor-actuated spooling mechanisms electronically and communicatively connected to computing device 100 that may, in some examples, adjust the lengths of elements 206. In some embodiments, the one or more motor-actuated spooling mechanisms. It should be understood that any disclosed motor-actuated spooling mechanism would comprise components, characteristics and the programmability of any motor-actuated spooling mechanisms known by one of ordinary level of skill in the art. This includes providing correctly sized and powered motor-actuated spooling mechanisms that may be configured, in some examples, to provide a pre-load, a force profile, a resistance, or the like. In some embodiments, the motor actuated spooling mechanisms may replace fasteners 234 or 236 and connect elements 206 to belt 202 or brace 204, respectively, and allow for the adjustment of the length of elements 206 and/or an application of a force profile to elements 206. In some embodiments, the motor actuated spooling mechanisms allow for the application of a time profile to elements 206. In some embodiments, the motor actuated spooling mechanisms regeneratively charge computing device 100.

Aspects of the present invention relate to interchangeable and/or adjustable bands or elements for an exosuit device. In some embodiments, elements 206 are elastic bands. In some embodiments, bands 206 are resistance bands. In some embodiments, elements 206 comprise any of coil spring, linear spring, helical extension spring, helical compression spring, torsion spring, linear actuator, motor-actuated spooling mechanism, strut, gas strut, flexural blades, flexural elements, flexures, or the like. In some embodiments, elements 206 are interchangeable and/or adjustable, to modify the rest length, elongation, stiffness, resistance, tensile force, length and/or width of the element. In some embodiments, each element of elements 206 may have the same or different tensile force, length and/or width. In some embodiments, elements 206 may comprise a hollow region extending at least a portion of the length of each element. In some embodiments, elements 206 may be colored to indicate the tensile force, length and/or width. In some embodiments, elements 206 have a stiffness ranging from about about 1 N/m to about 1000 N/m. In some embodiments, elements 206 comprise bilateral linear spring elements.

Aspects of the present invention relate to an exemplary brace for exosuit device 200. Referring now to FIG. 7G, brace 204 may be configured to be positioned around at least a portion of a subject and comprises one or more attachment points for elements 206. In some embodiments, the attachment points comprise at least one attachment pin 240 extending out from the brace. In some embodiments, the attachment points comprise a right lateral attachment pin 240 and a left lateral attachment pin 242 (pin is hidden from view). In some embodiments, attachment pin 240 and/or attachment pin 242 may comprise a stud, prong, post, button, or the like. In some embodiments, brace 204 may be configured and/or positioned (e.g. vertically and/or laterally relative to a position on the user) such that the attachment points correspond to the attachment points D(1,1) through D(5,5) as shown in FIG. 22 and as described herein. In some embodiments, brace 204 is shaped as a ring, annulus, sleeve, frustum, or the like. In some embodiments, brace 204 may comprise an opening 244 that separates brace 204 into an upper portion 246 and a lower portion 248. In some embodiments, opening 244 allows unrestricted flexion of a joint (e.g. the knee joint), and/or allows a portion of a joint to pass through the opening (e.g. a knee cap or an elbow).

Aspects of the present invention relate to suspenders for an exosuit device 200. Referring now to FIG. 7H, shown are exemplary suspenders 210 according to aspects of the present invention. Suspenders 210 are configured to immobilize and/or support belt 202 to prevent lateral and/or rotational movement. In some embodiments, each suspender of suspenders 210 comprises a proximal and distal end, with a length therebetween, with fasteners 250 attached to each end configured to fixedly and removably attach the suspenders to belt 202, base layer 214, and/or outer belt 216. In some embodiments, suspenders 210 further comprise one or more adjusters 252 slidably attached to suspenders 210, configured to adjust the length of the suspenders. In some embodiments, fasteners 250 may comprise any of hook and loop, hooks, clips, buckles, clasps, buttons, snaps, toggles or the like. Although suspenders 210 are described as separate lengths that may immobilize or support belt 202, it should be understood that suspenders may be in any shape or pattern that may connect to and immobilize belt 202 and/or exosuit 200. For example, suspenders 210 may attach in two anterior positions on belt 202, pass over the shoulders of the subject, cross each other, and then attach to two posterior positions on belt 202.

Aspects of the present invention relate to exemplary materials for exosuit device 200. In some embodiments, belt 202 comprises any material including, but not limited to, nylon, neoprene, foam, spandex, polyester, latex, rubber, cotton, wool, hemp, plastic, fiberglass, and/or metal. For example, in some embodiments, buckle 208 comprises plastic, base layer 214 comprises neoprene, and outer belt 216 comprises nylon. Although example materials are provided, it should be understood that exosuit device 200 may comprise any material as would be known and used by one of ordinary level of skill in the art.

Aspects of the present invention relate to dimensions for exosuit device 200. In some embodiments, belt 202 has a length ranging from about 10 cm to about 200 cm, and a width ranging from about 1 cm to about 20 cm. In some embodiments, elements 206 have a length ranging from about 10 cm to about 200 cm, and width ranging from about 1 cm to 10 cm. In some embodiments, brace 206 has a length ranging from about 2 cm to about 100 cm, and a width ranging from about 1 cm to 20 cm. In some embodiments, brace 206 has a diameter of about 1 cm to about 20 cm.

In some embodiments, exosuit device 200 or any aspect thereof may be electronically connected to a computing device. For example, in some embodiments, elements 206 are electronically connected to computing device 100 and/or powered by a power source. In some embodiments, computing device 100 and/or a power sourced are embedded within belt 202. In some embodiments, exosuit device 200 and/or computing device 100 may further comprise angular position sensors, angular rotation sensors, Inertial Measurement Unit (IMU), potentiometers, encoders, Hall effect sensors, Rotary Variable Differential Transformer (RVDT), Rotary Variable Inductive Transducer (RVIT), Positek Passivated Implanted Planar Silicon (PIPS), or the like.

Aspects of the present invention relate to configuring, sizing, and applying any exosuit to a user and optimizing and improving the performance and design. In some embodiments, the performance of device 200, sometimes referred to as a passive, bilateral, hip flexion assistance device, was improved by simulating its performance on neuromusculoskeletal models of users with MS. Assistive devices require adjustment to meet the needs of the individual user, and should account for factors including the user's functional abilities and size and shape. In some embodiments, user surface geometry is used to inform the behavior of the device and the resting length and stiffness of the passive elements (e.g. elements 206) on each leg of the device are iteratively adjusted using Bayesian optimization, a technique that is useful for problems where the cost function is expensive to evaluate [E. Brochu, V. M. Cora, and N. de Freitas, “A Tutorial on Bayesian Optimization of Expensive Cost Functions, with Application to Active User Modeling and Hierarchical Reinforcement Learning,” 2010, [Online]], such as computationally intensive simulations or human-in-the-loop physical experiments [Y. Ding, M. Kim, S. Kuindersma, and C. J. Walsh, “Human-in-the-loop optimization of hip assistance with a soft exosuit during walking,” Sci. Robot., vol. 3, no. 15, p. eaar5438, 2018, doi: 10.1126/scirobotics.aar5438] where the subjects may fatigue quickly, as is common in people with MS [A. R. Salter, G. R. Cutter, T. E. Bacon, and J. Herbert, “Disability in multiple sclerosis,” Neurology, vol. 80, pp. 1018-1024, 2013].

Aspects of the present invention relate to a method of designing an exosuit device. In some embodiments, a 3D surface geometry and 3D kinematics of a user are combined to generate a model of the user's body surface during each frame recorded in the movement. In some embodiments, these inputs can be provided using state-of-the-art motion capture and 3D/4D scanning lab-based sensors, or by consumer products/wearable technologies that exist outside of the lab. In some embodiments, the behavior of the contracting element is simulated using a wrapping algorithm, and the time-varying moment arm about the joint(s) span can be computed for the movement. In some embodiments, each static frame provides a measure of mechanical advantage (moment arm length and spatial orientation), and when combined in time can provide a measure of power-generating ability (e.g., Watts of joint power per Newton of tension across element). In some embodiments, this information can be used to inform optimizations of various aspects of device design and/or configuration, including attachment locations (e.g. attachment regions 220) of contracting elements or bands (e.g. elements 206), timing and magnitude of active energy input, and material properties of passive elements or bands (stiffness, pre-tension). Furthermore, in some embodiments, this method provides user-specific models of exosuit assistance that could be implemented in device controllers.

In some embodiments, this invention takes user-specific body surface and movement data as input to the design and configuration process, knowing that energy transmission from device to user is heavily reliant on these factors. Presently, exosuits are adjusted reactively to user needs and preferences, as opposed the proactive approach given in this method.

In some embodiments, this method systematically treats the wide range of shapes and movements with which humans present, specifically within the context of assistive exosuit devices. This variability must be considered if the goal is to deploy this technology to diverse populations.

This method incorporates unknown information about the individual user that present technologies do not, to better inform design and tuning decisions, as well as an opportunity to use this information for real-time on-demand device control.

In some embodiments, the disclosed method requires 3D surface models and joint kinematics of the user, that are easily obtained with computer vision systems and wearable sensors (many of which are incorporated in consumer products). Furthermore, using this method with large datasets over a statistical cross-section of a population, this same method could be used to generate more general guidelines and recommendations for device fitment and setup outside of a laboratory setting. In some embodiments, the same method could be incorporated for the use of real-time adjustments in the control of device 200 (as opposed to using the system to inform a device). In some embodiments, these methods are extended to inform an active (motor-driven) exosuit device 200, wherein elements 206 are actively controlled. In some embodiments, elements 206 comprise linear actuators and/or motor actuated spooling cables. In some embodiments, the step of adjusting elements 206 comprises adjusting the timing and force profile of a linear actuator or a motor actuated spooling cable.

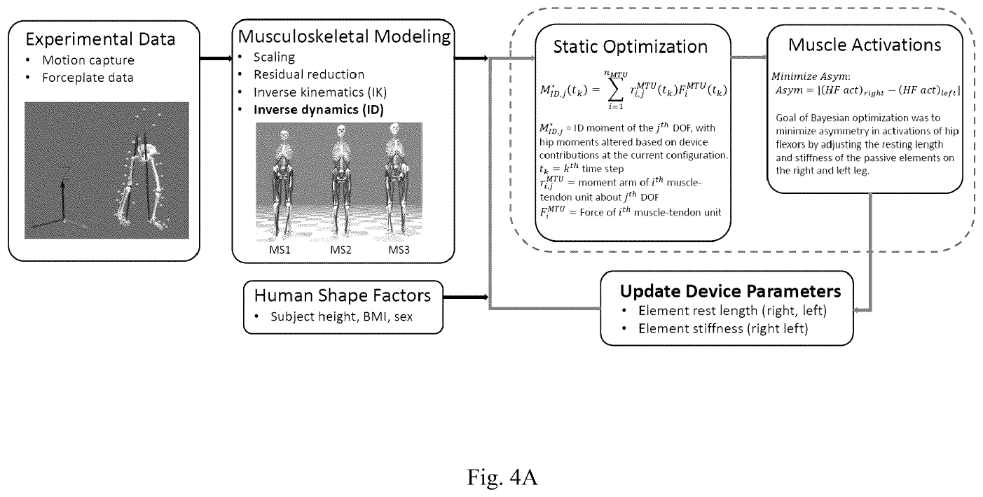

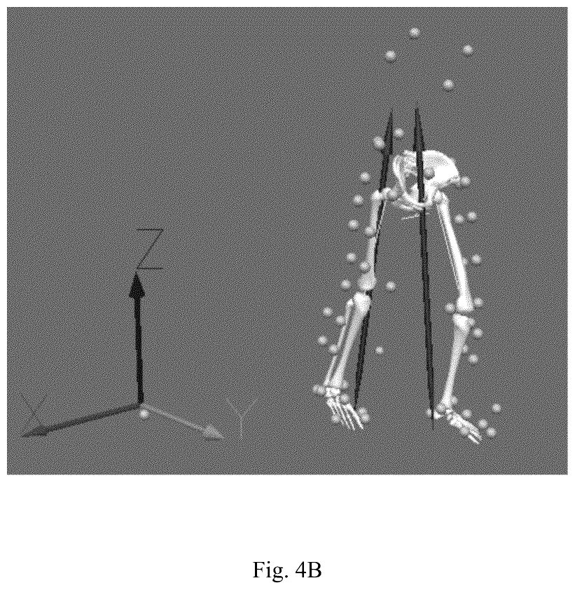

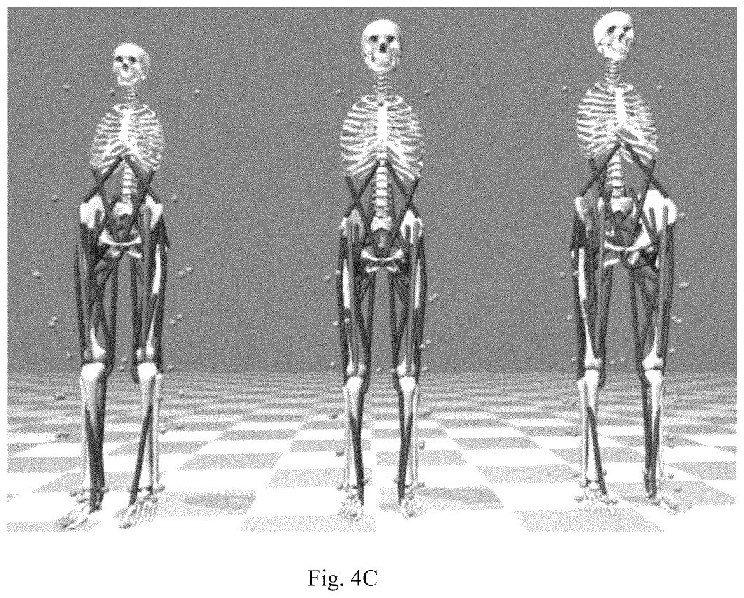

In some embodiments, device 200 is modelled in OpenSim 4.1 using bilateral linear spring elements (i.e. elements 206) whose force-elongation curves are informed by human shape modelling. In some embodiments, the anchoring locations (e.g. anchoring regions 220) remain static in this analysis, and only the rest length and elongation (of elements 206) are changed. In some embodiments, a generic 23-degree-of-freedom, 54-muscle musculoskeletal model is scaled to match the experimental data gathered from each user. Referring now to FIG. 4A in some embodiments, experimental data is used to inform musculoskeletal and human shape modeling pipelines, which are fed to the static optimization algorithm in order to estimate muscle activations. In some embodiments, activation asymmetries are the cost function that the Bayesian optimization algorithm attempts to minimize by adjusting the resting length and stiffness of each contracting element in the exosuit device. In some embodiments, Bayesian optimization treats the problem as a black box, i.e., no information about the modeling process is fed to the optimizer.

In some embodiments, for elements 206 on the disclosed exosuit device 200, the stiffness, rest length, medio-lateral attachment, and vertical attachment positions are passed into the function for a total of 8 optimizable variables. In some embodiments, after the simulations are run, the metabolic cost is reported, which is used to update the Bayesian acquisition function, and 8 new parameter values are chosen. In some embodiments, inside the black box function, the shape modeling system takes the device configuration, 3D surface model, and joint kinematics of the user, and calculates the forces contributed by the exosuit. In some embodiments, these forces, along with the musculoskeletal model, ground reaction forces (GRFs), and joint kinematics, are the inputs for computed muscle control (CMC), a muscle-driven dynamic gait simulation technique. In some embodiments, the CMC returns muscle states that are used to estimate the metabolic cost of the motion.

Aspects of the present invention relate to a method of fabricating an exosuit. In some embodiments, the method of fabricating an exosuit for assisting at least one movement of a subject comprises the steps of generating an estimated surface mesh of a subject, calculating an estimated controlling skeleton within the surface mesh, comprising a set of joint vertices and edges, calculating a set of poses which, performed successively, form the at least one movement, calculating a set of lines of action, each having a first and second attachment point on the surface mesh and a corresponding moment arm about a corresponding joint vertex of the set of joint vertices, calculating a maximum power generating ability of each line of action, selecting the a desired line of action from the set of lines of action having the maximum power generating ability about the corresponding joint vertex across the poses in the set of poses, and building an exosuit device having an element attached at the first and second attachment points of the selected desired line of action.

In some embodiments, the element comprises a hip flexion element, a linear actuator, a motor-driven cable, a spring, or an elastic band configured to assist in movement of a hip of the subject. In some embodiments, the exosuit is configured to be anchored to a waist of the subject. In some embodiments, the at least one movement is a stride. In some embodiments, the stride is selected from a level stride, an inclined stride, or a staircase climbing stride.

In some embodiments, the first and second attachment points are on a waist and a thigh of the subject, respectively. In some embodiments, the exosuit comprises at least one motor configured to dynamically modulate the first or second attachment positions. In some embodiments, the at least one motor is configured to dynamically modulate the first or second attachment positions during ambulation of the subject.

Aspects of the present invention relate to a method of designing a soft exosuit device comprising the steps of providing one or more biomechanical goals for a subject, providing any exosuit device of the present invention to the subject, positioning the one or more brackets to one or more attachment regions along the length of the belt, adjusting the elements to achieve the one or more biomechanical goals. In some embodiments, the step of configuring the device comprises adjusting the position of the device on the subject vertically or rotating the device mediolaterally.

In some embodiments, the step of positioning the one or more brackets to the one or more attachment regions comprises positioning a first bracket to a medial attachment region on the belt, and a second bracket to a lateral attachment region on the belt. In some embodiments, the step of adjusting the elements comprises applying a preload to the elements. In some embodiments, the step of adjusting the elements comprises adjusting the stiffness, rest-length or elongation of the elements. In some embodiments, the step of adjusting the elements comprises adjusting the length or width of the elements. In some embodiments, the step of adjusting the elements comprises adjusting the timing and force profile of a linear actuator or a motor actuated spooling cable.

In some embodiments, the biomechanical goal comprises reducing the swinging of a limb on the subject. In some embodiments, the biomechanical goal comprises reducing the metabolic cost of movement in the subject. In some embodiments, the biomechanical goal comprises any of: influencing the kinematics of a limb, influencing a desired motion in a limb, increasing/decreasing flexion of a joint, increasing/decreasing extension of a joint, modulating internal/external rotation of a joint, increasing/decreasing kinematic asymmetry between the limbs, increasing/decreasing inter-limb muscle activation asymmetry.

Aspects of the present invention relate to a software that may reside on computing device 100 and perform the steps of any disclosed method. In some embodiments, the software resides on computing device 100 and controls functions of exosuit device 200 including, but not limited to, element 206 length, stiffness, and preload, linear actuator activation and force profile, motor-actuated spooling cable activation and force profile, and any combinations thereof. In some embodiments, device 200 comprises a screen with a user interface that helps the user configure exosuit device 200. It should be understood that any methods of present invention may also be applied to other exosuit devices, and determining the correct parameters (e.g. element length, element positions, preloading, force profile, etc.) for the exosuit device.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art may, using the preceding description and the following illustrative examples, utilize the present invention and practice the claimed methods. The following working examples therefore, specifically point out exemplary embodiments of the present invention, and are not to be construed as limiting in any way the remainder of the disclosure.

### Example 1: Method for Exosuit Modeling, Design, and Configuration Based on Individual Body Shape and Movement Context

With reference to FIG. 4A, FIG. 4B, and FIG. 4C, experimental data was collected from human subjects with MS walking at a self-selected pace. The data is used to scale a musculoskeletal model and run inverse kinematics (IK) and inverse dynamics (ID) to obtain estimates of the moments generated at each joint. Using human shape modeling and device parameters (resting length and stiffness of passive elements), the contributions of the device to hip moments were calculated and subtracted from the hip moments calculated in ID. Static optimization was performed to obtain a solution for the muscle activations that matches the adjusted ID moments, which were then used to calculate the cost function for the Bayesian optimization of device parameters. The cost function was calculated as the difference in average activations of the hip flexors (sartorius, iliacus, psoas, rectus femoris) between the left and right legs. Bayesian optimization was used to iteratively update device parameters until the ideal device configuration for reducing hip flexor asymmetry was obtained.

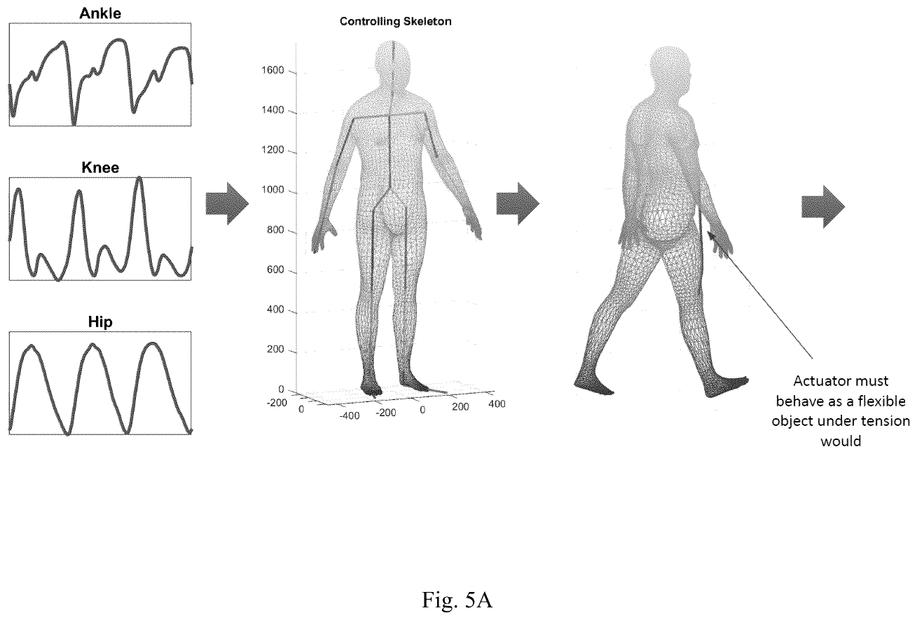

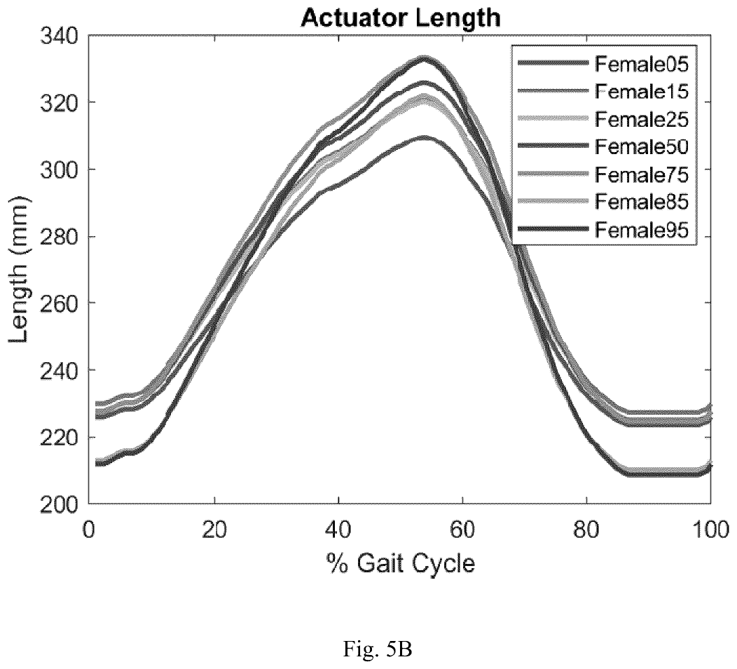

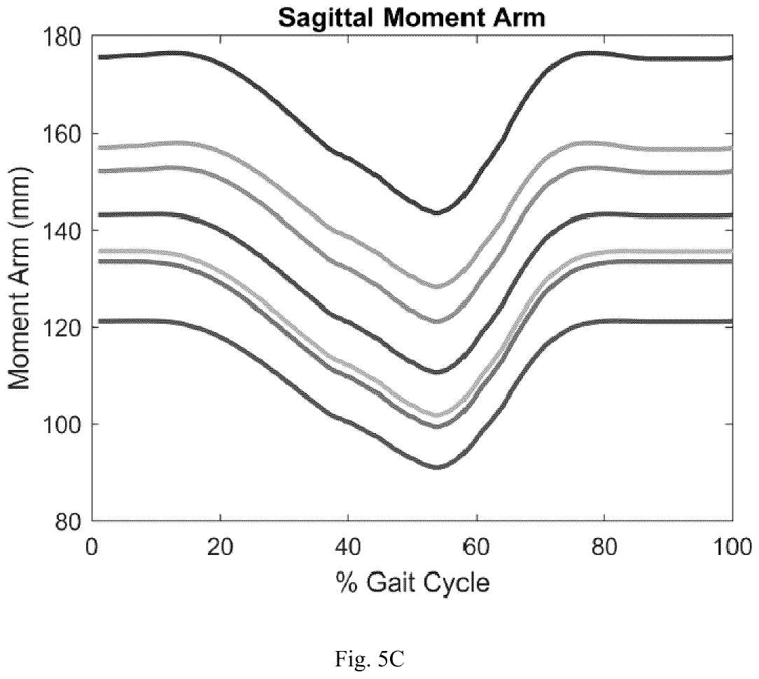

With reference to FIG. 5A and FIG. 5B, experimentally-recorded kinematics were inputted into the model, which informed the position of bones in a skeleton that controls deformation of the mesh representing a subject's body surface. After deforming the mesh, a wrapping algorithm was used to determine the path that the actuator/contracting element takes between prescribed attachment locations. The actuator must conform to the shape the body, but still take the shortest path over concavities, as a flexible element under tension would. Finally, the length of the actuator and its moment arm about the joint(s) it spans were calculated to inform device performance. An example of the length and moment arm over the range of female subjects is shown.

With reference to Table 1 below, results of Bayesian Optimization are shown. The table shows no-device and minimized results for inter-limb flexion asymmetry, resting length and stiffness for the stronger and weaker limbs, respectively, for each subject, and the number of iterations before the optimization obtained its solution.

TABLE 1
Results of Bayesian Optimization

| Subject ID | MS1 | MS2 | MS3 |
|---|---|---|---|
| Inter-limb hip flexion | 0.7613 | 0.1527 | 0.1849 |
| asymmetry (no device) | | | |
| Inter-limb hip flexion | 0.3799 | 0.0019 | 0.1584 |
| asymmetry (minimized) | | | |
| Rest length strong/weak(m) | 0.477/0.481 | 0.465/0.289 | 0.500/0.409 |
| Stiffness strong/weak (N/m) | 356.6/446.3 | 562.6/486.4 | 597.2/535.25 |
| # Iterations | 11 | 14 | 2 |

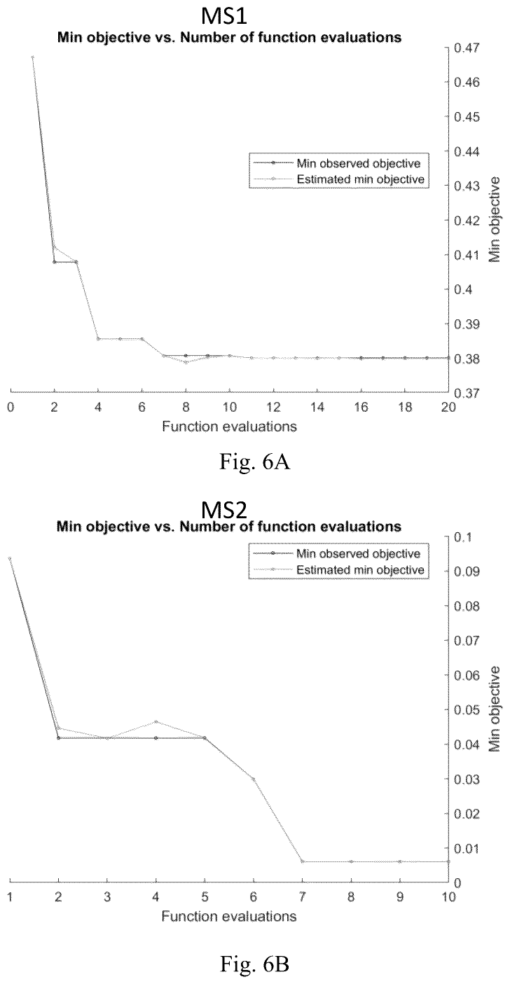

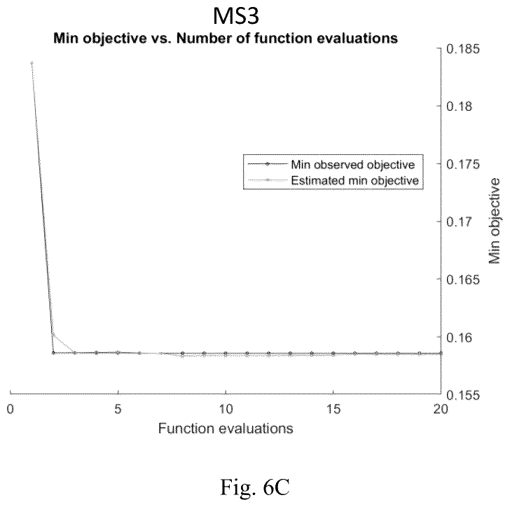

Further results are shown in FIG. 6A, FIG. 6B, and FIG. 6C.

The problem of efficiently optimizing walking assistive devices has been explored before, primarily in the context of improving metabolic cost of walking during experiments. These human-in-the-loop approaches to tuning devices are an important development in addressing user-specific assistive needs, however the amount of walking required for metabolic studies exceeds what some patient populations are capable of, and metabolic consumption does not reflect the activations of specific muscle groups that may be the target of device assistance. Disclosed herein, it is demonstrated how a single device may need to be configured quite differently to assist different people within the same patient population, and shown is a way to estimate these setups efficiently using computational simulations and Bayesian optimization.

### Example 2: Personalized Devices for Hip Flexion Assistance in Ambulation: Human-Centered Considerations in Design, Modeling, and Application

Mobility assistive technology has seen a surge in development in recent years thanks to technological advancements that allow more power to be delivered from smaller devices through more sophisticated means of control. While wearable assistive devices used by patient populations can be mostly accounted for by ankle-foot orthoses, knee braces, and functional electrical stimulation devices, there has been a push among researchers to develop cutting-edge wearable devices that augment lower-limb biomechanics using motors, sensors, and novel means of power transmission. These powered orthoses, commonly referred to as “exoskeletons” or “exosuits”, command significant funding and attention in the scientific community, yet they remain almost entirely out of the hands of the populations for whom they are developed. In order for these technologies to make their way into daily use and positively impact the lives of people in need of mobility assistance, the human side of the equation must be thoroughly considered. What populations could benefit from these devices? How well do they work for people of different sexes, sizes, and shapes? What challenges do various terrains pose to device performance? And what parameters can be tuned to optimize a device with an individual's specific needs in mind? The overall objective of the disclosed invention is to take a human-centered approach to the design of wearable devices aimed at assisting hip flexion during ambulation. The disclosed invention pushes new wearable assistive technologies toward adoption by individuals whose quality of life could be improved by way of the disclosed invention.

Gait impairment is a common complication of multiple sclerosis (MS). Gait limitations such as limited hip flexion, foot drop, and knee hyperextension often require external devices like crutches, canes, and orthoses. The effects of mobility-assistive technologies (MATs) prescribed to people with MS are not well understood, and current devices do not cater to the specific needs of these individuals. To address this, a passive unilateral hip flexion-assisting orthosis (HFO) was developed that uses resistance bands spanning the hip joint to redirect energy in the gait cycle. The purpose of this study was to investigate the short-term effects of the HFO on gait mechanics and muscle activation for people with and without MS. It was hypothesized that (1) hip flexion would increase in the limb wearing the device, and (2) that muscle activity would increase in hip extensors, and decrease in hip flexors and plantar flexors. Five healthy subjects and five subjects with MS walked for minute-long sessions with the device using three different levels of band stiffness. Peak hip flexion and extension angles, lower limb joint work, and muscle activity was analyzed in eight muscles on the lower limbs and trunk. Single-subjects analysis was used due to inter-subject variability. For subjects with MS, the HFO caused an increase in peak hip flexion angle and a decrease in peak hip extension angle. Healthy subjects showed less pronounced kinematic changes when using the device. Power generated at the hip was increased in most subjects while using the HFO. This exploratory study showed that the HFO was well-tolerated by healthy subjects and subjects with MS, and that it promoted more normative kinematics at the hip for those with MS.

Multiple sclerosis (MS) is a chronic neurological disorder in which inflammation leads to the demyelination of nerve fibers and the eventual breakdown of neurons in the central nervous system. This damage causes a long-term accumulation of disability, resulting from sensory and motor impairments [M. M. P. Soldin et al., “Relapses and disability accumulation in progressive multiple sclerosis,” Neurology, vol. 84, no. 1, pp. 81-88, 2015, doi: 10.1212/WNL.0000000000001094]. In 2015, over 2 million cases were reported globally [M. T. Wallin et al., “Global, regional, and national burden of multiple sclerosis 1990-2016: a systematic analysis for the Global Burden of Disease Study 2016,” Lancet Neurol., vol. 18, no. 3, pp. 269-285, 2019, doi: 10.1016/S1474-4422(18)30443-5], and an estimated 75% of people with MS experience mobility impairments over the course of their disease [A. R. Salter, G. R. Cutter, T. E. Bacon, and J. Herbert, “Disability in multiple sclerosis,” Neurology, vol. 80, pp. 1018-1024, 2013]. These deficits, often emerging in early adulthood, constrain activities of daily living and appear to negatively affect quality-of-life [H. L. Zwibel, “Contribution of impaired mobility and general symptoms to the burden of multiple sclerosis,” Adv. Ther., vol. 26, no. 12, pp. 1043-1057, 2009, doi: 10.1007/s12325-009-0082-x].

MS-related symptoms such as muscle weakness, spasticity, and sensory changes are highly variable across individuals. Symptoms can vary throughout the day due to fatigue, and as the disease progresses, individuals can experience relapses, remissions, and increasing disability [A. R. Salter, G. R. Cutter, T. E. Bacon, and J. Herbert, “Disability in multiple sclerosis,” Neurology, vol. 80, pp. 1018-1024, 2013], [A. Compston and A. Coles, “Multiple sclerosis,” Lancet, vol. 372, no. 9648, pp. 1502-1517, 2008, doi: 10.1016/S0140-6736(08)61620-7], [M. J. Hohol and H. L. Weiner, “Disease Steps in multiple sclerosis:,” Neurology, no. April 1993, 1995]. The effects of MS on gait often include reductions in step length, walking speed, dynamic stability, and range of motion (ROM) in lower limb joints [L. Filli et al., “Profiling walking dysfunction in multiple sclerosis: Characterisation, classification and progression over time,” Sci. Rep., vol. 8, no. 1, pp. 1-13, 2018, doi: 10.1038/s41598-018-22676-0; M. Pau et al., “Novel characterization of gait impairments in people with multiple sclerosis by means of the gait profile score,” J. Neurol. Sci., vol. 345, no. 1, pp. 159-163, 2014, doi: 10.1016/j.jns.2014.07.032; P. Thoumie, D. Lamotte, S. Cantalloube, M. Faucher, and G. Amarenco, “Motor determinants of gait in 100 ambulatory patients with multiple sclerosis,” Mult. Scler., vol. 11, no. 4, pp. 485-491, August 2005, doi: 10.1191/1352458505ms1176oa; C. L. Martin et al., “Gait and balance impairment in early multiple sclerosis in the absence of clinical disability,” Mult. Scler., vol. 12, no. 5, pp. 620-628, 2006, doi: 10.1177/1352458506070658].

To address the various mobility limitations caused by MS, a wide range of devices are prescribed to patients. While severe impairments necessitate wheelchairs, ambulatory people with MS often use ankle-foot orthoses (AFOs), crutches, canes, or walkers. While these are helpful interventions for walking impairments, the variability of gait impairment amongst individuals with MS and the lack of evidence-based practice in prescribing mobility devices to people with MS have led to high rates of abandonment and low satisfaction with this equipment [A. Souza, A. Kelleher, R. A. R. Cooper, R. A. R. Cooper, L. I. Iezzoni, and D. M. Collins, “Multiple sclerosis and mobility-related assistive technology: Systematic review of literature,” J. Rehabil. Res. Dev., vol. 47, no. 3, p. 213, 2010, doi: 10.1682/JRRD.2009.07.0096], [B. T. Fay and M. L. Boninger, “The science behind mobility devices for individuals with multiple sclerosis,” Med. Eng. Phys., vol. 24, no. 6, pp. 375-383, July 2002, doi: 10.1016/S1350-4533(02)00037-1]. For instance, a common manifestation of MS is difficulty clearing the foot during the swing phase of gait, which is often attributed to dorsiflexion and eversion weakness in the ankle. AFOs are frequently prescribed in this situation [L. R. Sheffler, M. T. Hennessey, J. S. Knutson, G. G. Naples, and J. Chae, “Functional Effect of an Ankle Foot Orthosis on Gait in Multiple Sclerosis,” Am. J. Phys. Med. Rehabil., vol. 87, no. 1, pp. 26-32, 2008, doi: 10.1097/PHM.0b013e31815b5325], [B. L. Davies, R. M. Hoffman, K. Healey, R. Zabad, and M. J. Kurz, “Errors in the ankle plantarflexor force production are related to the gait deficits of individuals with multiple sclerosis,” Hum. Mov. Sci., vol. 51, pp. 91-98, 2017, doi: 10.1016/j.humov.2016.11.008]. While the literature has shown that AFOs can produce measurable gait improvements in people recovering from stroke [M. Franceschini, M. Massucci, L. Ferrari, M. Agosti, and C. Paroli, “Effects of an ankle-foot orthosis on spatiotemporal parameters and energy cost of hemiparetic gait,” Clin. Rehabil., vol. 17, no. 4, pp. 368-372, 2003, doi: 10.1191/0269215503cr622oa.; H. Gök, A. Küçükdeveci, H. Altinkaynak, G. Yavuzer, and S. Ergin, “Effects of ankle-foot orthoses on hemiparetic gait,” Clin. Rehabil., vol. 17, no. 2, pp. 137-139, 2003, doi: 10.1191/0269215503cr605oa.; M. Pohl and J. Mehrholz, “Immediate effects of an individually designed functional ankle-foot orthosis on stance and gait in hemiparetic patients,” Clin. Rehabil., vol. 20, no. 4, pp. 324-330, April 2006, doi: 10.1191/0269215506cr951oa.; A. Danielsson and K. S. Sunnerhagen, “Energy expenditure in stroke subjects walking with a carbon composite ankle foot orthosis,” J. Rehabil. Med., vol. 36, no. 4, pp. 165-168, 2004, doi: 10.1080/16501970410025126.; J. Leung and A. M. Moseley, “Impact of ankle-foot orthoses on gait and leg muscle activity in adults with hemiplegia,” Physiotherapy, vol. 89, no. 1, pp. 39-60, 2003, doi: 10.1016/S0031-9406(05)60668-2], the data regarding their effects in the context of MS is sparse and inconclusive [L. R. Sheffler, M. T. Hennessey, J. S. Knutson, G. G. Naples, and J. Chae, “Functional Effect of an Ankle Foot Orthosis on Gait in Multiple Sclerosis,” Am. J. Phys. Med. Rehabil., vol. 87, no. 1, pp. 26-32, 2008, doi: 10.1097/PHM.0b013e31815b5325], [G. M. Ramdharry, J. F. Marsden, B. L. Day, and A. J. Thompson, “De-stabilizing and training effects of foot orthoses in multiple sclerosis,” Mult. Scler. J., vol. 12, no. 2, pp. 219-226, April 2006, doi: 10.1191/135248506ms1266oa], [D. Cattaneo, F. Marazzini, A. Crippa, and R. Cardini, “Do static or dynamic AFOs improve balance?,” Clin. Rehabil., vol. 16, no. 8, pp. 894-899, 2002, doi: 10.1191/0269215502cr547oa]. This demonstrates the lack of MS-specific research into mobility interventions, and the need for further development of mobility-assistive technologies (MATs) for people living with neurodegenerative disorders.

In recent years, research in MATs has focused on the development of wearable robotic exosuits and exoskeletons. These devices aim to augment human gait through the controlled actuation of motor-driven cables or pneumatic artificial muscles that span various joints in the lower limbs [F. A. Panizzolo et al., “A biologically-inspired multi-joint soft exosuit that can reduce the energy cost of loaded walking,” J. Neuroeng. Rehabil., vol. 13, no. 1, p. 43, December 2016, doi: 10.1186/s12984-016-0150-9.; L. M. Mooney, E. J. Rouse, and H. M. Herr, “Autonomous exoskeleton reduces metabolic cost of human walking,” J. Neuroeng. Rehabil., vol. 11, no. 1, p. 151, 2014, doi: 10.1186/1743-0003-11-151.; B. G. Do Nascimento, C. B. S. Vimieiro, D. A. P. Nagem, and M. Pinotti, “Hip orthosis powered by pneumatic artificial muscle: Voluntary activation in absence of myoelectrical signal,” Artif Organs, vol. 32, no. 4, pp. 317-322, 2008, doi: 10.1111/j.1525-1594.2008.00549.x.], or motors situated concentrically with joints [F. Giovacchini et al., “A light-weight active orthosis for hip movement assistance,” Rob. Auton. Syst., vol. 73, pp. 123-134, 2015, doi: 10.1016/j.robot.2014.08.015], [S. Jung, C. Kim, J. Park, D. Yu, J. Park, and J. Choi, “A wearable robotic orthosis with a spring-assist actuator,” Proc. Annu. Int. Conf IEEE Eng. Med. Biol. Soc. EMBS, vol. 2016-Octob, pp. 5051-5054, 2016, doi: 10.1109/EMBC.2016.7591862]. Studies have demonstrated that such technology can reduce muscle activation during unloaded [L. M. Mooney, E. J. Rouse, and H. M. Herr, “Autonomous exoskeleton reduces metabolic cost of human walking,” J. Neuroeng. Rehabil., vol. 11, no. 1, p. 151, 2014, doi: 10.1186/1743-0003-11-151], [A. J. Young, H. Gannon, and D. P. Ferris, “A Biomechanical Comparison of Proportional Electromyography Control to Biological Torque Control Using a Powered Hip Exoskeleton,” Front. Bioeng. Biotechnol., vol. 5, no. June, 2017, doi: 10.3389/fbioe.2017.00037.; J. Lee, K. Seo, B. Lim, J. Jang, K. Kim, and H. Choi, “Effects of assistance timing on metabolic cost, assistance power, and gait parameters for a hip-type exoskeleton,” IEEE Int. Conf. Rehabil. Robot., pp. 498-504, 2017, doi: 10.1109/ICORR.2017.8009297.; T. Lenzi, M. C. Carrozza, and S. K. Agrawal, “Powered hip exoskeletons can reduce the user's hip and ankle muscle activations during walking,” IEEE Trans. Neural Syst. Rehabil. Eng., vol. 21, no. 6, pp. 938-948, 2013, doi: 10.1109/TNSRE.2013.2248749.; L. Grazi, S. Crea, A. Parri, R. M. Lova, S. Micera, and N. Vitiello, “Gastrocnemius myoelectric control of a robotic hip exoskeleton can reduce the user's lower-limb muscle activities at push off,” Front. Neurosci., vol. 12, no. FEB, pp. 1-11, 2018, doi: 10.3389/fnins.2018.00071] and loaded walking [F. A. Panizzolo et al., “A biologically-inspired multi-joint soft exosuit that can reduce the energy cost of loaded walking,” J. Neuroeng. Rehabil., vol. 13, no. 1, p. 43, December 2016, doi: 10.1186/s12984-016-0150-9], [Y. Ding et al., “Effect of timing of hip extension assistance during loaded walking with a soft exosuit,” J. Neuroeng. Rehabil., vol. 13, no. 1, pp. 1-10, 2016, doi: 10.1186/s12984-016-0196-8], and reduce the metabolic cost of walking in both healthy subjects [L. M. Mooney, E. J. Rouse, and H. M. Herr, “Autonomous exoskeleton reduces metabolic cost of human walking,” J. Neuroeng. Rehabil., vol. 11, no. 1, p. 151, 2014, doi: 10.1186/1743-0003-11-151], [A. J. Young, H. Gannon, and D. P. Ferris, “A Biomechanical Comparison of Proportional Electromyography Control to Biological Torque Control Using a Powered Hip Exoskeleton,” Front. Bioeng. Biotechnol., vol. 5, no. June, 2017, doi: 10.3389/fbioe.2017.00037], [B. T. Quinlivan et al., “Assistance magnitude versus metabolic cost reductions for a tethered multiarticular soft exosuit,” Sci. Robot., vol. 2, no. 2, p. eaah4416, 2017, doi: 10.1126/scirobotics.aah4416.; A. J. Young, J. Foss, H. Gannon, and D. P. Ferris, “Influence of Power Delivery Timing on the Energetics and Biomechanics of Humans Wearing a Hip Exoskeleton,” Front. Bioeng. Biotechnol., vol. 5, no. March, pp. 1-11, 2017, doi: 10.3389/fbioe.2017.00004.; Y. Ding, M. Kim, S. Kuindersma, and C. J. Walsh, “Human-in-the-loop optimization of hip assistance with a soft exosuit during walking,” Sci. Robot., vol. 3, no. 15, p. eaar5438, 2018, doi: 10.1126/scirobotics.aar5438] and subjects with post-stroke hemiparesis [L. N. Awad et al., “A soft robotic exosuit improves walking in patients after stroke,” Sci. Transl. Med., vol. 9, no. 400, p. eaai9084, July 2017, doi: 10.1126/scitranslmed.aai9084], [K. Z. Takahashi, M. D. Lewek, and G. S. Sawicki, “A neuromechanics-based powered ankle exoskeleton to assist walking post-stroke: A feasibility study,” J. Neuroeng. Rehabil., vol. 12, no. 1, pp. 1-13, 2015, doi: 10.1186/s12984-015-0015-7]. While promising, the costs, power demands, environmental adaptability, noisiness, and size of these devices are hurdles that must be overcome for widespread adoption of this technology [Y. Zhang, V. Arakelian, and J. L. E. Baron, “Design Concepts and Functional Particularities of Wearable Walking Assist Devices and Power-Assist Suits—a Review,” Proc. 58th Int. Conf. Mach. Des. Departmants, no. September, pp. 436-441, 2017.; A. Schiele, “Ergonomics of exoskeletons: Objective performance metrics,” Proc.—3rd Jt. EuroHaptics Conf Symp. Haptic Interfaces Virtual Environ. Teleoperator Syst. World Haptics 2009, pp. 103-108, 2009, doi: 10.1109/WHC.2009.4810871.; A. Burton, “Expecting exoskeletons for more than spinal cord injury,” Lancet Neurol., vol. 17, no. 4, pp. 302-303, 2018, doi: 10.1016/S1474-4422(18)30074-7].

Despite the practical barriers currently preventing most exosuits from reaching consumers, the research related to these devices has been vital to learning about the biomechanical effects of augmenting forces about the lower-limb joints. Exosuit studies have demonstrated the virtues of carefully-timed assistive forces about the hip during walking [J. Lee, K. Seo, B. Lim, J. Jang, K. Kim, and H. Choi, “Effects of assistance timing on metabolic cost, assistance power, and gait parameters for a hip-type exoskeleton,” IEEE Int. Conf. Rehabil. Robot., pp. 498-504, 2017, doi: 10.1109/ICORR.2017.8009297; T. Lenzi, M. C. Carrozza, and S. K. Agrawal, “Powered hip exoskeletons can reduce the user's hip and ankle muscle activations during walking,” IEEE Trans. Neural Syst. Rehabil. Eng., vol. 21, no. 6, pp. 938-948, 2013, doi: 10.1109/TNSRE.2013.2248749.; L. Grazi, S. Crea, A. Parri, R. M. Lova, S. Micera, and N. Vitiello, “Gastrocnemius myoelectric control of a robotic hip exoskeleton can reduce the user's lower-limb muscle activities at push off,” Front. Neurosci., vol. 12, no. FEB, pp. 1-11, 2018, doi: 10.3389/fnins.2018.00071.; Y. Ding et al., “Effect of timing of hip extension assistance during loaded walking with a soft exosuit,” J. Neuroeng. Rehabil., vol. 13, no. 1, pp. 1-10, 2016, doi: 10.1186/s12984-016-0196-8], [A. J. Young, J. Foss, H. Gannon, and D. P. Ferris, “Influence of Power Delivery Timing on the Energetics and Biomechanics of Humans Wearing a Hip Exoskeleton,” Front. Bioeng. Biotechnol., vol. 5, no. March, pp. 1-11, 2017, doi: 10.3389/fbioe.2017.00004], [Y. Ding, M. Kim, S. Kuindersma, and C. J. Walsh, “Human-in-the-loop optimization of hip assistance with a soft exosuit during walking,” Sci. Robot., vol. 3, no. 15, p. eaar5438, 2018, doi: 10.1126/scirobotics.aar5438]. Considering the crucial role that hip flexors play in the swing phase of gait [I. Campanini, A. Merlo, and B. Damiano, “A method to differentiate the causes of stiff-knee gait in stroke patients,” Gait Posture, vol. 38, no. 2, pp. 165-169, 2013, doi: 10.1016/j.gaitpost.2013.05.003], [S. R. Goldberg, F. C. Anderson, M. G. Pandy, and S. L. Delp, “Muscles that influence knee flexion velocity in double support: Implications for stiff-knee gait,” J. Biomech., vol. 37, no. 8, pp. 1189-1196, 2004, doi: 10.1016/j.jbiomech.2003.12.005], the lack of clinically available hip-centric orthoses for mobility assistance suggests a need for more investigation in this area. In 2008, Sutliff et al. showed that a passive hip flexion-assisting orthosis, consisting of a waist belt with resistive components that span the hip and knee joints, improved clinical gait assessment scores in a group of people with MS over a 12-week period [M. H. Sutliff, J. M. Naft, D. K. Stough, J. C. Lee, S. S. Arrigain, and F. A. Bethoux, “Efficacy and safety of a hip flexion assist orthosis in ambulatory multiple sclerosis patients,” Arch. Phys. Med. Rehabil., vol. 89, no. 8, pp. 1611-1617, 2008, doi: 10.1016/j.apmr.2007.11.065]. A similar passive device with elastic components spanning only the hip joint produced significant improvements in timed 6 and 10-minute walk tests in a group of persons exhibiting hemiparetic gait post-stroke [S. Carda, M. Invernizzi, G. Cognolato, E. Piccoli, A. Baricich, and C. Cisari, “Efficacy of a Hip Flexion Assist Orthosis in Adults With Hemiparesis After Stroke,” Phys. Ther., vol. 92, no. 5, pp. 734-739, May 2012, doi: 10.2522/ptj.20110112]. More recently, Panizzolo et al. found that a bilateral passive hip flexion device reduced net metabolic power compared to free walking in older healthy adults [F. A. Panizzolo et al., “Metabolic cost adaptations during training with a soft exosuit assisting the hip joint,” Sci. Rep., vol. 9, no. 1, pp. 1-10, 2019, doi: 10.1038/s41598-019-45914-5]. While these studies show promising results based on clinical and metabolic assessments, biomechanical investigations of passive hip orthoses that include inverse dynamics and muscle activity have not been published.

In the disclosed study, a custom passive, lightweight, unilateral hip flexion orthosis (HFO) was presented, and its biomechanical and neuromuscular effects on individuals with and without MS was investigated. The orthosis comprises elastic bands that span the hip joint, store energy during hip extension in stance, and release the stored energy to assist flexion upon swing initiation. This exploratory study examined the effects of passively augmenting hip flexion in impaired gait, and is an important step toward conducting quantitative biomechanical analyses of novel mobility interventions for people with MS.

The aim of this study was twofold: first, to determine whether people with and without MS can tolerate the HFO in steady-state, level walking; and second, to investigate subjects' biomechanical and neuromotor responses to the HFO under three different stiffness configurations. While the effects of the device were detailed for subjects with and without MS, this study does not attempt to match these two groups. The non-MS group was the initial cohort to test the device, and represents a general control response that can be used as a basis of comparison for further studies involving a variety of pathologies. Testing with the MS group followed the successful completion the non-MS trials, and serves as an exploratory study of the effects of a novel device on people with varying levels of mobility impairment due to a neurological disorder.

In the disclosed study, a custom hip flexion orthosis is configured for unilateral assistance. The HFO (as shown in FIG. 7A & FIG. 7B) comprises: a nylon waist belt for proximal anchoring of resistance bands with a neoprene fabric base layer to interface with the torso; an off-the-shelf neoprene knee brace for distal anchoring of the exercise bands; off-the-shelf elastic suspenders to support the waist belt and distribute tensile forces about the torso; and two resistance exercise bands (TheraBand®) to store and release mechanical energy throughout the gait cycle.

Each resistance band is tensioned between quick-release attachment points on the waist belt and knee brace, creating a passive flexion moment about the hip joint. The two bands are arranged antagonistically (crossing over at mid-thigh) to aid rotational stability and maintain a low profile. The band that anchors closer to the navel is referred to as the “medial” band, while the band that anchors near the iliac crest is called the “lateral” band. The locations of the waist anchors can be independently adjusted to meet the specific needs of the user.

The HFO is low-profile and it does not extend below the knee, allowing for simultaneous use of an AFO if desired. The HFO is also designed to cater to dexterity limitations experienced by people with MS [A. R. Salter, G. R. Cutter, T. E. Bacon, and J. Herbert, “Disability in multiple sclerosis,” Neurology, vol. 80, pp. 1018-1024, 2013]: when the user assumes a sitting position, tension in the bands is relieved, and the quick-release attachments can be easily connected or disconnected. The waist belt is fastened with a simple buckle, and with the suspenders it can be donned and doffed much like a backpack. The knee brace is fastened with two hook-and-loop straps.

Off-the-shelf resistance exercise bands are used to provide the assistive moment. These bands are commonplace in physical therapy clinics, where the HFO would be configured by the clinician. The wide range of available band stiffnesses provides the ability to adjust the HFO to an appropriate resistive force on a case-by-case basis.

Five volunteers with no mobility impairments and five volunteers with unilateral hip flexor weakness due to MS were recruited to wear the device configured in four different conditions: no resistive bands; nominal-stiffness bands (B1); intermediate-stiffness bands (B2); and high-stiffness bands (B3). Participant data can be found in Table 1. The MS participants were recruited from the Gait Disorder Clinic at the UT Southwestern School of Health Professions. Inclusion criteria were a confirmed diagnosis of MS, the ability to walk at least 150 feet without physical assistance (with or without an AFO), unilateral hip flexor weakness of 2+/5 or less as determined by Manual Muscle Testing [H. Hislop, D. Avers, and M. Brown, Daniels and Worthingham's Muscle Testing: Techniques of Manual Examination, 9th ed. Elsevier, 2013], ages 18-75yrs, and body mass index less than 35. Volunteers were excluded if they had other neurologic or orthopedic diagnoses that would negatively impact walking. Participants were encouraged not no rely on the handrails of the treadmill for walking, however light use of the treadmill handrails was permitted. One participant opted to wear an AFO during the trials.

Participants had no experience using the HFO prior to data collection. After recording anthropometric data, participants were fitted with the HFO. The leg to which the device was fitted is referred to as the assisted leg, and the other the unassisted leg. Individuals with MS wore the device on their weaker leg, and control subjects wore the device on their non-dominant leg. The distance between the proximal and distal attachment points for both bands was recorded in a neutral standing position, and band segments were sized to a resting length of 75% of this distance. This pre-tension value was chosen subjectively after preliminary tests found it to produce noticeable sensation in B1 without being prohibitively stiff in B3.

Participants with MS were allowed to self-select a comfortable walking pace under HFO assistance on a treadmill, and all controls walked at 1 m/s. A fixed pace was chosen for the control group to allow for closer comparison across joint conditions of the joint angles, moment, and muscle activity, which are known to vary significantly with walking speed [R. R. Neptune, K. Sasaki, and S. A. Kautz, “The effect of walking speed on muscle function and mechanical energetics,” Gait Posture, vol. 28, no. 1, pp. 135-143, July 2008, doi: 10.1016/j.gaitpost.2007.11.004]. For participants with MS, it was not feasible to fix the pace given the varying functional abilities of the individuals in the group. When ready, trials were conducted wherein the subject was recorded for one minute of steady-state, level walking. First, a no-bands trial (N1) was captured for an initial baseline, followed by the nominal (B1), intermediate (B2), and stiff (B3) conditions, in randomized order. Participants completed further no-bands trials (N2, N3, and N4) following each band condition. An example of the full randomized protocol for a subject would be N1-B3-N2-B1-N3-B2-N4. Participants were allowed as much time as they desired to rest between trials.

TABLE 2
Participant Data

| | | | | | Years | Assisted | Treadmill |
|---|---|---|---|---|---|---|---|
| Subject | | | Height | Mass | with | Hip Flexor | Velocity |
| ID | Age | Sex | (m) | (kg) | MS | Strength | (m/s) |
| MS1 | 57 | F | 1.64 | 88.5 | 24 | 2−/5 | 0.3 |
| MS2 | 61 | F | 1.59 | 51.3 | 7 | 2−/5 | 0.25 |
| MS3 | 45 | F | 1.69 | 56.5 | 24 | 5−Jan | 0.2 |
| MS4 | 54 | F | 1.6 | 88.2 | 5 | 2+/5 | 0.4 |
| MS5 | 52 | F | 1.58 | 87.9 | 2 | 1+/5 | 0.2 |
| C01 | 22 | M | 1.88 | 81.6 | — | — | 1 |
| C02 | 45 | M | 1.86 | 103.6 | — | — | 1 |
| C03 | 21 | M | 1.66 | 108 | — | — | 1 |
| C04 | 58 | F | 1.7 | 57.4 | — | — | 1 |
| C05 | 35 | F | 1.76 | 80.1 | — | — | 1 |

Three-dimensional kinematics were recorded by a ten-camera motion capture system (Vicon, Oxford, UK) at 100 Hz, and marker tracking was performed using Vicon Nexus. Three-dimensional ground reaction forces (GRFs) were recorded for each leg with an instrumented split-belt treadmill (Bertec, Columbus, OH, USA) at 2000 Hz. GRF and kinematic data were low-pass filtered (4th order Butterworth, 10 Hz cutoff) and inverse dynamics calculations were conducted in Visual3D (C-Motion, Kingston, ON, CA) to estimate joint moments and powers. Time integrals of positive and negative joint powers were calculated in Matlab (MathWorks, Natick, MA, USA) to estimate positive and negative joint work, respectively. The last ten good strides of each trial were used for statistical analysis. One control subject (C03) and one subject with MS (P05) were excluded from kinematic/kinetic analysis due to insufficient motion capture marker tracking.

Muscle activity was recorded at 2000 Hz with surface electromyography (EMG) sensors (Delsys Inc., Natick, MA, USA). Sensors were placed on the tibialis anterior (TA), gastrocnemius lateralis (GAS), soleus (SOL), rectus femoris (RF), vastus lateralis (VAS), biceps femoris (HAM), abdominal obliques (AB), and latissimus dorsi (LAT). Raw EMG signals were band-pass filtered (4th order Butterworth, 20-450 Hz cutoff), rectified, and then low-pass filtered (4th order Butterworth, 6 Hz cutoff) to obtain a linear envelope. Envelopes were normalized to the average peak amplitude of strides during N1. The mean normalized EMG values of the last ten good strides from each trial were used for statistical analysis. In several cases, EMG sensors made poor contact and were omitted from statistical analysis, and are left blank in the results.

Due to the small sample size and high variability of the functional levels of participants, single-subjects analysis was conducted, as group-level analysis would yield results not representative of any particular population [B. T. Bates, “Single-subject methodology: an alternative methodology,” Med. Sci. Sport. Exerc., vol. 28, p. 631, 1996], [B. T. Bates, J. S. Dufek, C. R. James, J. R. Harry, and J. D. Eggleston, “Measurement in Physical Education and Exercise Science The Influence of Experimental Design on the Detection of Performance Differences The Influence of Experimental Design on the Detection of Performance Differences,” Meas. Phys. Educ. Exerc. Sci., vol. 20, no. 4, pp. 200-207, 2016, doi: 10.1080/1091367X.2016.1198910]. One-way ANOVAs (α=0.05) were conducted on each observation of interest for each leg. When significant main effects were observed, post-hoc multiple comparisons using the Tukey-Kramer HSD test statistic were performed. These comparisons include all baseline tests for completeness [N. Stergiou and M. M. Scott, “Baseline measures are altered in biomechanical studies,” J. Biomech., vol. 38, no. 1, pp. 175-178, 2005, doi: 10.1016/j.jbiomech.2004.03.007], but only the significant pairwise comparisons between the initial baseline (N1) and band (B1, B2, B3) conditions in the assisted leg are reported here for brevity. Full ANOVA results including effect sizes and results on the non-device leg are reported in Example 6 below. Statistics were computed in Matlab.

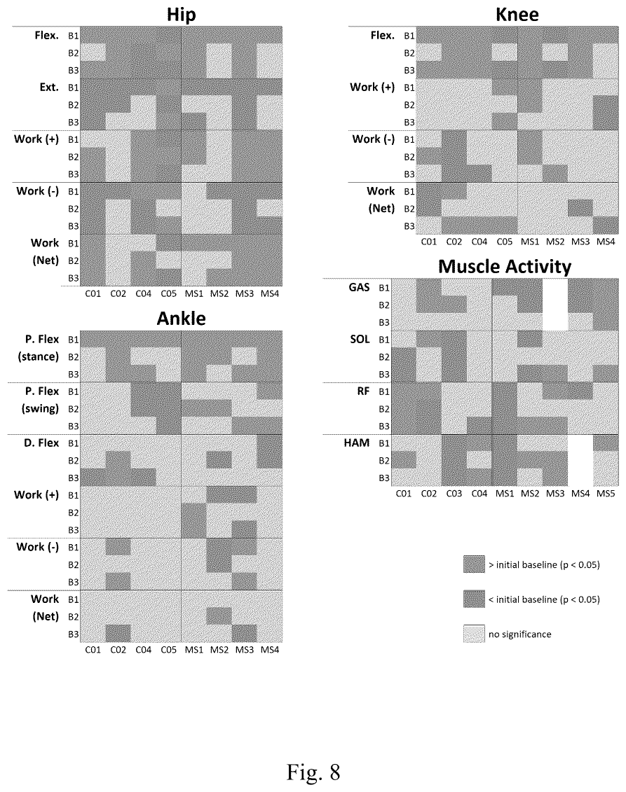

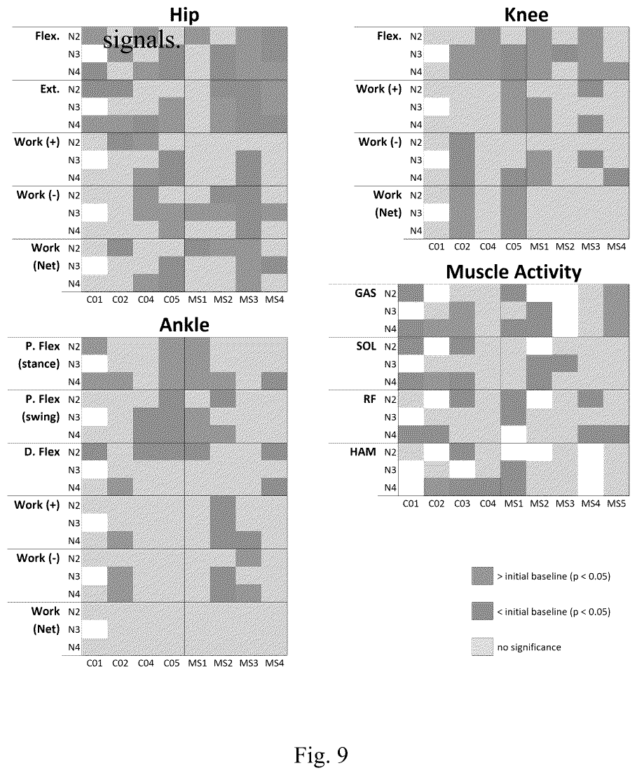

A summary of all ANOVA results are presented in FIG. 8 and FIG. 9. These figures indicate the significant pairwise results between initial baseline (N1) and subsequent conditions for all subjects. Rather than numerical values, the direction of change was simply indicated, if any, that was observed for a given subject and condition, to aid in identifying trends that were present.

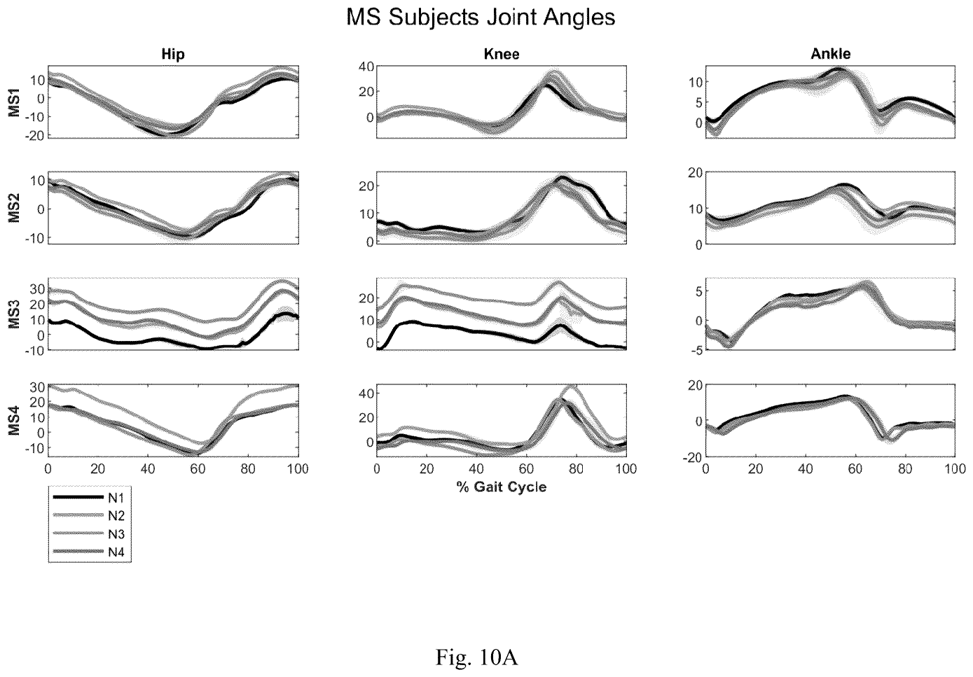

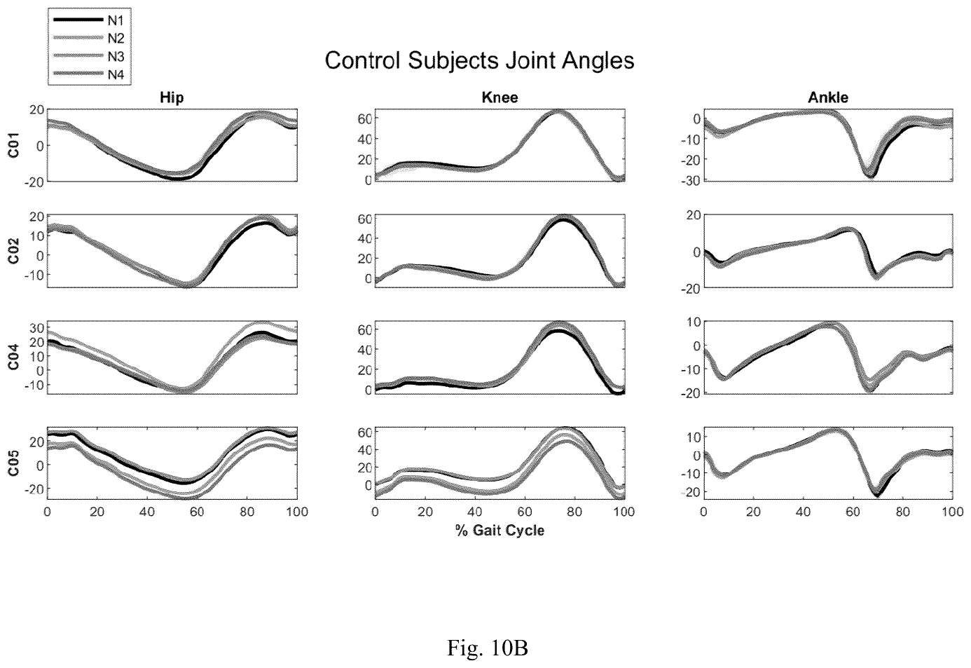

Hip kinematics results are reported in FIG. 8 and FIG. 9, and averaged individual joint trajectories can be viewed in FIG. 10A & FIG. 10B. In support of the hypothesis, all subjects with MS experienced a significant increase in peak hip flexion angle compared to baseline when using the HFO. While these effects were bilateral in several cases, they were more pronounced in the assisted leg, particularly during the B1 condition. Control subjects also showed increases in hip flexion, though not as drastic as those seen in subjects with MS, and with some band trials producing decreases in peak angle for C04 and C05.

Peak hip extension angles were significantly smaller for most MS and control subjects during HFO trials. Again, the greatest changes in peak angles were typically seen during the B1 condition. Significant results of both increases and decreases in hip kinematics were reported during subsequent baseline tests (N2, N3, N4) for both groups.

An increase in peak knee flexion angle was common, occurring for all subjects except for MS2 and C05, who saw decreases. These trends were observed in baseline and HFO trials.

Stance phase peak plantar flexion increased under at least one band condition for all subjects. Swing phase peak plantar flexion increased under at least one band condition for all of the MS group and decreased for C04 and C05. Peak dorsiflexion was largely unaffected, with primarily decreases observed. For most subjects, ankle kinematics experienced significant changes in both HFO and baseline trials.

Positive work in the assisted hip increased during HFO trials for most subjects (MS3 and MS4 for all HFO conditions), but did not increase for these subjects during baseline trials (FIG. 11A and FIG. 11B). Positive work in the unassisted hip was almost completely unaffected. Negative work in the assisted hip either decreased or remained the same for all subjects with MS and for most controls. The resulting net work produced by the assisted hip increased during HFO trials for all subjects with MS.

Work at the knee and ankle was less affected than at the hip, and there was no apparent trend in those results, with varied effects on both baseline and HFO trials.

Peak hip flexion moment on the assisted side significantly decreased for all participants with MS during the B1 condition compared with initial baseline. The unassisted side tended to increase slightly or remain unchanged. Hip extensor moments were less consistent across subjects, though MS1 and MS2 saw the greatest reduction in assisted-side hip extensor moments in the B1 trial.

Significant results in muscle activity are reported in FIG. 8 & FIG. 9. It was hypothesized that hip extensor (HAM) activity would increase, which was observed in MS2, MS3, MS5, C01, and C04 during HFO trials only. Meanwhile, MS1 and C03 showed decreases in HAM activity. also It was also hypothesized that hip flexor (RF) activity would be reduced, which was not the case with most of the collected data. A small reduction to RF activity was seen in MS4 B1, and in all band conditions for MS1, though the reductions seen in MS1 were comparable to those seen in their baseline trials. Finally, it was hypothesized that plantar flexor (GAS, SOL) muscle activity would be reduced by the HFO. For GAS, only MS4 showed reductions in muscle activity exclusively during HFO trials (B1, B2). For SOL, results were similarly mixed, and no clear trends were observed.

The primary purpose of this study was to evaluate the efficacy of a novel hip flexion orthosis worn by people with and without MS. All participants were able to complete trials for all conditions. The HFO was adjusted to successfully fit a wide range of body sizes, and was well-tolerated by all participants. The benefits of a low-profile, discrete device should not be overlooked; device abandonment due to non-acceptance by the user is common [R. Verza, M. L. Lopes Carvalho, M. A. Battaglia, and M. Messmer Uccelli, “An interdisciplinary approach to evaluating the need for assistive technology reduces equipment abandonment,” Mult. Scler., vol. 12, no. 1, pp. 88-93, 2006, doi: 10.1191/1352458506ms1233oa], and a lower profile device might not interfere as much with activities of daily living. Furthermore, the inexpensive materials with which the device was built would make it highly accessible to those in search of a walking aid, and easy to maintain given the availability of off-the shelf exercise bands.

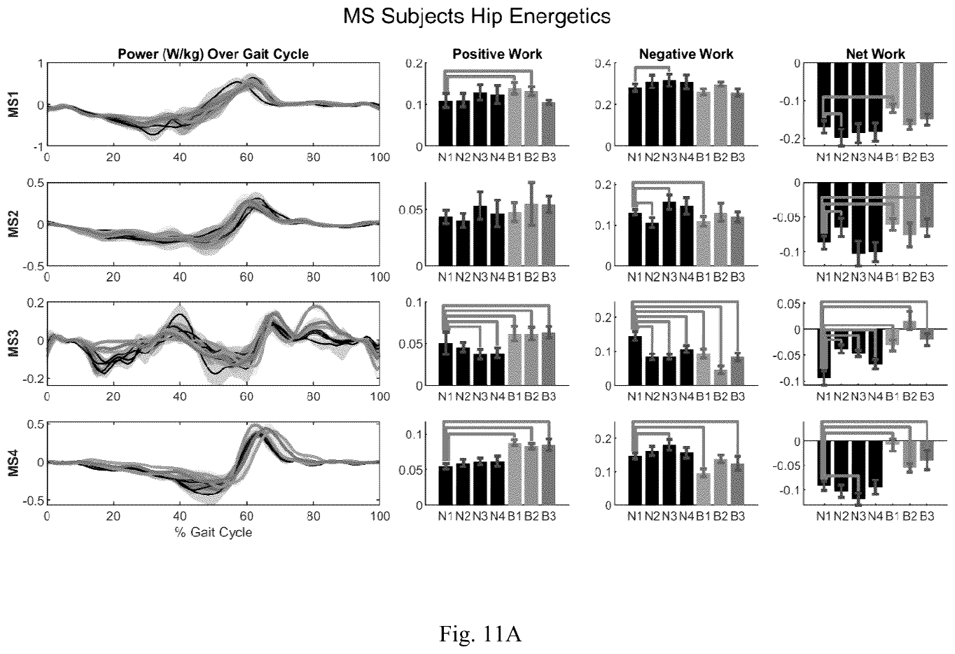

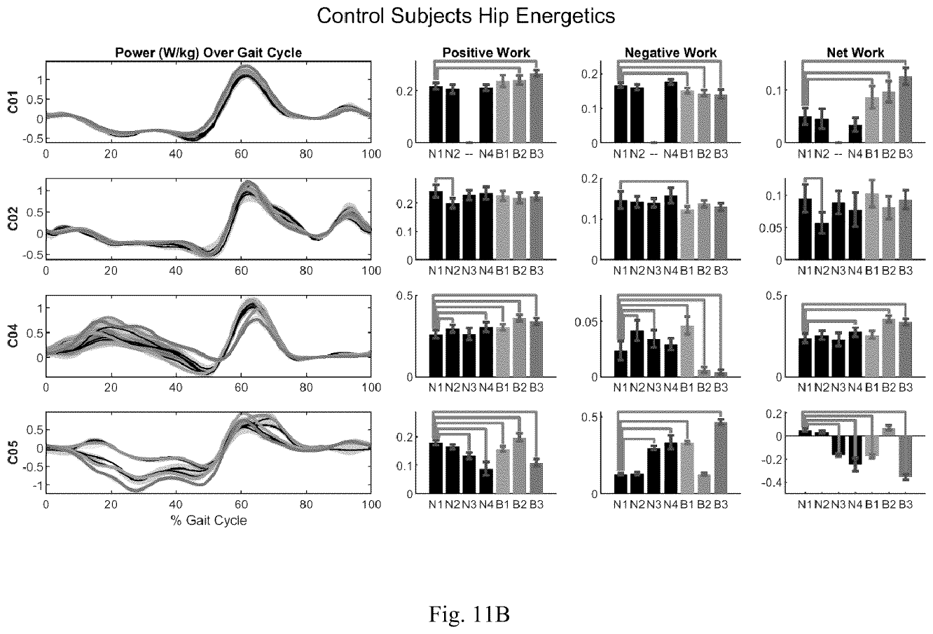

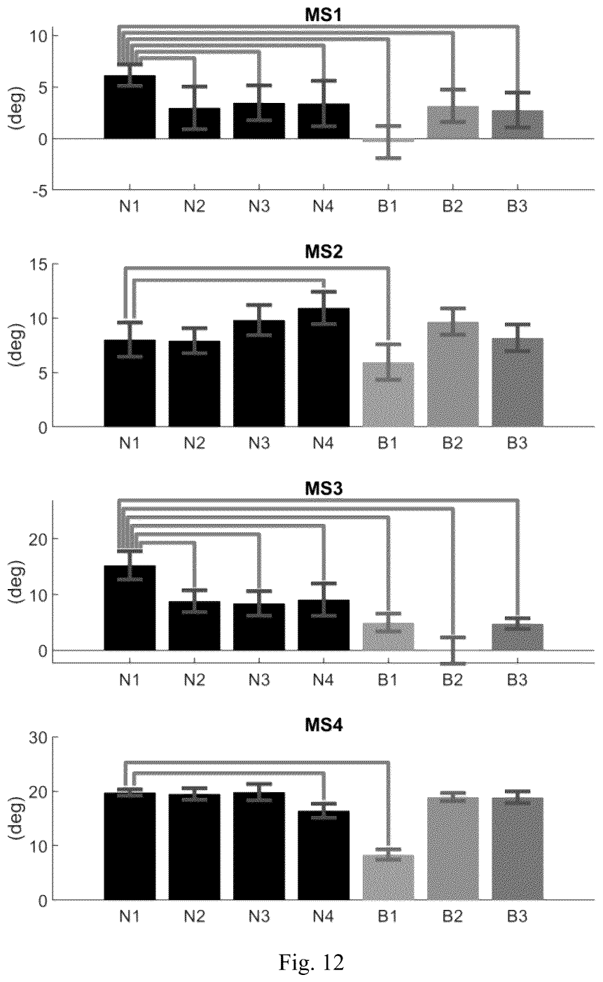

The hypothesis that hip kinematics in the assisted leg would shift towards flexion was largely supported by subjects with MS and several controls, particularly in the B1 condition. This change opposes the shift toward hip extension during swing that has been observed in people with MS [L. Filli et al., “Profiling walking dysfunction in multiple sclerosis: Characterisation, classification and progression over time,” Sci. Rep., vol. 8, no. 1, pp. 1-13, 2018, doi: 10.1038/s41598-018-22676-0]. These effects were more pronounced for subjects with MS, indicating that the HFO was able to “target” the pathological gait patterns exhibited in this group. While changes in kinematics do not necessarily reflect changes in energetics [C. L. Lewis and D. P. Ferris, “Invariant hip moment pattern while walking with a robotic hip exoskeleton,” J. Biomech., vol. 44, no. 5, pp. 789-793, 2011, doi: 10.1016/j.jbiomech.2011.01.030], the shift to greater hip flexion suggests an increase in foot clearance and lower risk of toe-drag. To highlight this shift toward normative kinematics, an inter-limb comparison of peak hip flexion angle for subjects with MS is given in FIG. 12. The B1 condition resulted in the lowest inter-limb hip angle asymmetry for all but MS3, and was lower than all baseline trials for subjects with MS.

The HFO demonstrated a contribution to positive work at the hip during swing by assisting concentric contraction (FIG. 11A & FIG. 11B). During stance, it contributed to negative work at the hip by opposing extension. It has been shown that human locomotion requires a net positive amount of work, and that in unimpaired level walking, positive work done by the hip is substantially greater than negative work [P. DeVita, J. Helseth, and T. Hortobagyi, “Muscles do more positive than negative work in human locomotion,” J. Exp. Biol., vol. 210, no. 19, pp. 3361-3373, 2007, doi: 10.1242/jeb.003970]. In this study, all subjects with MS showed the opposite condition, with negative work exceeding positive work at the hip. While wearing the HFO, however, the net work at the hip was more positive than in no-device trials in nearly every case. In the most extreme case (MS4 B2), we observed a shift to net positive work. These findings suggest that the redistribution of mechanical energy by the HFO improved walking for people with MS.

The variability seen in neuromuscular responses, including several instances of subjects showing opposite responses to the same conditions, emphasizes the need for highly customizable assistive devices for people with MS. The members of the MS group in this study demonstrated a wide range of functional ability, but all wore the device in the same three configurations for experimental control. The HFO can be configured in numerous ways, and a customized approach with a clinician would be more appropriate to tailor the setup to the needs of a given individual.

Even with such variability, a consistent result was that the B1 condition tended to produce more pronounced effects than the B2 or B3 conditions. This is a particularly noteworthy finding, because B1 had the lowest stiffness of the bands tested, thereby introducing the smallest external loading. This trend was not due to the stiffer bands restricting range of motion at the hip, as the range of hip motion was generally consistent across trials. This suggests that there is an upper limit on device effectiveness as band stiffness increases, and presents the need for exploration of lower-stiffness bands in future studies. It has been shown that there are diminishing returns with increased assistance magnitude for a powered hip exoskeleton [I. Kang, H. Hsu, and A. Young, “The Effect of Hip Assistance Levels on Human Energetic Cost Using Robotic Hip Exoskeletons,” IEEE Robot. Autom. Lett., vol. 4, no. 2, pp. 430-437, 2019, doi: 10.1109/lra.2019.2890896], as well as with assistance onset timing for the same exoskeleton [A. J. Young, J. Foss, H. Gannon, and D. P. Ferris, “Influence of Power Delivery Timing on the Energetics and Biomechanics of Humans Wearing a Hip Exoskeleton,” Front. Bioeng. Biotechnol., vol. 5, no. March, pp. 1-11, 2017, doi: 10.3389/fbioe.2017.00004]. A similar phenomenon may be observed in the HFO, because both the magnitude and timing of its energy delivery are a function of the device configuration. Quantifying these parameters is not trivial: band stiffness, pre-tension, anchoring locations, user anthropometrics, device deformation, and individual gait characteristics all play a role in determining their values.

The results of the present study demonstrated that an inexpensive and mechanically passive orthosis can produce significant effects on leg joint kinematics and energetics, and specifically in people with MS. The changes observed in participants with MS trended toward more normative gait kinematics, suggesting the device helped restore some functionality for these individuals.

The N2, N3, and N4 trials were included to provide a baseline between the tests of the three different band stiffnesses, and to monitor the progression of the baseline condition. Inclusion of these trials showed that the initial baseline is subject to change substantially between device trials. Significant changes in subsequent baseline trials could be the result of acclimation to the task, or to carried-over effects of the device itself.

This study presented a soft, passive, unilateral hip flexion orthosis that was well-tolerated by healthy adults and adults with MS under three levels of compliance. For subjects with MS, all device trials showed a statistically significant increase in the peak hip flexion angle of the assisted leg. Net work at the hip was more positive in people with MS when wearing the HFO. Muscle activity responses were highly varied, emphasizing the need for case-by-case adjustments to the device configuration. This study demonstrated the efficacy of the HFO as a mobility-assisting device for people with MS. More generally, it demonstrated that passive devices can significantly affect walking mechanics, and that patient populations could benefit from redistribution, rather than addition, of mechanical energy from a wearable device.

### Example 3: Kinematics of Locomotor Transitions Between Level Ground and Stair Ambulation and their Implications in Assistive Device Control

Human ambulation is typically characterized during steady-state isolated tasks (e.g., walking, running, stair ambulation). However, general human locomotion comprises continuous adaptation to the varied terrains encountered during activities of daily life. To fill an important gap in knowledge that may lead to improved therapeutic and device interventions for mobility-impaired individuals, it is vital to identify how the mechanics of individuals change as they transition between different ambulatory tasks, and as they encounter terrains of differing severity. In this work, lower-limb joint kinematics were studied during the transitions between level walking and stair ascent and descent over a range of stair inclination angles. Using statistical parametric mapping, where and when the kinematics of transitions are unique were identified from the adjacent steady-state tasks. Results show unique transition kinematics primarily in the swing phase, which are sensitive to stair inclination. Gaussian process regression models were also trained for each joint to predict joint angles given the gait phase, stair inclination, and ambulation context (transition type, ascent/descent), demonstrating a mathematical modeling approach that successfully incorporates terrain transitions and severity. The results of this work further the understanding of transitory human biomechanics and motivate the incorporation of transition-specific control models into mobility-assistive technology.

Studies involving human mobility often isolate a particular task of interest, such as level walking or inclined walking, and attempt to capture the steady-state biomechanics driving that task. In contrast, general human ambulation involves continuous adjustment to the varying terrain one may encounter while moving from one place to the next. In order to better understand human movement, it is necessary to investigate the mechanics that enable successful transitions between these terrains and account for the severity of a given terrain.

The tasks of ascending and descending the steps of a staircase show the importance of adapting to varied terrain. Falls occurring on stairs present a significant public health risk to people of all ages [H. Nagata, “Analysis of fatal falls on the same level or on stairs/steps,” Saf. Sci., vol. 14, no. 3-4, pp. 213-222, 1991, doi: 10.1016/0925-7535(91)90022-E.; D. Friedland, I. Brunton, and J. Potts, “Falls and traumatic brain injury in adults under the age of sixty,” J. Community Health, vol. 39, no. 1, pp. 148-150, 2014, doi: 10.1007/s10900-013-9752-3.; F. Abolhassani, A. Moayyeri, M. Naghavi, A. Soltani, B. Larijani, and H. T. Shalmani, “Incidence and characteristics of falls leading to hip fracture in Iranian population,” Bone, vol. 39, no. 2, pp. 408-413, 2006, doi: 10.1016/j.bone.2006.01.144.], are responsible for over 1,000,000 visits to United States emergency departments annually [D. H. Blazewick, T. Chounthirath, N. L. Hodges, C. L. Collins, and G. A. Smith, “Stair-related injuries treated in United States emergency departments,” Am. J. Emerg. Med., vol. 36, no. 4, pp. 608-614, 2018, doi: 10.1016/j.ajem.2017.09.034], and represent a major cause of traumatic brain injury in adults [D. Friedland, I. Brunton, and J. Potts, “Falls and traumatic brain injury in adults under the age of sixty,” J. Community Health, vol. 39, no. 1, pp. 148-150, 2014, doi: 10.1007/s10900-013-9752-3]. Stairs can be particularly hazardous for the elderly, who must contend with age-related changes in mobility [N. Lythgo, R. Begg, and R. Best, “Stepping responses made by elderly and young female adults to approach and accommodate known surface height changes,” Gait Posture, vol. 26, no. 1, pp. 82-89, 2007, doi: 10.1016/j.gaitpost.2006.07.006.; H. J. Lee and L. S. Chou, “Balance control during stair negotiation in older adults,” J. Biomech., vol. 40, no. 11, pp. 2530-2536, 2007, doi: 10.1016/j.jbiomech.2006.11.001.; S. M. Reid, R. B. Graham, and P. A. Costigan, “Differentiation of young and older adult stair climbing gait using principal component analysis,” Gait Posture, vol. 31, no. 2, pp. 197-203, February 2010, doi: 10.1016/j.gaitpost.2009.10.005.; S. L. Chiu, C. C. Chang, J. T. Dennerlein, and X. Xu, “Age-related differences in inter-joint coordination during stair walking transitions,” Gait Posture, vol. 42, no. 2, pp. 152-157, 2015, doi: 10.1016/j.gaitpost.2015.05.003.] and are more likely to experience potentially-fatal bone fractures following a fall [H. Nagata, “Analysis of fatal falls on the same level or on stairs/steps,” Saf Sci., vol. 14, no. 3-4, pp. 213-222, 1991, doi: 10.1016/0925-7535(91)90022-E], [F. Abolhassani, A. Moayyeri, M. Naghavi, A. Soltani, B. Larijani, and H. T. Shalmani, “Incidence and characteristics of falls leading to hip fracture in Iranian population,” Bone, vol. 39, no. 2, pp. 408-413, 2006, doi: 10.1016/j.bone.2006.01.144]. There is also a wide range of allowable staircase dimensions within building regulations [“SECTION R311 MEANS OF EGRESS,” in 2021 International Residential Code, Country Club Hills, IL: ICC, 2021, p. R311.7 Stairways] which can be a confounder in studies about stair falls [J. V. Jacobs, “A review of stairway falls and stair negotiation: Lessons learned and future needs to reduce injury,” Gait Posture, vol. 49, no. 2016, pp. 159-167, 2016, doi: 10.1016/j.gaitpost.2016.06.030], furthering the difficulty of assessing fall hazards in a standardized manner [R. Blanchet and N. Edwards, “A need to improve the assessment of environmental hazards for falls on stairs and in bathrooms: Results of a scoping review,” BMC Geriatr., vol. 18, no. 1, 2018, doi: 10.1186/s12877-018-0958-1]. With many falls occur during the transitions between level ground and stair walking [J. Templer, G. M. Mullet, J. Archea, and S. T. Margulis, “An analysis of the behavior of stair users,” pp. 1-74, 1978, [Online]. Available: https://nvlpubs.nist.gov/nistpubs/Legacy/IR/nbsir78-1554.pdf], the mechanics employed during these transitionary phases are relevant to understanding these incidents.

Further motivation can be found in the area of powered mobility-assistive devices, where considerable research has focused on of how best to handle the transitions between level ground and stairs. Strategies range from the simple methods of user-operated switching [S. Culver, H. Bartlett, A. Shultz, and M. Goldfarb, “A stair ascent and descent controller for a powered ankle prosthesis,” IEEE Trans. Neural Syst. Rehabil. Eng., vol. 26, no. 5, pp. 993-1002, 2018, doi: 10.1109/TNSRE.2018.2819508], to volitional switching with EMG [O. A. Kannape and H. M. Herr, “Volitional control of ankle plantar flexion in a powered transtibial prosthesis during stair-ambulation,” 2014 36th Annu. Int. Conf. IEEE Eng. Med. Biol. Soc. EMBC 2014, pp. 1662-1665, 2014, doi: 10.1109/EMBC.2014.6943925.; B. H. Nakamura and M. E. Hahn, “Myoelectric Activation Pattern Changes in the Involved Limb of Individuals With Transtibial Amputation During Locomotor State Transitions,” Arch. Phys. Med. Rehabil., vol. 98, no. 6, pp. 1180-1186, 2017, doi: 10.1016/j.apmr.2016.12.003.; S. Au, M. Berniker, and H. Herr, “Powered ankle-foot prosthesis to assist level-ground and stair-descent gaits,” Neural Networks, vol. 21, no. 4, pp. 654-666, 2008, doi: 10.1016/j.neunet.2008.03.006], anticipatory strategies based on input from biomechanical sensors [K. G. Rabe and N. P. Fey, “Evaluating Electromyography and Sonomyography Sensor Fusion to Estimate Lower-Limb Kinematics Using Gaussian Process Regression,” Front. Robot. Al, vol. 9, no. March, pp. 1-15, 2022, doi: 10.3389/frobt.2022.716545], [A. M. Simon et al., “Delaying Ambulation Mode Transition Decisions Improves Accuracy of a Flexible Control System for Powered Knee-Ankle Prosthesis,” IEEE Trans. Neural Syst. Rehabil. Eng., vol. 25, no. 8, pp. 1164-1171, 2017, doi: 10.1109/TNSRE.2016.2613020], and more recently computer vision [B. Laschowski, W. McNally, A. Wong, and J. McPhee, “Computer Vision and Deep Learning for Environment-Adaptive Control of Robotic Lower-Limb Exoskeletons,” Annu. Int. Conf IEEE Eng. Med. Biol. Soc. IEEE Eng. Med. Biol. Soc. Annu. Int. Conf, vol. 2021, pp. 4631-4635, 2021, doi: 10.1109/EMBC46164.2021.9630064], [B. Laschowski, W. McNally, A. Wong, and J. McPhee, “Environment Classification for Robotic Leg Prostheses and Exoskeletons Using Deep Convolutional Neural Networks,” Front. Neurorobot., vol. 15, no. February, 2022, doi: 10.3389/fnbot.2021.730965]. To successfully emulate the fluency of able-bodied ambulation, an assistive device would ideally facilitate not only the timely transition between level walking and stair walking, but also the mechanics of the transition between the two terrains [D. H. Gates, J. Lelas, U. Della Croce, H. Herr, and P. Bonato, “Characterization of ankle function during stair ambulation,” Annu. Int. Conf. IEEE Eng. Med. Biol.—Proc., vol. 26 VI, pp. 4248-4251, 2004, doi: 10.1109/iembs.2004.1404184]. This was demonstrated in a recent study [S. Cheng, E. Bolivar-Nieto, C. G. Welker, and R. D. Gregg, “Modeling the Transitional Kinematics Between Variable-Incline Walking and Stair Climbing,” IEEE Trans. Med. Robot. Bionics, pp. 1-1, 2022, doi: 10.1109/tmrb.2022.3185405] that modeled transition kinematics by interpolating between steady-state modes and incorporating an additional term to account for kinematics only seen in transitions, operating on the assumption that transition kinematics require special treatment from a modeling perspective. Thus, identifying whether transition kinematics are unique and how they deviate from those of steady-state walking will supplement and motivate the continued refinement of assistive technologies.

Prior studies about stair biomechanics have noted that individuals share some basic mechanical patterns [B. J. McFadyen and D. A. Winter, “An integrated biomechanical analysis of normal stair ascent and descent,” J. Biomech., vol. 21, no. 9, pp. 733-744, 1988, doi: 10.1016/0021-9290(88)90282-5] when traversing stairs, and that stair inclination angle affects kinematics and kinetics in the lower limbs [L. A. Livingston, J. M. Stevenson, and S. J. Olney, “Stairclimbing kinematics on stairs of differing dimensions,” Arch. Phys. Med. Rehabil., vol. 72, no. 6, pp. 398-402, 1991], [R. Riener, M. Rabuffetti, and C. Frigo, “Stair ascent and descent at different inclinations,” Gait Posture, vol. 15, pp. 32-44, 2002]. Others have observed that the transitions between level walking and stair walking are accompanied by anticipatory mechanics and muscle activations [J. Peng, N. P. Fey, T. A. Kuiken, and L. J. Hargrove, “Anticipatory kinematics and muscle activity preceding transitions from level-ground walking to stair ascent and descent,” J. Biomech., vol. 49, no. 4, pp. 528-536, 2016, doi: 10.1016/j.jbiomech.2015.12.041], [R. C. Sheehan and J. S. Gottschall, “Stair walking transitions are an anticipation of the next stride,” J. Electromyogr. Kinesiol., vol. 21, no. 3, pp. 533-541, 2011, doi: 10.1016/j.jelekin.2011.01.007]. While these studies demonstrate that there are biomechanical responses elicited by transitions and terrain severity in stair walking, there are presently no studies that statistically characterize how and when the lower limb mechanics change under these circumstances.

In this study, the differences in sagittal-plane lower-limb joint trajectories during the locomotor transitions were highlighted between level walking and stair walking, as well as the effects of inclination angle on stair walking mechanics. This includes the transitions into and out of stair walking for both ascending and descending tasks, with these tasks repeated over four different inclination angles. Kinematic data collected from ten able-bodied subjects [E. Reznick, K. R. Embry, R. Neuman, E. Bolivar-Nieto, N. P. Fey, and R. D. Gregg, “Lower-limb kinematics and kinetics during continuously varying human locomotion,” Sci. Data, vol. 8, no. 1, pp. 1-15, 2021, doi: 10.1038/s41597-021-01057-9] was separated into level walking (LW), transition (TR), and stair walking (SW) strides. Using statistical parametric mapping (SPM), full-stride joint trajectories were compared against each other rather than specific points of interest, for a more holistic picture of how joint kinematics vary due to these contextual and environmental factors. It was hypothesized that transition strides will present unique joint kinematics when compared to those of level walking and stair walking. Furthermore, it was hypothesized that the angle of staircase inclination will affect kinematics in transition strides, despite the modest difference in stair height between inclinations.

Finally, a Gaussian process regression (GPR) was performed on the same dataset to predict joint angles based on continuous gait phase and stair grade as well as discrete ambulation context (e.g., ascending/descending, transition type). GPR is a “black-box” statistical method that has been used in gait-related contexts [Y. Yun, H. C. Kim, S. Y. Shin, J. Lee, A. D. Deshpande, and C. Kim, “Statistical method for prediction of gait kinematics with Gaussian process regression,” J. Biomech., vol. 47, no. 1, pp. 186-192, 2014, doi: 10.1016/j.jbiomech.2013.09.032; J. Hong, C. Chun, S. J. Kim, and F. C. Park, “Gaussian Process Trajectory Learning and Synthesis of Individualized Gait Motions,” IEEE Trans. Neural Syst. Rehabil. Eng., vol. 27, no. 6, pp. 1236-1245, 2019, doi: 10.1109/TNSRE.2019.2914095.; J. Zhang, H. An, Y. Huang, Q. Wei, and H. Ma, “Flat-upstairs gait switching of lower limb prosthesis via Gaussian process and improved Kalman filter,” 2021 6th IEEE Int. Conf Adv. Robot. Mechatronics, ICARM 2021, pp. 241-244, 2021, doi: 10.1109/ICARM52023.2021.9536178] for its ability to handle the highly nonlinear joint trajectories and to incorporate the variability of the underlying dataset [C. E. R. & C. K. I. Williams, Gaussian Processes for Machine Learning, 2nd ed. Cambridge, Massachusetts: The MIT Press, 2006]. Because transitions represent an interruption to the regularity enforced by evenly-spaced stairs or steady-speed treadmill walking, seeing higher variability was anticipated and therefore higher model error for transition kinematics. Using cross-validation to assess the model error for each joint over each task, it was hypothesized that there will be higher error in predictions of transition kinematics compared steady-state tasks.

Ten able-bodied subjects (5 male, 5 female, 19-59 yrs., 53.7-87.0 kg) participated in the study after providing written informed consentA custom set of 42 retroreflective markers was placed on anatomical landmarks of each subject's lower body in order to obtain 3-dimensional kinematics using a ten-camera motion capture system at 100 Hz (Vicon Motion Systems, Oxford, UK) and Vicon's Plug-in Gait pose estimation software.

Subjects were then asked to approach and ascend, and approach and descend a four-step set of stairs at a comfortable pace, using a step-over-step strategy (i.e., without skipping stairs or stepping on any one stair with both feet [S. M. REID, S. K. LYNN, R. P. MUSSELMAN, and P. A. COSTIGAN, “Knee Biomechanics of Alternate Stair Ambulation Patterns,” Med. Sci. Sport. Exerc., vol. 39, no. 11, pp. 2005-2011, November 2007, doi: 10.1249/mss.0b013e31814538c8]). Allowing approach to the steps at a comfortable pace rather than starting from rest at the first step was important for capturing the transitionary biomechanics sought for investigation [S. Vallabhajosula, J. M. Yentes, M. Momcilovic, D. J. Blanke, and N. Stergiou, “Do lower-extremity joint dynamics change when stair negotiation is initiated with a self-selected comfortable gait speed?,” Gait Posture, vol. 35, no. 2, pp. 203-208, 2012, doi: 10.1016/j.gaitpost.2011.09.007]. Subjects repeated ascending and descending tasks five times each with the stairs set at incline angles of 20°, 25°, 30°, and 35°, for a total of 20 ascents and 20 descents. The International Residential Code [“SECTION R311 MEANS OF EGRESS,” in 2021 International Residential Code, Country Club Hills, IL: ICC, 2021, p. R311.7 Stairways] stipulates a maximum riser height of 7.75″ and minimum tread depth of 10″, corresponding to an incline angle of 37.8°, which is approximated by the steepest setting of 35°. Level walking data was collected from one minute of walking on a treadmill at 1 m/s once the steady pace had been achieved. The speed was fixed, as the data was recorded as part of a study where walking speed was controlled for across subjects [E. Reznick, K. R. Embry, R. Neuman, E. Bolivar-Nieto, N. P. Fey, and R. D. Gregg, “Lower-limb kinematics and kinetics during continuously varying human locomotion,” Sci. Data, vol. 8, no. 1, pp. 1-15, 2021, doi: 10.1038/s41597-021-01057-9]. While 1 m/s is relatively slow for the average adult walking speed [C. P. Charalambous, “Repeatability of kinematic, kinetic, and electromyographic data in normal adult gait,” Class. Pap. Orthop., pp. 399-401, 1989, doi: 10.1007/978-1-4471-5451-8_101], this speed is more inclusive of elderly and amputee populations, and helps reflect the slow-down observed in anticipation of encountering stairs [J. Peng, N. P. Fey, T. A. Kuiken, and L. J. Hargrove, “Anticipatory kinematics and muscle activity preceding transitions from level-ground walking to stair ascent and descent,” J. Biomech., vol. 49, no. 4, pp. 528-536, 2016, doi: 10.1016/j.jbiomech.2015.12.041]. A portion of this raw dataset is available at [E. Reznick, K. R. Embry, R. Neuman, E. Bolivar-Nieto, N. P. Fey, and R. D. Gregg, “Lower-limb kinematics and kinetics during continuously varying human locomotion,” Sci. Data, vol. 8, no. 1, pp. 1-15, 2021, doi: 10.1038/s41597-021-01057-9].

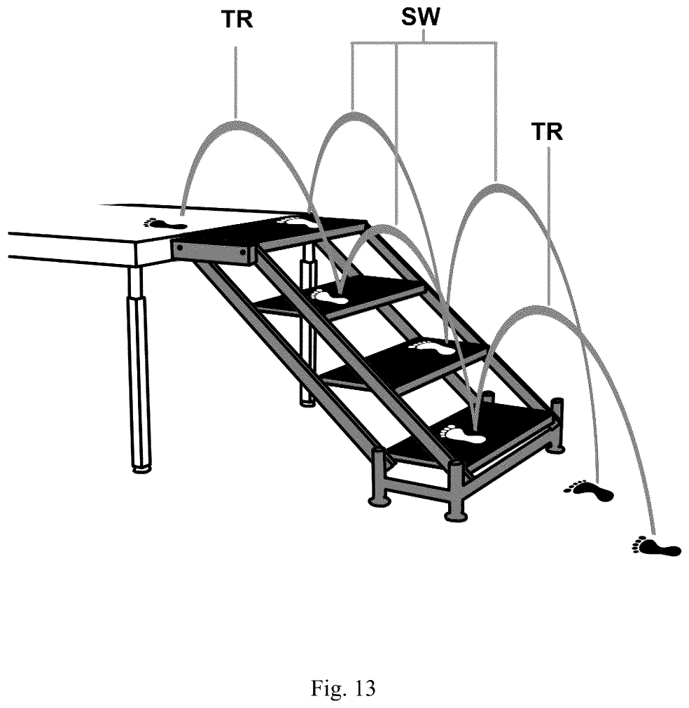

Raw trajectories were low-pass filtered (4^{th} order Butterworth, 6 Hz cutoff) and used as inputs to an inverse kinematic model to estimate ankle, knee, and hip joint kinematics in Nexus 2.8 (Vicon Motion Systems, Oxford, UK). A custom Matlab pipeline (Mathworks, Natick, MA, USA) was implemented to parse and time-normalize individual strides. Strides were classification into three types: level walking (LW), which came from treadmill walking; transitions (TR), which include the two strides that ascend/descend the height of a single step; and stair walking (SW), which was defined as the three strides that ascend/descend the height of two steps. It should be noted that this classification scheme counts the trailing leg transition stride as steady-state because it is based purely on the vertical displacement of the stride. FIG. 13 depicts the staircase and which strides were considered TR and SW.

Each subject's data were vetted for outliers, and then averaged to get one subject-representative ankle, knee, and hip trajectory for each stride type. These subject-representative strides were then used as the inputs for statistical tests. For every inclination angle and in both directions, the TR trajectories were compared against the LW and SW trajectories using statistical parametric mapping (SPM). SPM was carried out using the spm1d (spm1d.org) package in Matlab. SPM allows the generalization of classical statistical tests to time series data, so that regions of significant difference in trajectories instead of singular points of interest can be investigated [T. C. Pataky, J. Vanrenterghem, and M. A. Robinson, “Zero- vs. one-dimensional, parametric vs. non-parametric, and confidence interval vs. hypothesis testing procedures in one-dimensional biomechanical trajectory analysis,” J. Biomech., vol. 48, no. 7, pp. 1277-1285, 2015, doi: 10.1016/j.jbiomech.2015.02.051]. For transition analysis, paired t-tests across the ten subjects were conducted between LW and TR, and then between TR and SW, with α=0.95 and a Bonferroni correction for multiple comparisons. Paired t-tests were chosen over ANOVA to investigate transition behavior because the pairwise comparison of TR strides to LW and SS was of interest, but not the comparison of LW to SS, as these are different terrains entirely. Due to insufficient motion capture data, subjects 2, 6, 9, and 10 were omitted from the stair ascent to level walking transition. For the effects of inclination angle, a 1-way ANOVA was performed across the four inclinations, and significant main effects (p<0.05) were reported.

For each joint, a Gaussian process regression (GPR) model was trained on strides from all subjects for each inclination angle and task, with the goal of predicting the average joint angles for a given ambulation context (gait phase, stair incline, stride type, and direction). This resulted in a total of 3 GPRs performed to model the ankle, knee, and hip, based on all subjects pooled together. A GPR is a nonparametric, kernel-based probabilistic model [C. E. R. & C. K. I. Williams, Gaussian Processes for Machine Learning, 2nd ed. Cambridge, Massachusetts: The MIT Press, 2006] that was chosen here over traditional linear regression due to the complexity of the gait trajectories. The model ƒ(x) is a distribution over Gaussian functions with mean function m(x) and covariance function k(x,x′), which chosen as the squared exponential function.

$$f ( x ) \sim GP ( m ( x ) , k ( x , {x}^{′} ) ) \qquad Equation 1$$

$$k ( x , {x}^{′} \vert θ ) = {σ}_{f}^{2} exp [ - \frac{1}{2} \frac{{( x - {x}^{′} )}^{T} ( x - {x}^{′} )}{{σ}_{l}^{2}} ]$$

The mean function is the expected value of the posterior distribution of possible functions, and is used to make predictions. The covariance function is used to kernelize the prior functions, where σ_{ƒ} is the signal standard deviation, al is the characteristic length scale, and θ is a hyperparameter based on σ_{ƒ} and σₗ.

Leave-one-stride-out cross validation was used to obtain statistics on the root mean square error (RMSE) for each of the joint models during transitions and steady-state stair walking. A one-way ANOVA was performed to determine significantly (p<0.05) differing errors in both the ascending and descending tasks. When significance was encountered, pairwise comparisons were made using the Tukey-Kramer method.

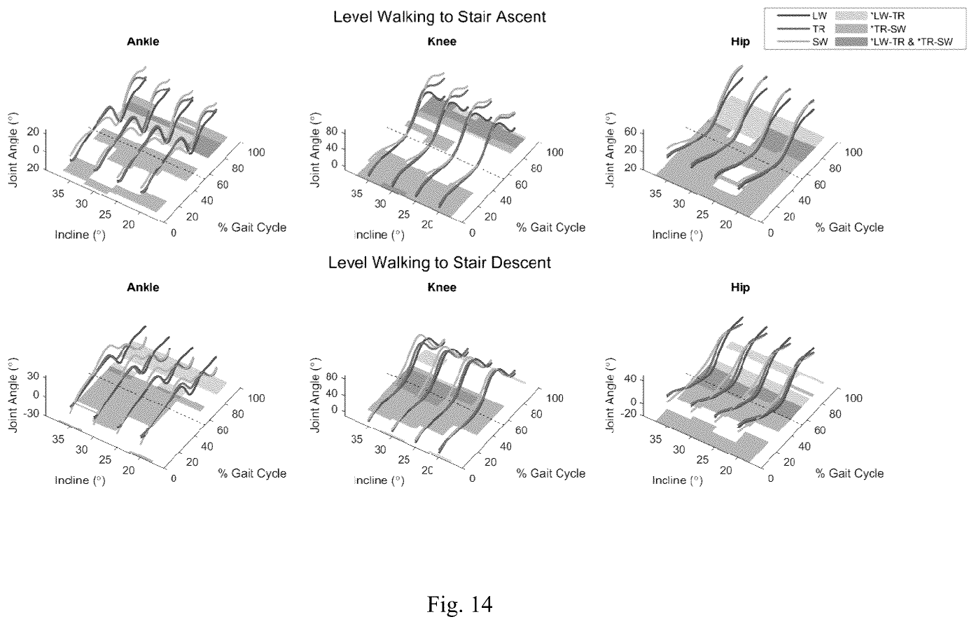

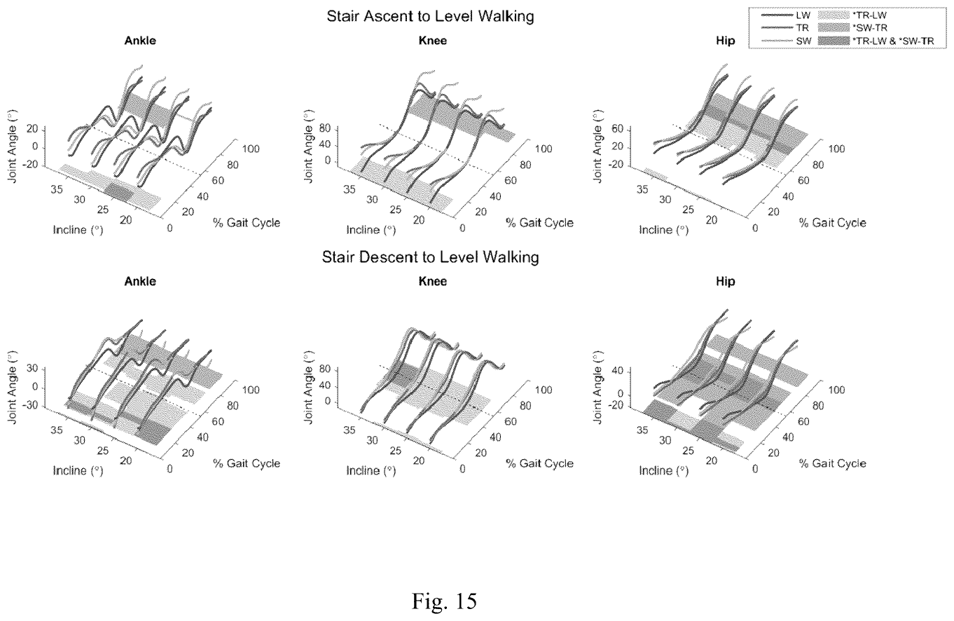

The following figures (FIG. 14 & FIG. 15) show the results obtained from SPM analyses of entire strides. For more information please see the methods section. Shaded areas behind the joint trajectories indicate regions of statistically significant difference between trajectories. Regions of difference between level walking and transition trajectories (LW-TR) and between transition and stair walking trajectories (TR-SW) are shown in the shaded regions of FIG. 14 & FIG. 15. In support of the hypothesis, regions of the TR trajectories were significantly different from those of LW and SW for every joint in every condition. Overlapping shaded regions indicate portions of TR trajectories that are statistically unique from LW and SW.

Level Walking to Stair Ascent: At the ankle, LW-TR significance appeared during mid-swing while TR-SW significance appeared in three distinct regions: early stance, late stance, and late swing. In the knee and hip, LW-TR significance appeared in mid-to-late stance. Hip TR-SW significance was generally present for all of stance and into early swing, while for the knee TR-SW was significant in early stance and various portions of swing. Significance did not appear related to the inclination angle.

Level Walking to Stair Descent: At the ankle, LW-TR significance appeared during late swing while TR-SW was significant during mid-late stance and early swing. At the knee, LW-TR significant differences were observed around the transition from stance to swing, though this was not observed at the 20° incline. Knee TR-SW differences were seen in a consistent, contiguous region from mid-late stance through early swing. At the hip, LW-TR significance was seen in early swing and late swing, while TR-SW significance occurred in early stance and late stance to early swing. TR-SW regions of significance in the ankle and knee tended increase with increasing inclination.

Stair Ascent to Level Walking: TR-LW significance was observed in early stance for every joint. For the hip joint, TR-LW significance was also present in early-to-mid swing. SW-TR significance occurred in late swing for all joints, and additionally during early stance at the ankle for one inclination. Higher inclination angles saw more SW-TR significance in the ankle and knee, and less TR-LW significance at the ankle.

Stair Descent to Level Walking: At the ankle, TR-LW differences were present in large regions spanning from mid stance to mid swing and SW-TR differences were seen in mid stance and late swing. TR-LW differences in the knee were observed from late stance through early swing. Very few regions of significant difference in SW-TR at the knee were observed, showing a sustained duration only in the 35° condition. For the hip, LW-TR differences were present in early stance and from late stance to early swing, while TR-LW differences spanned from mid stance through terminal swing.

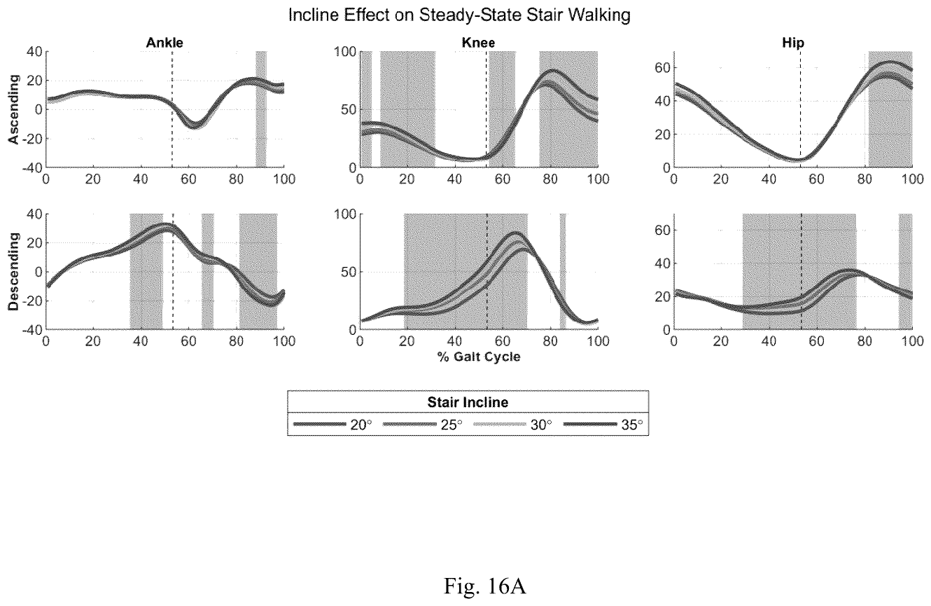

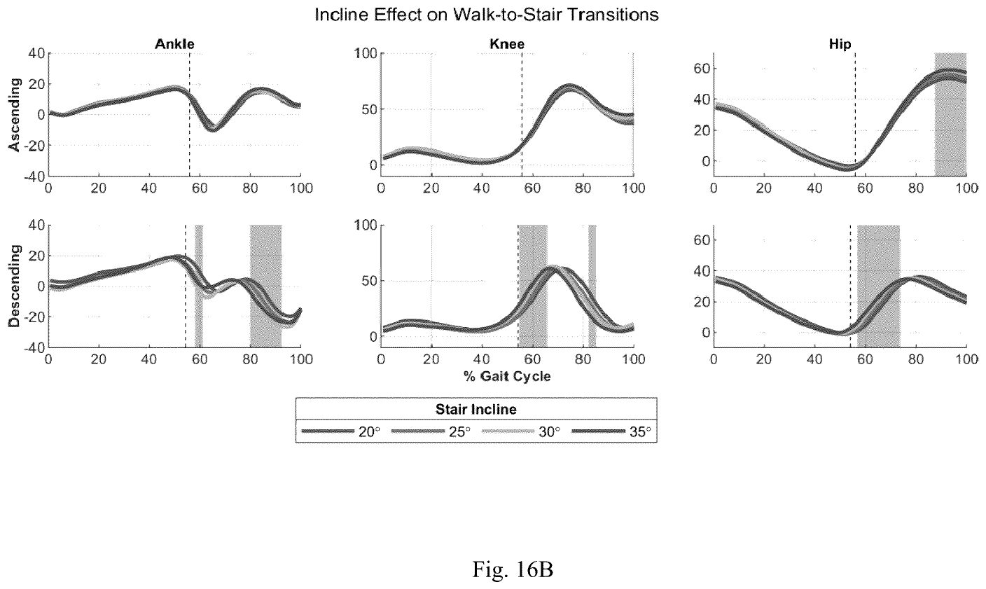

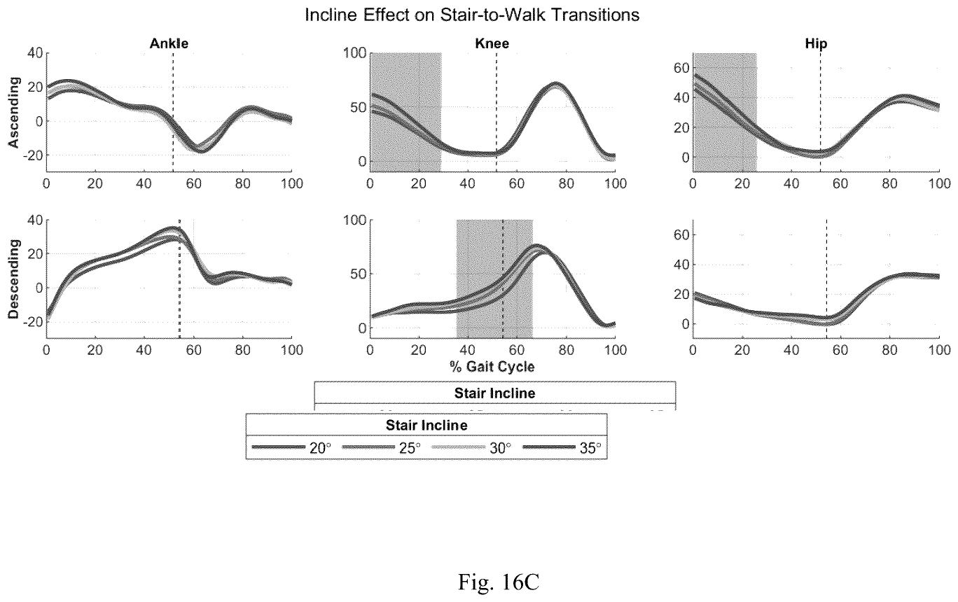

Statistical Parametric Mapping (SPM) ANOVAs were performed exploring the effects of stair incline on SW and TR strides, and results are shown in FIG. 16A, FIG. 16B, and FIG. 16C. Here, shaded regions indicate main effects due to stair incline. While inclination angle affected at least one joint in all stride types, the majority of significant effects were observed in SW trajectories. Knee angles in particular showed effects due to incline over much of the gait cycle.

A Gaussian process regression (GPR) model was trained on the collected data to allow continuous prediction of a joint angle based on the gait phase, inclination angle, direction of travel (ascending/descending), and ambulation task (steady-state stair, walk-to-stair, stair-to-walk). The root mean square error (RMSE) of model predictions based on leave-one-stride-out cross-validation is reported, and one-way ANOVAs determined that the ambulation task significantly (p<0.05) affected the model error only for the ankle joint during stair ascent, where the stair-to-walk error was greater than both walk-to-stair and steady-state errors. Errors were largest in the knee joint and smallest in the ankle joint for all tasks.

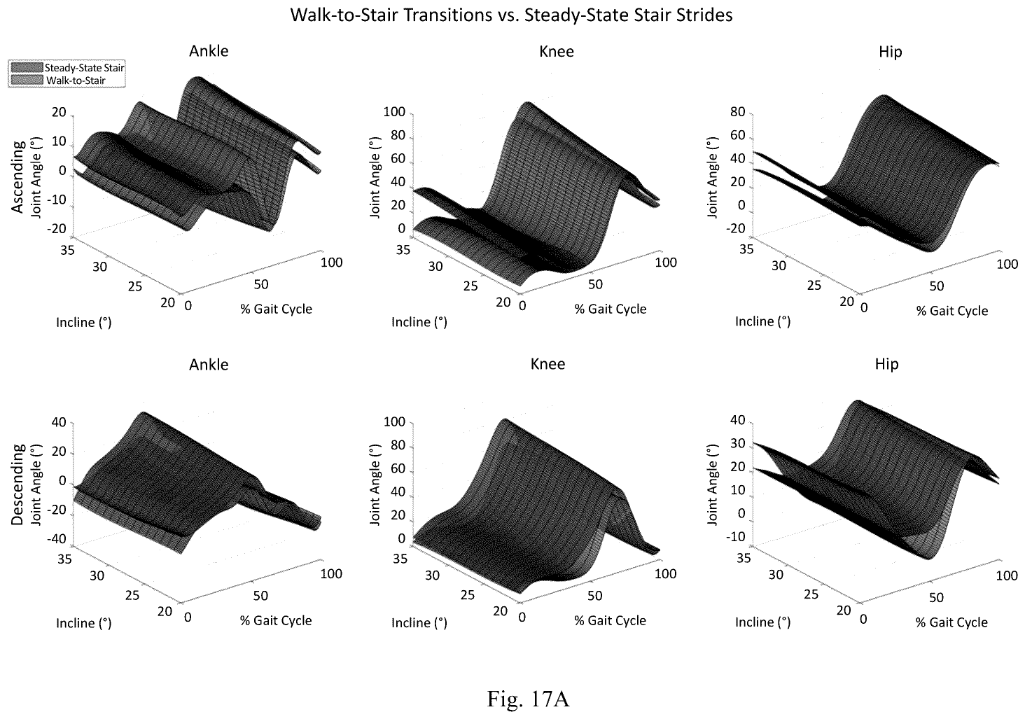

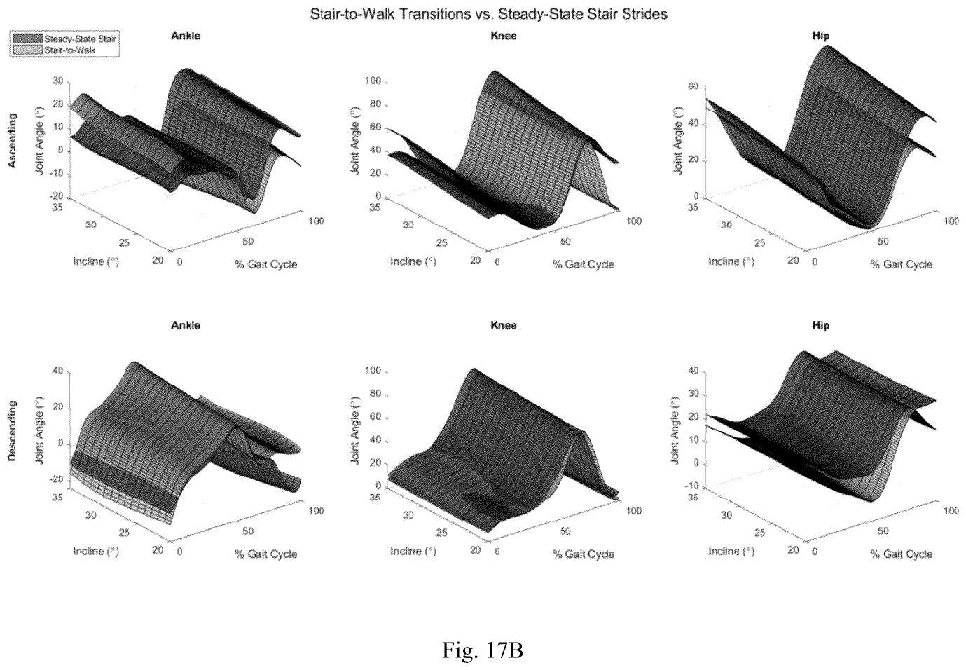

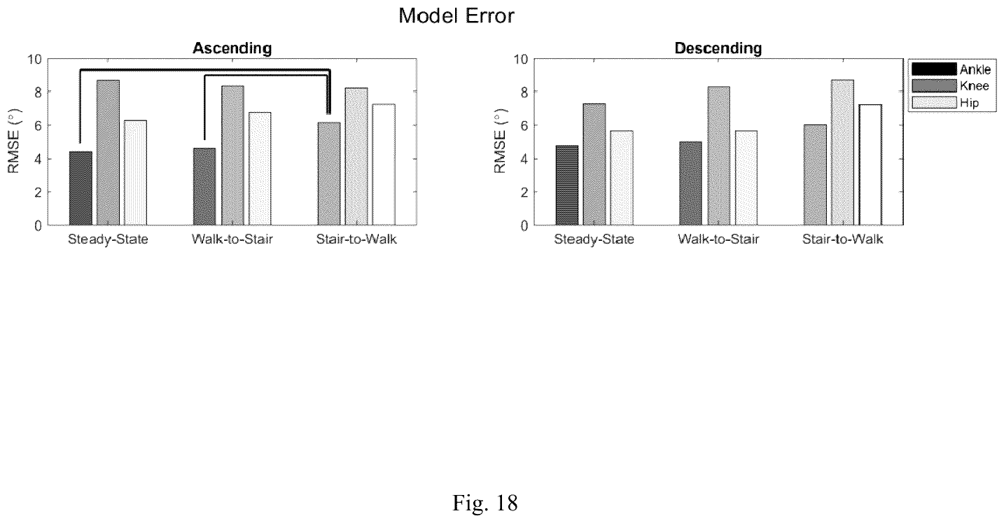

Using the GPR models, the predicted joint kinematics as a continuous surface over gait phase and stair inclination were plotted (FIG. 17A & FIG. 17B). These plots helped visualize the trends seen in FIG. 16A, FIG. 16B, and FIG. 16C. With increasing inclination angle, the peak knee flexion, hip flexion, dorsiflexion, and plantarflexion angles increased for steady-state stair walking. In walk-to-stair transitions, however, inclination angle had little effect on knee or ankle angles, while hip angles were still influenced. In stair-to-walk transitions, increasing inclination again caused general increases in peak angles for all joints, however the knee and hip saw changes during early stance rather than mid-late stance during ascending tasks. Leave-one-stride-out cross validation results (FIG. 18, Table 3) showed that model errors were largely unaffected by the task, with only the ascending ankle tasks showing significant main effects, and pairwise comparisons indicating this was due to the error being significantly higher in the stair-to-walk task in this subset. In general, these results run counter to the hypothesis that the error would be higher during transition tasks.

TABLE 3
Model error ANOVA. Model errors given as mean
(standard deviation) in degrees. (*) indicates that
there were significant (p < 0.05) effects on model
error due to stride type according to a 1-way ANOVA.

| Direction | Ascending | | | Descending | | |
|---|---|---|---|---|---|---|
| | | Walk- | Stair- | | Walk- | Stair- |
| Stride | Steady- | to- | to- | Steady- | to- | to- |
| Type | State | Stair | Walk | State | Stair | Walk |
| Ankle | 4.40 | 4.60 | 6.15 | 4.76 | 5 | 6.02 |
| | (1.92)* | (1.55)* | (1.52)* | −2.26 | −3.12 | 2.94 |
| Knee | 8.68 | 8.35 | 8.21 | 7.28 | 8.28 | 8.7 |
| | 3.83 | −4.05 | −3.54 | −3.2 | −3.48 | 3.46 |
| Hip | 6.29 | 6.74 | 7.24 | 5.65 | 5.64 | 7.22 |
| | 2.98 | −3.29 | −2.38 | −2.97 | −2.86 | 4.55 |

In this study, the uniqueness of lower-limb joint kinematics during the transition strides between level walking and stair walking in able-bodied adults were demonstrated. Furthermore, the specific regions of the gait cycle where TR strides differed from those of LW and SW were identified. Visually, the kinematics show that TR trajectories tend to form a “hybrid stride” that closely tracks the previous ambulation mode early in the gait cycle, then tracks the following ambulation mode by the end of the cycle. While this pattern makes intuitive sense—TR strides facilitate a change from one steady state to the next—the findings presented here represent the first to quantify the way these changes occur. By statistically identifying the regions of the gait cycle over which kinematics differ for each joint, the details of when, where, and to what extent these broader transitory patterns hold true were explored. The existence of unique transition kinematics demonstrates the frequently-adapting nature of general human locomotion and provides valuable insight and reference material for the developers of mobility-assistive technology. It was also demonstrated that joint kinematics can be predicted with reasonable accuracy by a Gaussian process regression model given the gait phase, stair inclination angle, direction of travel, and stride type.

Level Walking to Stair Transitions: The transition from level walking to stair descent is perhaps the most crucial of the four transitions presented, given the injury potential from experiencing a fall at the top of a staircase. In this task, ankle TR trajectories (FIG. 14) provide a clear example of where abruptly changing from LW to SW is not ideal. While TR and LW are nearly identical from 0-60% GC, there is a sharp divergence around 80% GC, after which TR and SW are closely aligned for the remainder of the stride. In this region of late stance, TR and SW strides show a large plantarflexion peak as subjects prepare to make forefoot contact with the following stair [R. Riener, M. Rabuffetti, and C. Frigo, “Stair ascent and descent at different inclinations,” Gait Posture, vol. 15, pp. 32-44, 2002], where the plantar flexors are active in controlling the progression velocity [T. Cluff and D. G. E. Robertson, “Kinetic analysis of stair descent: Part 1. Forwards step-over-step descent,” Gait Posture, vol. 33, no. 3, pp. 423-428, March 2011, doi: 10.1016/j.gaitpost.2010.12.016]. While comprising only a small portion of the TR stride, this quick switch in ankle kinematic strategy may be crucial to safely transition from level walking to stair descent. Hip trajectories also show a departure from LW in late stance for this transition, extending earlier to make foot contact with a lower surface.

The transition into stair ascent also presents a fall risk, particularly in the case that the foot fails to clear the initial step. Furthermore, the forces experienced by the joints upon contact with this initial step can be far higher than in level walking [P. A. Costigan, K. J. Deluzio, and U. P. Wyss, “Knee and hip kinetics during normal stair climbing,” Gait Posture, vol. 16, no. 1, pp. 31-37, 2002, doi: 10.1016/S0966-6362(01)00201-6]. The disclosed data again suggest that neither LW nor SW trajectories would be sufficient substitutes for the TR stride: not only is the vertical displacement between consecutive foot contacts half of that in SW, but the horizontal distance is subject to vary substantially depending on the subject's approach to the stairs [R. C. Sheehan and J. S. Gottschall, “Stair walking transitions are an anticipation of the next stride,” J. Electromyogr. Kinesiol., vol. 21, no. 3, pp. 533-541, 2011, doi: 10.1016/j.jelekin.2011.01.007]. The knee trajectories reflect this intermediate step height, as swing-phase TR angles fall between LW and SW by a large enough margin to register as unique. Swing-phase uniqueness is present at the ankle as well: rather than simply switching to resemble SW following the plantarflexion peak prior to toe-off, ankle TR strides plantarflex at mid-swing and terminate at an angle much closer to zero (horizontal foot placement) than is seen in SW. This behavior might serve to address the newly-encountered higher terrain by first dorsiflexing to insure foot clearance and aid in propulsion [Y. C. Lin, L. A. Fok, A. G. Schache, and M. G. Pandy, “Muscle coordination of support, progression and balance during stair ambulation,” J. Biomech., vol. 48, no. 2, pp. 340-347, 2015, doi: 10.1016/j.jbiomech.2014.11.019], [N. G. Harper, J. M. Wilken, and R. R. Neptune, “Muscle Function and Coordination of Stair Ascent,” J. Biomech. Eng., vol. 140, no. 1, pp. 1-11, January 2018, doi: 10.1115/1.4037791], and then plantarflexing early to meet the level of the initial stair with the forefoot [S. D. Prentice, E. N. Hasler, J. J. Groves, and J. S. Frank, “Locomotor adaptations for changes in the slope of the walking surface,” Gait Posture, vol. 20, no. 3, pp. 255-265, 2004, doi: 10.1016/j.gaitpost.2003.09.006]. The hip trajectories for this transition into stair ascent are a clear example of a hybrid stride, where the strategy seems to switch from level walk to stair ascent upon switching from stance to swing. This is consistent with past findings about anticipatory adjustments for accommodating level changes [B. J. McFadyen and H. Carnahan, “Anticipatory locomotor adjustments for accommodating versus avoiding level changes in humans,” Exp. Brain Res., vol. 114, no. 3, pp. 500-506, 1997, doi: 10.1007/PL00005659].

Stair Walking to Level Transitions: Moving from stair descent to level walking has been reportedly difficult for elderly populations [H. J. Lee and L. S. Chou, “Balance control during stair negotiation in older adults,” J. Biomech., vol. 40, no. 11, pp. 2530-2536, 2007, doi: 10.1016/j.jbiomech.2006.11.001]. In the disclosed statistical analysis, the trend where ankle TR strides form a hybrid of SW and LW was again observed, with a period of unique kinematics around the time of swing initiation. Meanwhile, TR trajectories at the knee show little to no difference from SW, with compensation for the transitions occurring instead at the hip. The hip joint TR achieves greater peak extension than SW, potentially indicating a longer step length as the leading leg lands on level ground, and then assumes LW-like swing mechanics with flexion lasting through foot contact.

Transitions from stair ascent to level walking, notably, were the only task of the four in which ankle TR trajectories were significantly different from the preceding mode during early stance, presenting with a large amount of dorsiflexion just after foot contact. This is also the only example of a peak ankle TR angle that is consistently greater than either SW or LW. This could again be preparing the leading leg to take a larger stride than preceding SW strides given the lack of step placement constraints imposed by stairs. The similar trend seen at the knee, with greater early stance flexion in TR than in SW or LW, corroborates this idea-if the TR stride is longer than SW, but still needs to cover a vertical distance of one stair, then the ankle and knee must undergo greater flexion to allow the leading leg to plant at the desired location.

The kinematics observed in the present analysis suggest the need for special treatment of transition strides between level walking and stair walking, rather than simply switching from one steady-state mode to the next. Importantly, the disclosed results show that the strategies adopted to facilitate these transitions should treat each of the four transition types as its own special case. For example, the stance phase ankle trajectories in three of the four transition types would be sufficiently approximated by the preceding mode, which also supports the finding that delaying the transition between walk and stair modes in a powered prosthesis largely does not affect the user [A. M. Simon et al., “Delaying Ambulation Mode Transition Decisions Improves Accuracy of a Flexible Control System for Powered Knee-Ankle Prosthesis,” IEEE Trans. Neural Syst. Rehabil. Eng., vol. 25, no. 8, pp. 1164-1171, 2017, doi: 10.1109/TNSRE.2016.2613020]. However, this may not hold for stair ascent to level walking, where there is unique dorsiflexion seen in early stance. It has been suggested that appropriately-timed dorsiflexion of a device during stair ascent could help with vertical and forward propulsion of the leg as seen in able-bodied studies [N. G. Harper, J. M. Wilken, and R. R. Neptune, “Muscle Function and Coordination of Stair Ascent,” J. Biomech. Eng., vol. 140, no. 1, pp. 1-11, January 2018, doi: 10.1115/1.4037791], [N. G. Harper, J. M. Wilken, and R. R. Neptune, “Muscle Function and Coordination of Amputee Stair Ascent,” J. Biomech. Eng., vol. 140, no. 12, pp. 1-10, December 2018, doi: 10.1115/1.4040772].

The ankle joint in particular shows the most unique kinematics throughout these tasks, and given its function as the last link in the kinematic chain before contact with the environment, much of the challenge in commanding a prosthesis to safely emulate natural locomotor transitions lies here. In ankle angle trajectories, not only are there differences in the amplitude of local maxima and minima between SW, TR, and LW, but there are differences in the concavity of the trajectory. Still, while foot position is most directly altered by the ankle joint, the knee and hip cannot be discounted. One significant concern is how drastically an amputee's hip trajectories will be affected by the weight and inertia of the prosthesis, particularly in the case of a transfemoral amputation. While one solution is to engineer the device to command excessive foot clearance, the inertial effects of such exaggerated motions could perturb balance. It was hypothesized that by aiming to emulate the unique transition kinematics of able-bodied persons, a more natural gait can be achieved.

Gaussian process regression models were trained across subjects for each joint to predict its angle using two categorical predictors (stride type, direction), and two continuous predictors (stair inclination angle, gait phase). RMSE results (Table 3) from leave-one-stride-out cross-validation indicated that average prediction error was between 4-8°. This demonstrates the usefulness of the GPR in that a single model can predict joint angles reasonably well when supplied with disparate data about the environment and ambulation context. As environment recognition continues to improve [B. Laschowski, W. McNally, A. Wong, and J. McPhee, “Environment Classification for Robotic Leg Prostheses and Exoskeletons Using Deep Convolutional Neural Networks,” Front. Neurorobot., vol. 15, no. February, 2022, doi: 10.3389/fnbot.2021.730965], use of both categorical and continuous mechanical data in device control will become more ingrained in device control. The model was also not sensitive to the type of stride undertaken as it was hypothesized, with only one example of statistically significant (p<0.05) difference in error due to stride type. Surface fitting using GPR models (FIG. 17A & FIG. 17B) demonstrated how a smooth surface can be used to represent continuous changes in terrain with relatively low errors in the predicted joint angles. This kind of model could be used to generate lookup tables for joint trajectories in controllers that account for the severity of terrain. The surfaces also provide visual insight into the complex effects of both terrain severity and stride type on joint trajectories. It was hypothesized that the steady-state models would predict joint trajectories with lower error than the transition models because transitions pose fewer physical constraints to limb motion, and therefore allow for greater variability between subjects. Statistical analysis showed that there were only significant differences in error between tasks for the ankle joint during stair ascent.

The analyses show that among the four types of transitions between level walking and stair walking, there are numerous instances of joint trajectories not seen in either of the steady-state modes, and that these unique trajectories may occur at different parts of the gait cycle or in different joints depending on which transition type is being executed. This study encourages efforts to handle transition strides as more than a timed switching between steady-state modes of ambulation. It was also reported where each joint is significantly affected by differences in the inclination angle of the stairs. Finally, it was shown that Gaussian process regression models can be trained on all of these factors and across subjects to predict joint angles reasonably well, a possible way to generate reference trajectories for the control of powered assistive devices.

### Example 4: Modeling the Influence of the Human Form and Ambulation Context on Moment- and Power-Generating Abilities of Soft Hip Flexion Exosuits

Exosuits are close-fitting devices, which are meant to be worn without restricting the motion of the user in the way that a rigid device would. The HFO disclosed herein is an example of an exosuit. These soft devices augment lower-limb biomechanics by using flexible, joint-spanning linear elements that are actuated to create moments about the spanned joints, effectively using the human body as the mechanical transmission from input to output. Consequently, the size of the moment arm that an exosuit creates about a given joint is dependent on the size and shape of the user, as well as their individualized gait patterns that depend on the terrain they are negotiating. These highly-variable human and environmental factors affect the performance of all soft exosuits (both passive and active), and the ability to quantify these effects would benefit assistive device development. In the disclosed study, a system for modeling the effects of user body mass index, biological sex, and gait kinematics on task-dependent exosuit performance is presented. This system was used to estimate the performance of a hip-flexion exosuit over a range of body shapes obtained from a database of 3D human surface models, and with gait kinematics from physical experiments. The disclosed results demonstrate that the user's body mass index, sex, and gait kinematics are necessary factors to consider when designing an exosuit for personalized assistance. This type of analysis can allow device developers to account for the unique shape and gait patterns of individuals, either in generating new designs, developing online control algorithms, or in configuring devices for specific individuals.

Recently, considerable research has been conducted in the development of textile-based mobility-assisting orthoses that aim to alter walking mechanics through the actuation of elements that span one or more of the lower-limb joints. Often referred to as soft exosuits, these compliant mechanical aids possess several key advantages over devices with rigid linkages, including high levels of adjustability, low mass, and improved user comfort [G. S. Sawicki, O. N. Beck, I. Kang, and A. J. Young, “The exoskeleton expansion: Improving walking and running economy,” J. Neuroeng. Rehabil., vol. 17, no. 1, pp. 1-9, 2020, doi: 10.1186/s12984-020-00663-9]. However, the lack of rigid linkages generally prohibits the engineer from mounting a motor concentrically with the joints they wish to augment-instead these designs require developing tension through single- or multi-joint-spanning elements to create a moment about the spanned joint(s). Regardless of whether this tensile force is developed with motor-driven cables, pneumatic actuators, or passive elements, the force is inevitably scaled by the moment arm it creates about a person's anatomical joint(s). Given the wide variety of people who could benefit from using this technology, it was important to investigate how human characteristics, both geometric and motion-related, contribute to the phase-dependent mechanical advantage a given device can develop.

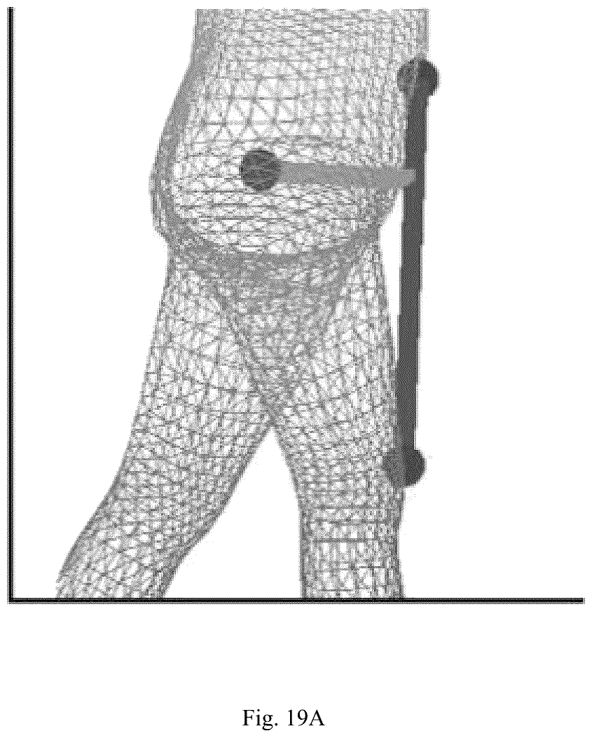

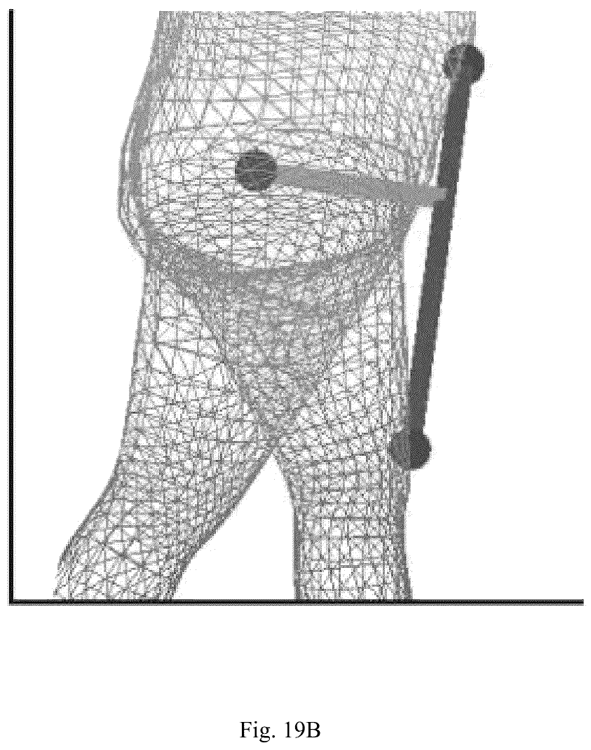

The moment arm about a joint is a geometric property that affects any soft exosuit as previously described. Importantly, the moment arm is dependent on the user's body shape and the instantaneous pose they assume (FIG. 19A & FIG. 19B). These factors also affect the length of the element as it interfaces with the surface of the body, which has design implications like motor gearing or the stiffness of passive structures within the device. It is therefore vital that exosuits are made with user anthropometrics in mind, particularly if they are to be used in assistive and rehabilitative settings, where patient populations may have high variability in gait characteristics and high rates of obesity due to inactivity [S. M. McPhail, M. Schippers, and A. L. Marshall, “Age, physical inactivity, obesity, health conditions, and health-related quality of life among patients receiving conservative management for musculoskeletal disorders,” Clin. Interv. Aging, vol. 9, pp. 1069-1080, 2014, doi: 10.2147/CIA.S61732].

To investigate the relationship between a device's attachment points, its user's size and shape, and the mechanical advantage it possesses during movement, this research presents a computational model to simulate the behavior of a flexible contractile element during human movement. A 3D surface model of the user, 3D joint kinematics, and attachment locations for the contracting element are input into the model, which estimates the length of the contracting element and the 3D moment arm about the joint it spans. Further, by analyzing successive frames of a motion in time, dynamic calculations are made to obtain estimates for the amount of power the device delivers to or absorbs from the user. Using this model, this paper presents a performance comparison study of a hip-flexion exosuit on models of male and female subjects of ranging body mass index (BMI) during widely-varying ambulation scenarios. This research targets hip flexion assistance because devices anchored to the waist are subject to high geometric variability depending on the adiposity of the subject, and because prior research has suggested that assisting hip flexion is an efficient way for devices to reduce the metabolic cost of walking [C. L. Dembia, A. Silder, T. K. Uchida, J. L. Hicks, and S. L. Delp, “Simulating ideal assistive devices to reduce the metabolic cost of walking with heavy loads,” PLoS One, vol. 12, no. 7, pp. 1-25, 2017, doi: 10.1371/journal.pone.0180320]. Using a set of surface models of hypothetical subjects representing a statistical cross-section, this work investigates the moment- and power-generating abilities of the hip-flexion exosuit during level walking, incline and decline walking, and stair ascent and descent.

To realize more effective design implementations for lower-limb soft exosuits and/or understanding how they can benefit specific device wearers, it is critical to ensure that a device can accommodate a wide range of user body characteristics, as well as its interaction with a person's own unique gait pattern that varies from one ambulation task to another [E. Reznick, K. R. Embry, R. Neuman, E. Bolivar-Nieto, N. P. Fey, and R. D. Gregg, “Lower-limb kinematics and kinetics during continuously varying human locomotion,” Sci. Data, vol. 8, no. 1, pp. 1-15, 2021, doi: 10.1038/s41597-021-01057-9], [M. Spanjaard, N. D. Reeves, J. H. Van Dieën, V. Baltzopoulos, and C. N. Maganaris, “Lower-limb biomechanics during stair descent: Influence of step-height and body mass,” J. Exp. Biol., vol. 211, no. 9, pp. 1368-1375, 2008, doi: 10.1242/jeb.014589], [K. Wang et al., “Differences between Gait on Stairs and Flat Surfaces in Relation to Fall Risk and Future Falls,” IEEE J. Biomed. Heal. Informatics, vol. 21, no. 6, pp. 1479-1486, 2017, doi: 10.1109/JBHI.2017.2677901]. As such, this research provides insights into mobility augmentation which may help to enhance devices that demonstrate an intended biomechanical benefit such as to reduce the metabolic cost [L. M. Mooney, E. J. Rouse, and H. M. Herr, “Autonomous exoskeleton reduces metabolic cost of human walking,” J. Neuroeng. Rehabil., vol. 11, no. 1, p. 151, 2014, doi: 10.1186/1743-0003-11-151], [L. Chen, C. Chen, Z. Wang, X. Ye, Y. Liu, and X. Wu, “A novel lightweight wearable soft exosuit for reducing the metabolic rate and muscle fatigue,” Biosensors, vol. 11, no. 7, pp. 1-15, 2021, doi: 10.3390/bios11070215.; J. Kim et al., “Reducing the metabolic rate of walking and running with a versatile, portable exosuit,” Science (80-.)., vol. 365, no. 6454, pp. 668-672, 2019, doi: 10.1126/science.aav7536.; F. A. Panizzolo, C. Bolgiani, L. Di Liddo, E. Annese, and G. Marcolin, “Reducing the energy cost of walking in older adults using a passive hip flexion device,” J. Neuroeng. Rehabil., vol. 16, no. 1, pp. 1-9, 2019, doi: 10.1186/s12984-019-0599-4] of performing movement tasks or altering an individual's kinematics toward bilateral stepping symmetry [R. M. Neuman, S. M. Shearin, K. J. McCain, and N. P. Fey, “Biomechanical analysis of an unpowered hip flexion orthosis on individuals with and without multiple sclerosis,” J. Neuroeng. Rehabil., vol. 18, no. 1, pp. 1-13, 2021, doi: 10.1186/s12984-021-00891-7].

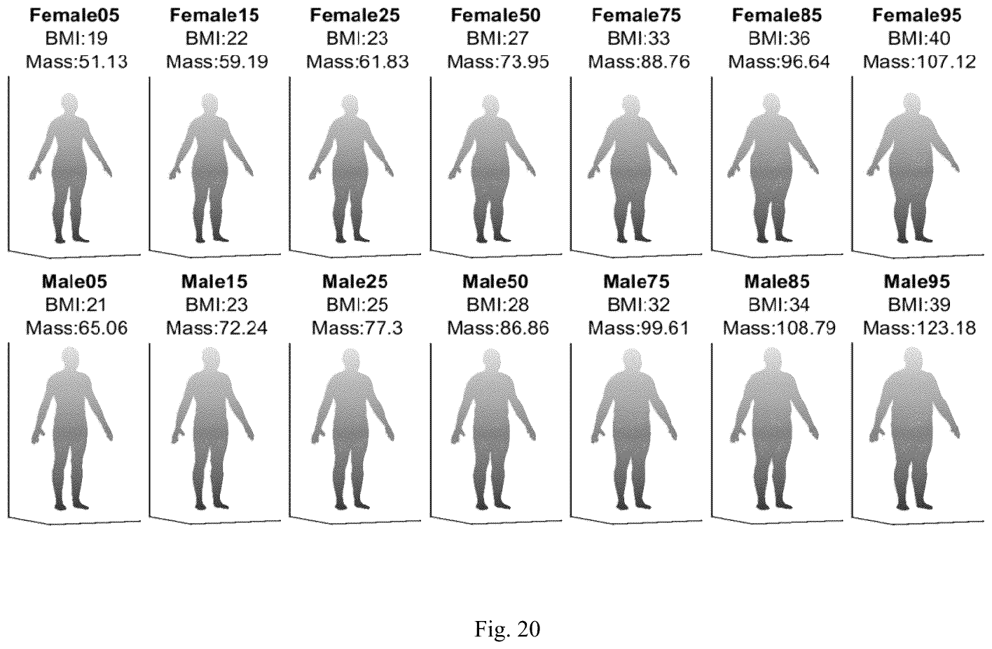

For the study, three-dimensional representations of the surface geometry of a range of human bodies were required. For this, the University of Michigan Transportation Research Institute's freely-available “body shape modeler” was used [B. Park and M. P. Reed, “BioHuman Human Shapes,” 2020. humanshape.org (accessed Aug. 6, 2021)]. The modeler parametrically generates a 3D surface model of the human form based on sex, height, BMI, sitting height-to-stature ratio, and age. These models are informed by statistics gathered from a database of high-resolution laser scans and anthropometric measurements [M. P. Reed, U. Raschke, R. Tirumali, and M. B. Parkinson, “Developing and Implementing Parametric Human Body Shape Models in Ergonomics Software,” 3rd Digit. Hum. Model. Symp., no. 1, pp. 1-8, 2014]. For the present analysis, a group of adult subject models were selected to cover a statistical cross-section of anthropometrics: 7 male, 7 female, average height, weight, and age for a US adult of the respective sex, and BMIs ranging from the 5th to 95th percentiles according to CDC data [C. D. C. Fryar et al., “Anthropometric Reference Data for Children and Adults: United States,” Vital Heal. Stat., vol. 11, no. 251, pp. 2007-2010, 2010, [Online]. Available: http://www.ncbi.nlm.nih.gov/pubmed/19642512%0A http://www.ncbi.nlm.nih.gov/pubmed/25585443%0A http://www.ncbi.nlm.nih.gov/pubmed/28437242%0A http://www.cdc.gov/nchs/data/series/sr_11/sr11_252.pdf]. Subject models and their BMI, height, and mass are shown in FIG. 20. Because BMI does not represent the body composition of shorter and taller subjects equally [S. B. Heymsfield, D. Gallagher, L. Mayer, J. Beetsch, and A. Pietrobelli, “Scaling of human body composition to stature: New insights into body mass index (American Journal of Clinical Nutrition (2007) 86, (82-91)),” Am. J. Clin. Nutr., vol. 88, no. 3, p. 810, 2008], the height was held constant to prioritize analysis of varying body shapes, i.e. distribution of adiposity.

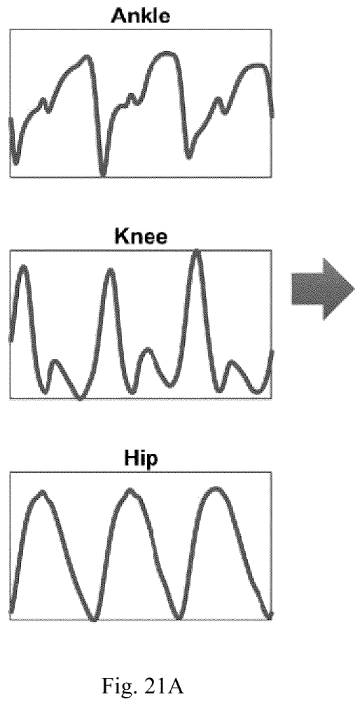

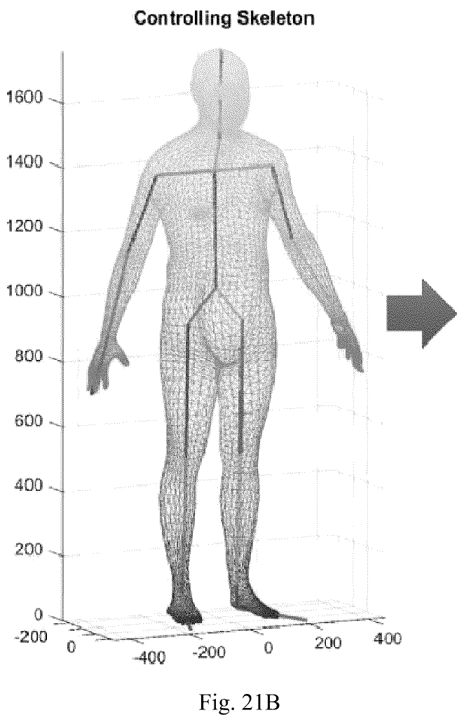

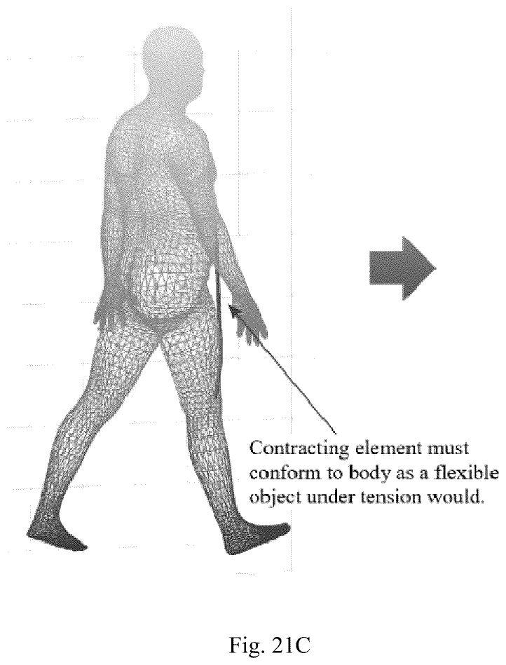

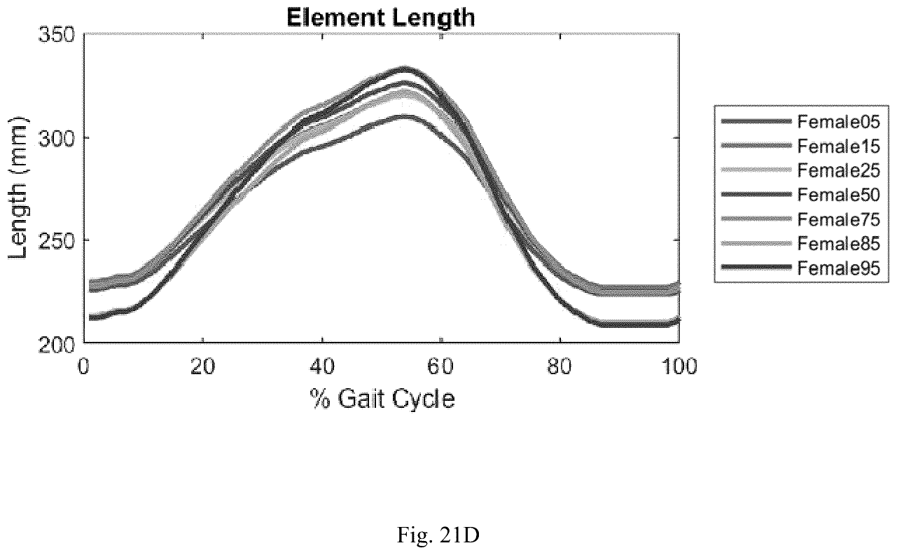

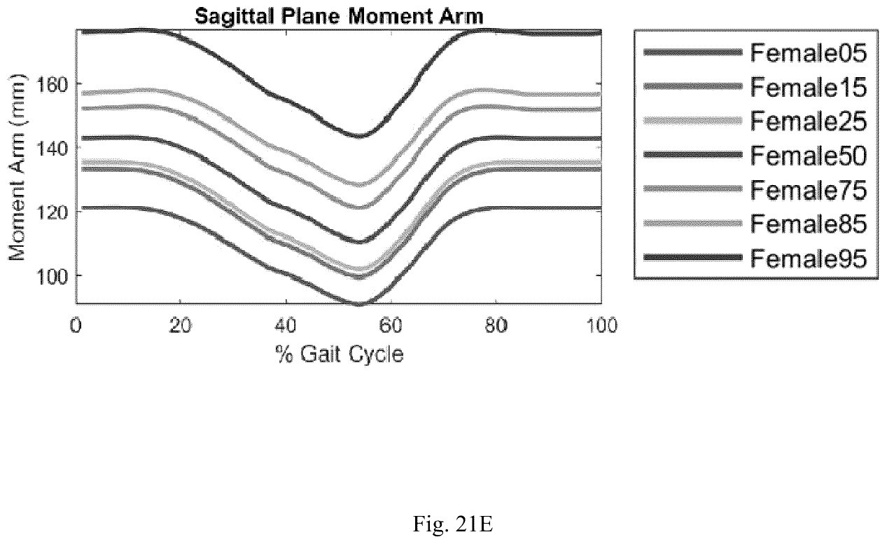

To simulate realistic human-device interactions, a custom software pipeline was implemented in MATLAB (MathWorks, Natick, MA, USA). First, a process similar to the one described by Yan et al. [H. B. Yan, S. Hu, R. R. Martin, and Y. L. Yang, “Shape deformation using a skeleton to drive simplex transformations,” IEEE Trans. Vis. Comput. Graph., vol. 14, no. 3, pp. 693-706, 2008, doi: 10.1109/TVCG.2008.28] was used to define a controlling skeleton underlying the surface mesh. Joint center locations provided with the surface models were used to mark the joints of the skeleton, and the “bones” were represented as straight lines connecting the joints, as depicted in FIG. 21B. By mapping each bone to control a set of vertices on the mesh, the mesh can be deformed according to the pose of the underlying skeleton (with some additional optimization to preserve the shape of the body-see [H. B. Yan, S. Hu, R. R. Martin, and Y. L. Yang, “Shape deformation using a skeleton to drive simplex transformations,” IEEE Trans. Vis. Comput. Graph., vol. 14, no. 3, pp. 693-706, 2008, doi: 10.1109/TVCG.2008.28] for details). With this system, 3D joint angles are input to achieve the desired pose of the surface model. It is then straightforward to use experimentally-obtained joint kinematics to generate a series of poses representative of the movement of a subject's body surface throughout a task. For the present study, averaged strides from ten subjects (5 male, 5 female, aged 20-60 yrs.) walking on level ground, ascending and descending a 10° incline, and ascending and descending a staircase at 35°, were used [E. Reznick, K. R. Embry, R. Neuman, E. Bolivar-Nieto, N. P. Fey, and R. D. Gregg, “Lower-limb kinematics and kinetics during continuously varying human locomotion,” Sci. Data, vol. 8, no. 1, pp. 1-15, 2021, doi: 10.1038/s41597-021-01057-9].

For simulating the behavior of the contracting element on the surface of the individual, a wrapping algorithm was implemented to first define a path along the surface connecting the proximal and distal attachment points, then iteratively checked points along this path for intersections with the surface mesh to realistically wrap or lift off of the surface as a non-adhesive flexible element under tension would be expected to do, as shown in FIG. 21C. Doing this obtains the length of the element in the given pose. The moment arm is then calculated as the perpendicular distance between the line of action of the element and the hip joint center.

The goal for the initial analysis was to find the optimal device configurations based purely on mechanical advantage. Device configuration in this case is defined by the proximal and distal attachment locations of the contracting element. Regions were chosen on the anterior waist and thigh for proximal and distal attachment points, respectively, that would be feasible for a hip flexion exosuit design. To explore the design space, 25 candidate points forming a grid in both proximal and distal attachment regions were chosen (FIG. 22), yielding 625 possible combinations of distal and proximal attachment points, i.e. device configurations.

Because hip flexion is defined as occurring in the sagittal plane, the metric for assessing the efficacy of a given device configuration was taken as the average value of the sagittal plane component of the moment arm during hip flexion. For the level walking stride used, this was approximately 55-84% of the gait cycle. For a stride defined by N sample points, with proximal attachment point p(x,y,z), distal attachment point d(x,y,z), hip joint center hjc(x,y,z), and sagittal plane defined in the x-direction, the goal of the design optimization is described in Equation 2 below. For this analysis, the optimal configuration was sought when averaged across all subjects. The resulting configuration is that which provides the greatest mechanical advantage during hip flexion when averaged over the subjects.

$$maximize \frac{1}{k} {\sum }_{k = s 1}^{s 2} [ ( p - hjc ) - ( ( p - hjc ) \cdot n ) * n ] * \hat{x} \qquad Equation 2$$

$$where n = \frac{d - p}{‖ d - p ‖}$$

$$s 1 = round ( 0.55 * N ) , s 2 = round ( 0.84 * N )$$

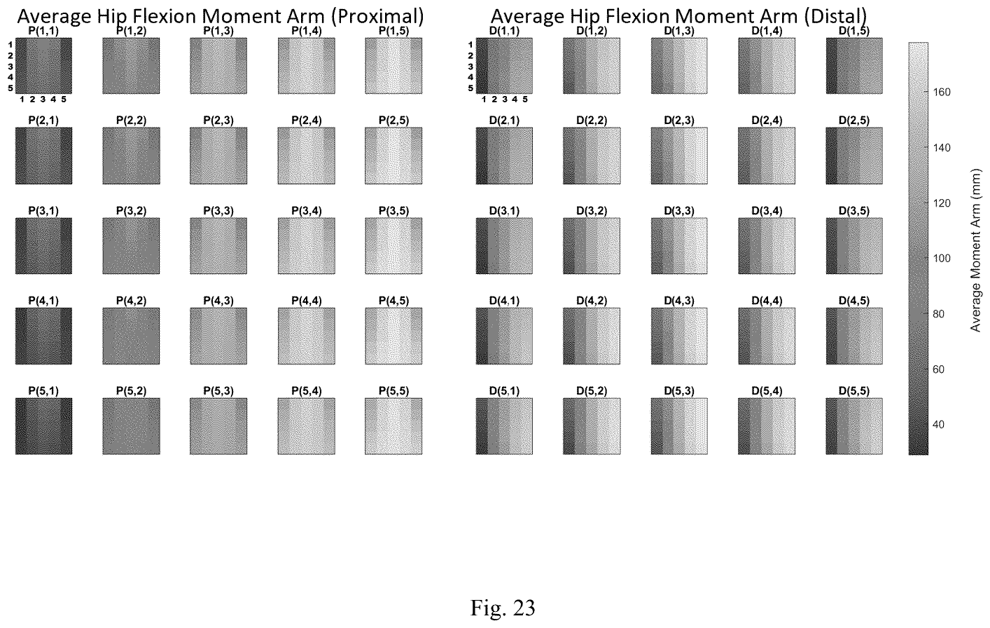

In order to visualize the results of all 625 tests, heatmaps were generated to communicate the relative efficacy of all configurations (FIG. 23).

For subsequent analyses, a single device configuration was used in order to compare the effects of BMI, sex, and terrain on device performance. The configuration chosen was P(5,3) D(1,3), because this configuration is centered on the thigh in a manner consistent with many hip flexion exosuits in literature. The modeling pipeline was also used as previously described to show the actuator lengths and moment arm lengths over a typical hip range of motion between −20° and 80° (positive angle represents flexion).

Finally, the power that the device could deliver in this configuration was estimated for level walking, as well as incline/decline walking, and stair ascent/descent. This includes 14 subjects and 5 tasks for 70 simulations of device power-generating ability in this nominal configuration. Hip power is calculated as the product of hip angular velocity and hip torque, which was normalized to body mass and tension developed in the device, resulting in Equation 3 below where rₕᵢₚ is the moment created about the hip. Normalizing by body mass is done to compare the relative effects of the device across subjects, and normalizing by tension in the device keeps the actuator dynamics separate from this analysis.

$$Power ( \frac{W}{N * k g} ) = \frac{{r}_{{hip}^{*}} {ω}_{whip}}{{m}_{subject}} \qquad Equation 3$$

The results of configuration tests averaged over all subjects are summarized visually using heatmaps (FIG. 23). The “Proximal” and “Distal” representations contain the same set of results, but organized in complimentary fashion. For example, the heatmap labeled P(1,1) shows the results of connecting the P(1,1) attachment location to each of the 25 distal locations, which are represented by individual pixels. The pixels are organized in the same manner as the larger grid, i.e. the top right pixel of P(1,1) represents connecting P(1,1) to D(1,5). The brightness of the pixel corresponds to the length of the average hip flexion moment arm during a level walking stride. Similarly, the heatmap labeled D(1,1) shows the results of attaching point D(1,1) to each of the proximal locations. Based on the optimization criterion described by (1), the optimal configuration for the supplied level walking stride, when averaged over all subjects, was P(4,5) D(2,3), yielding an average moment arm of 173.81 mm during hip flexion.

Moment arm and element length during level walking were investigated, and the results from the female cohort are given in FIG. 21D & FIG. 21E. Actuator length and moment arm increased with increasing BMI for both the female and male subjects.

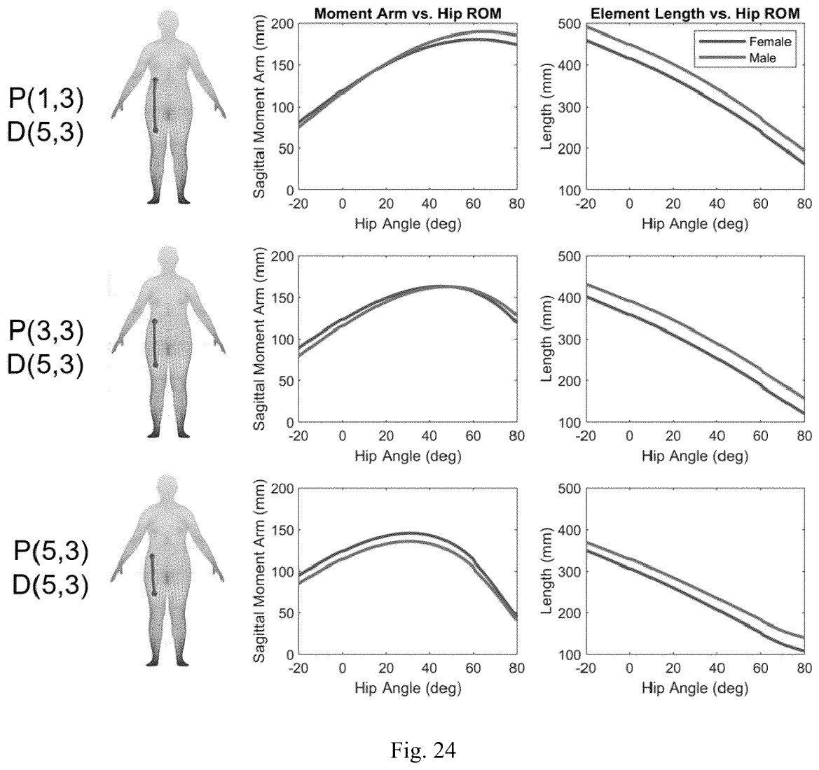

The effects of modulating the distal attachment point vertically about the thigh in three configurations were explored (FIG. 24), plotted over the full range of motion of the hip. Element length scaled with hip range of motion, however peak moment arm changed with the changing attachment point.

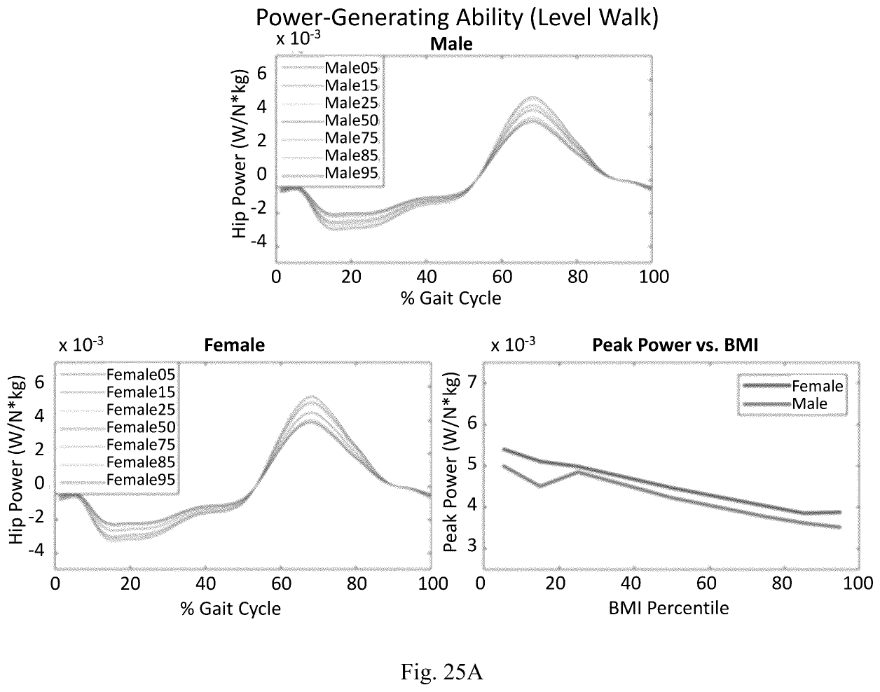

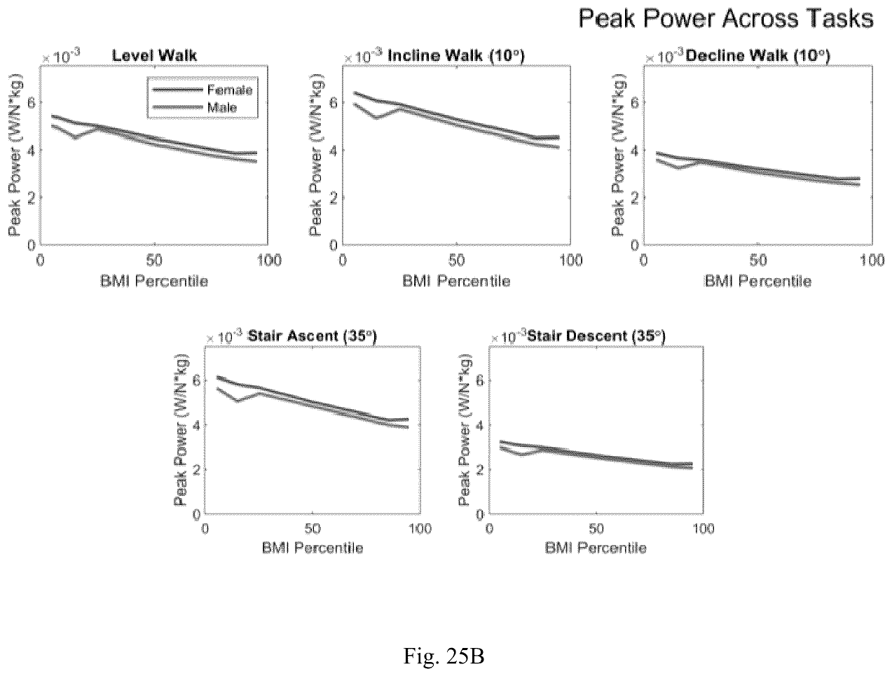

With the nominal configuration of P(5,3) D(1,3), the power profiles in FIG. 25A, and peak power comparisons in FIG. 25B, were produced. The device provided higher power-generating ability for lower BMI subjects, and in this configuration was also more efficient for the females compared to males of the same BMI percentile. Different terrains resulted in shifting of the peak power, however relative relationships between subject sex and BMI were preserved across terrains.

Soft exosuits, by design, conform to the size and shape of their user, and are therefore mechanically dependent on the user's body geometry. The purpose of this study was to create a tool capable of exploring the implications of this dependency, and to present some of the findings when the tool is applied to the specific case of designing a hip flexion exosuit.

As expected, the moment arm the device created about the hip increased as subject BMI increased, as the increased adiposity around the waist placed the proximal attachment location further in front of the hip joint than on lower BMI subjects. Despite this increase in mechanical advantage, however, further analysis showed that the power-generating ability decreased for subjects of higher BMI, as the higher body mass meant fewer watts per kilogram of power could be supplied to the hip.

Interestingly, the device appeared to operate more efficiently on the female cohort in the investigated configuration for power-generating ability. The difference in distribution of adipose tissue between the male and female cohort was consistent enough in to give the female subjects more potential power per kilogram than the males of the same BMI percentile. These results have implications on device design, particularly for applications where the subjects may skew to one sex, for instance multiple sclerosis, which affects approximately four times more women than men [M. T. Wallin et al., “Global, regional, and national burden of multiple sclerosis 1990-2016: a systematic analysis for the Global Burden of Disease Study 2016,” Lancet Neurol., vol. 18, no. 3, pp. 269-285, 2019, doi: 10.1016/S1474-4422(18)30443-5].

The power-generating ability of the device was reported in the units of W (N*kg), an unconventional metric that highlights an important use case for this system. While it is standard practice in biomechanics literature to report power-per-kilogram [D. A. Winter, Biomechanics and Motor Control of Human Movement: Fourth Edition. 2009], the present analysis required the additional normalizing variable of the tension force developed by the device. This metric allows the designer to understand the power-generating potential of the device for a given configuration, user, and kinematic activity, without needing to first incorporate the tension in the contracting element. This decoupling of actuator dynamics and the assistive potential of an exosuit provides engineers with a new way to approach device design problems. For example, the same device layout could be configured with a range of motors or gearboxes to accommodate different segments of the population.

One aspect of exosuit design that is often overlooked is selection of the attachment locations for the contracting element. Studies typically use a single attachment configuration throughout, which is understandable given the effort required to fabricate a single device, and that the focus is often on other design variables such as the assistance timing or magnitude. However, the compliant nature of exosuits provides a large design space, and opportunities to deliver assistance in ways that rigid devices cannot-wrapping contracting elements could deliver assistance in multiple degrees of freedom, or using motors to dynamically modulate the attachment locations during ambulation are some examples. With the present modeling system, such design ideas can be explored without the need to fabricate a device to test new idea. Furthermore, the system can be used in an optimization framework to select device configurations that accomplish a specific goal.

In this study, a design optimization was presented that sought a configuration to maximize the average hip flexion moment arm during level walking given 625 possible configurations and 14 subjects. The configuration P(4,5) D(2,3) yielded the greatest average hip flexion moment arm, which represents a more medial location for the proximal anchor than is typical. The results for all configurations were presented in heatmap-based visualizations that help the designer understand areas where the device is more and less optimal for the given goal, and can be organized from the proximal or distal perspective. These alternative organization strategies are useful for observing different trends in the results—in this instance, the heatmaps show that average moment arm is highly sensitive to the medial-lateral location of the proximal attachment point. However, when examining the distal heatmaps, the central columns of D(x,3) show that there is also sensitivity to the height of the proximal attachment point. To explore this further, the configurations shown in FIG. 24 were evaluated over the range of motion of the hip. The results showed that the moment arm reaches a peak value during flexion, which occurs at greater hip angles when the proximal attachment point is higher. This is an example of a geometric property of an exosuit that could be exploited to suit a different application. One such application could be modulating the proximal attachment point higher to accommodate ascending tasks in which the hip flexes more, and lower for descending tasks where the hip extends more.

This modeling system could be used to inform exosuit designs intended for any joints or degrees of freedom, it is not strictly limited to the hip flexion example presented. While this pipeline is based in kinematics, it could be incorporated into more complex analyses such as musculoskeletal simulations. In this situation, the device configuration and user geometry could be precomputed over the range of motion tested and used as a surrogate model to provide realistic joint moment and loading values to the simulation software. While the 3D models used in this analysis were statistically-based, the accessibility and quality of 3D scanning technology is rapidly improving, making this type of analysis a feasible step in customizing an exosuit to meet the needs of specific individuals.

The present work represents recent efforts to develop and test a system that is capable of examining the mechanics of soft exosuits in a human-centric way. The results showed that the same device configuration can have markedly different mechanical effects on people with different body surface geometry and body mass. There were trends observed not only relating to BMI, but also to biological sex of the user. This study details the development of a tool that could be employed in a variety of ways for further research into exosuit design.

### Example 5: User-Centered Configuration of Soft Hip Flexion Exosuit Designs to Assist Individuals with and without Multiple Sclerosis Through Simulated Human-In-the-Loop Optimization

Soft exosuits hold promise as assistive technology for people with gait deficits owing to a variety of causes. A key aspect of providing useful assistance is to keep the human user at the center of all considerations made in the design, configuration, and prescribed use of an assistive device. This work details a method for informing the configuration of a soft hip flexion exosuit by modeling the user's shape and movements in order to simulate the mechanical interaction of the exosuit and user, incorporating the mechanical effects of the exosuit into a muscle-driven musculoskeletal gait simulation, and using the results of these simulations to define a cost function that is minimized via Bayesian optimization. Two different cost functions are compared: one uses the estimated metabolic cost of transport, and the other uses the asymmetry in average muscle excitations across the stride. This simulation and optimization process is carried out for models of four people with multiple sclerosis and four healthy control subjects. For all users, the estimated metabolic cost of transport was reduced below baseline, no-device levels. Similarly, the asymmetry in muscle excitations was also reduced below baseline levels in all user models. Three of four MS subjects saw a positive correlation between reducing the metabolic cost of transport and reducing the asymmetry of muscle excitations, while control subjects saw significant correlations, mostly negative. This work represents a step toward more individualized, user-centric modeling of assistive devices, and demonstrates a system for informing the physical configuration of an exosuit on a case-by-case basis using real patient data. Further, it provides evidence that seeking more symmetrical muscle activity could improve walking efficiency for people with MS.

Clothing-like, wearable orthoses that are increasingly referred to as “exosuits” have been the subject of considerable research in recent years. Exosuits aim to provide targeted assistance to users' joints in a form factor that is lighter, lower-profile, and more comfortable than rigid alternatives known as exoskeletons [G. S. Sawicki, O. N. Beck, I. Kang, and A. J. Young, “The exoskeleton expansion: Improving walking and running economy,” J. Neuroeng. Rehabil., vol. 17, no. 1, pp. 1-9, 2020, doi: 10.1186/s12984-020-00663-9]. To accomplish this, soft exosuits use flexible components to transmit forces to the joints, often by developing linear tension in a joint-spanning cable or band, creating a moment about the spanned joint [A. T. Asbeck, S. M. M. M. De Rossi, I. Galiana, Y. Ding, and C. J. Walsh, “Stronger, smarter, softer: Next-generation wearable robots,” IEEE Robot. Autom. Mag., vol. 21, no. 4, pp. 22-33, 2014, doi: 10.1109/MRA.2014.2360283]. A notable effect of this approach is that the routing of the joint-spanning elements and the body shape unique to the wearer become important components of the transmission of mechanical power between the device and human. While all wearable device designs must account for the different body sizes and shapes of potential users by invoking adjustable components, customized manufacture by an orthotist, or incremental sizing schemes, the problem of ensuring a proper fit is particularly salient for soft exosuits, as these form-fitting devices necessarily exhibit form-dependent mechanics.

To address the high sensitivity of exosuits to the contours and movements of their users, a system for modeling the physical interaction of a device and user based on the user's body geometry and kinematics during movement tasks was previously developed [R. M. Neuman and N. P. Fey, “Modeling the Influence of the Human Form and Ambulation Context on Moment- and Power-Generating Abilities of Soft Hip-Flexion Exosuits,” in 2022 International Conference on Rehabilitation Robotics (ICORR), July 2022, pp. 1-6, doi: 10.1109/ICORR55369.2022.9896601]. This modeling system demonstrated the influence of user body mass index (BMI) and biological sex on the mechanics of a passive hip flexion exosuit, as well as the effects of changing the attachment locations of the elastic bands that provided energy to the hip.

The hip flexion exosuit being modeled in the present example (FIG. 7A & FIG. 7B) is a simple, passive device where elastic bands span the hip joint, anchoring proximally to the waist and distally to the thigh just above the knee. As the hip extends during stance, the bands are stretched, storing energy and subsequently releasing that energy as the hip begins to flex into the swing phase of gait. This passive redistribution of biomechanical energy is intended to assist people with swing initiation, preventing issues such as toe-drag that can cause slow gait, pain, and falls. Previously, a unilateral embodiment of this device was used in an exploratory study to investigate the effects it had on people with multiple sclerosis (MS), a demyelinating disease that often causes gait impairments [M. T. Wallin et al., “Global, regional, and national burden of multiple sclerosis 1990-2016: a systematic analysis for the Global Burden of Disease Study 2016,” LancetNeurol., vol. 18, no. 3, pp. 269-285, 2019, doi: 10.1016/S1474-4422(18)30443-5], and for which many people have trouble selecting and using appropriate assistive technology [A. Souza, A. Kelleher, R. A. R. Cooper, R. A. R. Cooper, L. I. Iezzoni, and D. M. Collins, “Multiple sclerosis and mobility-related assistive technology: Systematic review of literature,” J. Rehabil. Res. Dev., vol. 47, no. 3, p. 213, 2010, doi: 10.1682/JRRD.2009.07.0096]. It is difficult to prescribe devices with any generality to people with MS due to the high variability with which gait disorders can present across individuals [A. R. Salter, G. R. Cutter, T. E. Bacon, and J. Herbert, “Disability in multiple sclerosis,” Neurology, vol. 80, pp. 1018-1024, 2013], and the changes in ability as individuals experience fatigue throughout the day, or the relapses and remissions that can occur as the disease progresses [L. Filli et al., “Profiling walking dysfunction in multiple sclerosis: Characterisation, classification and progression over time,” Sci. Rep., vol. 8, no. 1, pp. 1-13, 2018, doi: 10.1038/s41598-018-22676-0]. For these reasons, the hip exosuit was made to be highly adjustable such that the routing of the bands as well as their stiffness and pre-tension amounts could all be customized to the specific needs of the user. In the exploratory study, while results were highly varied, there was a consistent trend of shifting the net work done at the hip joint toward more positive work, which meant more normative kinematics for the participants with MS [R. M. Neuman, S. M. Shearin, K. J. McCain, and N. P. Fey, “Biomechanical analysis of an unpowered hip flexion orthosis on individuals with and without multiple sclerosis,” J. Neuroeng. Rehabil., vol. 18, no. 1, pp. 1-13, 2021, doi: 10.1186/s12984-021-00891-7]. Given the promising preliminary results and the high configurability of passive hip flexion exosuits, there is substantial motivation to better model this scenario, helping to inform the next generation of physical devices.

The present study builds upon previous works in several ways: first, kinematics and surface geometries were used to generate models that are based on specific study participants, both with and without MS; second, the results from the purely-geometric shape modeling system are incorporated into forward dynamic musculoskeletal simulations, giving estimations of the muscle states throughout a stride; and third, the outputs from these muscle-driven simulations are used to define a cost function to iteratively optimize the exosuit configuration for each individual. This simulated human-in-the-loop optimization framework is designed to shed light on different strategies that could be employed using a single, highly-configurable hip flexion exosuit to help people with different functional abilities, physical attributes, and assistive needs.

Optimizing assistive devices for specific individuals requires incorporating user feedback into the process, where parameters are iteratively tuned to achieve the desired user responses. This strategy is referred to as “human-in-the-loop” optimization (HIL), and has been enthusiastically explored in recent assistive device studies [Y. Ding, M. Kim, S. Kuindersma, and C. J. Walsh, “Human-in-the-loop optimization of hip assistance with a soft exosuit during walking,” Sci. Robot., vol. 3, no. 15, p. eaar5438, 2018, doi: 10.1126/scirobotics.aar5438], [J. Zhang et al., “Human-in-the-loop optimization of exoskeleton assistance during walking,” Science (80-.)., vol. 356, no. 6344, pp. 1280-1284, June 2017, doi: 10.1126/science.aa15054.; Z. Li, Q. Li, P. Huang, H. Xia, and G. Li, “Human-in-the-Loop Adaptive Control of a Soft Exo-Suit With Actuator Dynamics and Ankle Impedance Adaptation,” IEEE Trans. Cybern., pp. 1-13, 2023, doi: 10.1109/TCYB.2023.3240231.; H. Han et al., “Selection of Muscle-Activity-Based Cost Function in Human-in-the-Loop Optimization of Multi-Gait Ankle Exoskeleton Assistance,” IEEE Trans. Neural Syst. Rehabil. Eng., vol. 29, pp. 944-952, 2021, doi: 10.1109/TNSRE.2021.3082198.; F. Haufe, P. Wolf, and R. Riener, “Human-in-the-loop optimization of a multi-joint wearable robot for movement assistance,” Proc. Autom. Med. Eng., vol. 1, no. 1, p. 023, 2020, doi: 10.18416/AUTOMED.2020.; J. Kim et al., “Reducing the energy cost of walking with low assistance levels through optimized hip flexion assistance from a soft exosuit,” Sci. Rep., vol. 12, no. 1, pp. 1-13, 2022, doi: 10.1038/s41598-022-14784-9.; P. Slade, M. J. Kochenderfer, S. L. Delp, and S. H. Collins, “Personalizing exoskeleton assistance while walking in the real world,” Nature, vol. 610, no. 7931, pp. 277-282, October 2022, doi: 10.1038/s41586-022-05191-1.; M. Tucker et al., “Preference-Based Learning for Exoskeleton Gait Optimization,” Proc.—IEEE Int. Conf. Robot. Autom., pp. 2351-2357, 2020, doi: 10.1109/ICRA40945.2020.9196661.; M. Kim et al., “Human-in-the-loop Bayesian optimization of wearable device parameters,” PLoS One, vol. 12, no. 9, pp. 6-8, 2017, doi: 10.1371/journal.pone.0184054], both for tuning static parameters of the devices and for implementation in online controllers. Studies have shown that different optimal settings for individuals can perform better than the group-averaged optimal settings [B. A. Shafer, J. C. Powell, A. J. Young, and G. S. Sawicki, “Emulator-Based Optimization of a Semi-Active Hip Exoskeleton Concept: Sweeping Impedance Across Walking Speeds,” IEEE Trans. Biomed. Eng., vol. 70, no. 1, pp. 271-282, 2023, doi: 10.1109/TBME.2022.3188482], and how different these optimal settings might be, even for healthy subjects of relatively similar physical characteristics [Y. Ding, M. Kim, S. Kuindersma, and C. J. Walsh, “Supplementary Materials For Human-in-the-loop optimization of hip assistance with a soft exosuit during walking,” Sci. Robot., vol. 3, no. 15, February 2018, doi: 10.1126/scirobotics.aar5438]. Most of these studies use indirect calorimetry to estimate the metabolic cost of walking, which is then used as the cost to target for minimization, which is a common metric for evaluating the efficacy of assistive devices. Others, however, have explored costs derived from using surface electromyography (sEMG) to estimate muscle activity during tasks in both upper [R. Meattini, D. Chiaravalli, G. Palli, and C. Melchiorri, “SEMG-Based Human-in-the-Loop Control of Elbow Assistive Robots for Physical Tasks and Muscle Strength Training,” IEEE Robot. Autom. Lett., vol. 5, no. 4, pp. 5795-5802, 2020, doi: 10.1109/LRA.2020.3010741] and lower [H. Han et al., “Selection of Muscle-Activity-Based Cost Function in Human-in-the-Loop Optimization of Multi-Gait Ankle Exoskeleton Assistance,” IEEE Trans. Neural Syst. Rehabil. Eng., vol. 29, pp. 944-952, 2021, doi: 10.1109/TNSRE.2021.3082198] limbs, or measures of joint impedance and actuator dynamics [Z. Li, Q. Li, P. Huang, H. Xia, and G. Li, “Human-in-the-Loop Adaptive Control of a Soft Exo-Suit With Actuator Dynamics and Ankle Impedance Adaptation,” IEEE Trans. Cybern., pp. 1-13, 2023, doi: 10.1109/TCYB.2023.3240231]. Given the benefits of individualized optimization, it stands to reason that applying HIL strategies to musculoskeletal simulations based on experimental data would enable further refinement of assistive device designs without the usual limitations posed by physical experiments. Without worrying about user fatigue, time to adjust device parameters, and limitations in the signals that one can capture in a physical experiment, a simulation framework can allow for more iterations and greater freedom in choosing the optimization's cost function. Indeed, studies have demonstrated HIL strategies applied for upper- and lower-limb human-exoskeleton interaction are effective for optimizing devices [Y. Zimmermann et al., “Digital Guinea Pig: Merits and Methods of Human-in-the-Loop Simulation for Upper-Limb Exoskeletons,” IEEE ICORR Proc., p. in press, 2022], [X. Zhou, “Predictive human-in-the-loop simulations for assistive exoskeletons,” in Proceedings of the ASME Design Engineering Technical Conference, 2020, vol. 9, pp. 1-7, doi: 10.1115/DETC2020-22668], while others have used online simulation to provide metabolic cost estimates for physical HIL experiments [D. F. N. Gordon, C. McGreavy, A. Christou, and S. Vijayakumar, “Human-in-the-Loop Optimization of Exoskeleton Assistance Via Online Simulation of Metabolic Cost,” IEEE Trans. Robot., vol. 38, no. 3, pp. 1410-1429, 2022, doi: 10.1109/TRO.2021.3133137]. While a number of studies have used simulation to optimize the parameters of lower-limb assistive devices [E. P. Grabke, K. Masani, and J. Andrysek, “Lower Limb Assistive Device Design Optimization Using Musculoskeletal Modeling: A Review,” J. Med. Devices, Trans. ASME, vol. 13, no. 4, pp. 1-13, 2019, doi: 10.1115/1.4044739], these often consist of a parameter sweep over a single generic model, and are less analogous to physical HIL experiments.

In the case of the current study, HIL optimization techniques were chosen for two main reasons. First, the subjects modeled had widely varying physical and functional characteristics, motivating a reactive approach to each individual's response rather than group-averaged responses. This also allows comparison of the different optimal configurations across subjects. Second, to the study optimized eight parameters (resting length, stiffness, medio-later waist anchor placement, and vertical waist anchor placement, for each of two bands), making a traditional parameter sweep or grid search infeasible given the number of parameter combinations and time required for each simulation to run. Instead, Bayesian optimization was used, a sequential design method appropriate for finding global solutions for expensive-to-evaluate, black box functions [E. Brochu, V. M. Cora, and N. de Freitas, “A Tutorial on Bayesian Optimization of Expensive Cost Functions, with Application to Active User Modeling and Hierarchical Reinforcement Learning,” 2010, [Online]. Available: http://arxiv.org/abs/1012.2599]. The core idea of Bayesian optimization is to balance the exploration-exploitation tradeoff in probing the design space, extracting the most value from each evaluation of the objective function. This makes it an excellent candidate for HIL studies, as demonstrated in [Y. Ding, M. Kim, S. Kuindersma, and C. J. Walsh, “Human-in-the-loop optimization of hip assistance with a soft exosuit during walking,” Sci. Robot., vol. 3, no. 15, p. eaar5438, 2018, doi: 10.1126/scirobotics.aar5438], [M. Kim et al., “Human-in-the-loop Bayesian optimization of wearable device parameters,” PLoS One, vol. 12, no. 9, pp. 6-8, 2017, doi: 10.1371/journal.pone.0184054].

Leveraging the flexibility afforded by simulating HIL studies, two separate optimizations for each subject were performed in order to compare the outcomes of using different cost functions. In one optimization, the metabolic cost of walking averaged over the stride was minimized, in accordance with much of the existing literature on assistive device optimization. This would indicate the device increases walking efficiency from a purely energetic standpoint. Second, a novel cost function was proposed that attempts to reduce asymmetry in average muscle excitations for each pair of muscles in the model. This was chosen due to the highly asymmetrical gait that the unilaterally-affected MS patients presented with, and it represents more of a neuromuscular strategy than the metabolic approach, as the “excitations” in the model are meant to approximate the neural impulses being sent to specific muscles or muscle groups. While there is no precedent for using such a cost function, there is an abundance of literature demonstrating the connections between various measures of symmetry and healthy gait [K. Z. Takahashi, M. D. Lewek, and G. S. Sawicki, “A neuromechanics-based powered ankle exoskeleton to assist walking post-stroke: A feasibility study,” J. Neuroeng. Rehabil., vol. 12, no. 1, pp. 1-13, 2015, doi: 10.1186/s12984-015-0015-7], [M. D. Lewek, C. E. Bradley, C. J. Wutzke, and S. M. Zinder, “The relationship between spatiotemporal gait asymmetry and balance in individuals with chronic stroke,” J. Appl. Biomech., vol. 30, no. 1, pp. 31-36, 2014, doi: 10.1123/jab.2012-0208.; Z. Zhang, H. Yu, W. Cao, X. Wang, Q. Meng, and C. Chen, “Design of a semi-active prosthetic knee for transfemoral amputees: Gait symmetry research by simulation,” Appl. Sci., vol. 11, no. 12, 2021, doi: 10.3390/app11125328.; P. Malcolm, S. Galle, P. Van Den Berghe, and D. De Clercq, “Exoskeleton assistance symmetry matters: Unilateral assistance reduces metabolic cost, but relatively less than bilateral assistance,” J. Neuroeng. Rehabil., vol. 15, no. 1, pp. 1-11, 2018, doi: 10.1186/s12984-018-0381-z.; T. D. Luna, V. Santamaria, and S. K. Agrawal, “Redistributing Ground Reaction Forces During Squatting Using a Cable-Driven Robotic Device,” in IEEE International Conference on Rehabilitation Robotics, 2022, vol. 2022-July, pp. 25-29, doi: 10.1109/ICORR55369.2022.9896494.; S. Srivastava et al., “The relationship between motor pathway damage and flexion-extension patterns of muscle co-excitation during walking,” Front. Neurol., vol. 13, 2022, doi: 10.3389/fneur.2022.968385]. Moreover, this paradigm demonstrates one of the strengths of using simulations with HIL studies, as many of the muscles used in this cost function are not superficial enough for measurement by sEMG and therefore infeasible to include in physical experiments. It was hypothesized that greater asymmetry in muscle excitations will positively correlate with greater metabolic cost.

Individual simulations were generated based on data collected from four people with MS and four healthy control subjects (Table 4), undergoing level walking on an instrumented treadmill (Bertec) at a self-selected comfortable pace for 1-minute bouts. A custom set of 44 motion capture markers was placed on the lower-limbs and trunk, and 3D kinematics were recorded with a 10-camera motion capture system (Vicon). One representative stride was chosen for each participant to drive the shape modeling and musculoskeletal simulation. All MS participants had primarily unilateral hip flexor deficits, and as such it was referred to as their “stronger” and “weaker” sides when discussing the results of this work, while the controls are organized by their dominant and non-dominant leg.

For the shape modeling simulation, a 3D surface mesh representative of the subject's body geometry was generated using the HumanShape modeling tool (humanshape.org), which parametrically generates a surface mesh based on height, age, sex, BMI, and torso-to-leg length ratio [M. P. Reed, U. Raschke, R. Tirumali, and M. B. Parkinson, “Developing and Implementing Parametric Human Body Shape Models in Ergonomics Software,” 3rd Digit. Hum. Model. Symp., no. 1, pp. 1-8, 2014]. These meshes are then deformed according joint kinematics observed from motion capture studies, creating a physically-representative animation of the user's surface movements. Based on the attachment locations of the exosuit bands, a wrapping algorithm is invoked to simulate how the device actuators interact with the body surface, enabling calculation of the moment arm formed about the spanned joint(s) (hip joints in this case) and the length of each band throughout the stride [R. M. Neuman and N. P. Fey, “Modeling the Influence of the Human Form and Ambulation Context on Moment- and Power-Generating Abilities of Soft Hip-Flexion Exosuits,” in 2022 International Conference on Rehabilitation Robotics (ICORR), July 2022, pp. 1-6, doi: 10.1109/ICORR55369.2022.9896601]. The band length is used along with band stiffness and resting length data to calculate the resulting moments about the hip in three dimensions (flexion/extension, adduction/abduction, and internal/external rotation).

TABLE 4
Participant Data

| Subject | | | Height | Mass | Years | Strong |
|---|---|---|---|---|---|---|
| ID | Age | Sex | (m) | (kg) | with MS | Dominant Leg |
| MS1 | 57 | F | 1.64 | 88.5 | 24 | Right |
| MS2 | 61 | F | 1.59 | 51.3 | 7 | Left |
| MS3 | 45 | F | 1.69 | 56.5 | 24 | Right |
| MS4 | 54 | F | 1.6 | 88.2 | 5 | Left |
| C01 | 22 | M | 1.88 | 81.6 | — | Right |
| C02 | 45 | M | 1.86 | 103.6 | — | Right |
| C03 | 58 | F | 1.7 | 57.4 | — | Right |
| C04 | 35 | F | 1.76 | 80.1 | — | Right |

After the hip moments generated by the device for the given configuration are calculated, they are used as inputs into a musculoskeletal simulation in OpenSim 4.1 (SimTK). The computed muscle control (CMC) algorithm is used to estimate muscle excitations that will generate the experimentally observed movements [D. G. Thelen and F. C. Anderson, “Using computed muscle control to generate forward dynamic simulations of human walking from experimental data,” J. Biomech., vol. 39, no. 6, pp. 1107-1115, 2006, doi: 10.1016/j.jbiomech.2005.02.010]. First, a generic musculoskeletal model with 23 degrees of freedom and 54 muscles (“gait2354”) is scaled to fit the subject, and the ground reaction forces (GRFs), and kinematics are used in a PD controller to define a set of desired accelerations that will drive the model coordinates toward the observed coordinates. It is in this step that the exosuit moments calculated during shape modeling are input as ideal actuators with prescribed behavior according to the subject's geometry and kinematics. Then, a static optimization is performed to find the set of muscle excitations that can achieve these accelerations with the minimal squared sum of excitations [A. Seireg and R. J. Arvikar, “The prediction of muscular load sharing and joint forces in the lower extremities during walking,” J. Biomech., vol. 8, no. 2, pp. 89-102, March 1975, doi: 10.1016/0021-9290(75)90089-5]. Finally, the model states output by CMC are used to compute the metabolic energy expenditure of each muscle based on mechanical and thermal energy rates as described by Umberger in 2010 [B. R. Umberger, “Stance and swing phase costs in human walking,” J. R. Soc. Interface, vol. 7, no. 50, pp. 1329-1340, 2010, doi: 10.1098/rsif.2010.0084].

The metabolic goal was chosen because it is an often-used metric of success in wearable device studies, particularly for human-in-the-loop optimizations [Y. Ding, M. Kim, S. Kuindersma, and C. J. Walsh, “Human-in-the-loop optimization of hip assistance with a soft exosuit during walking,” Sci. Robot., vol. 3, no. 15, p. eaar5438, 2018, doi: 10.1126/scirobotics.aar5438], [J. Zhang et al., “Human-in-the-loop optimization of exoskeleton assistance during walking,” Science (80-.)., vol. 356, no. 6344, pp. 1280-1284, June 2017, doi: 10.1126/science.aal5054]. Estimates of the instantaneous metabolic cost at each time step were obtained using the model and muscle parameter values described by Umberger in [B. R. Umberger, “Stance and swing phase costs in human walking,” J. R. Soc. Interface, vol. 7, no. 50, pp. 1329-1340, 2010, doi: 10.1098/rsif.2010.0084], [B. R. UMBERGER, K. G. M. GERRITSEN, and P. E. MARTIN, “A Model of Human Muscle Energy Expenditure,” Comput. Methods Biomech. Biomed. Engin., vol. 6, no. 2, pp. 99-111, May 2003, doi: 10.1080/1025584031000091678], which models the rate of heat production and rate of work being done by each hill-type muscle, including different heat rate coefficients for lengthening and shortening of the muscle. The symmetry goal was chosen as asymmetry is often associated with gait deficits, and the people with MS in the disclosed study all showed significant unilateral hip flexor deficits when assessed by clinicians. The muscle excitation asymmetry was calculated as the sum of the absolute value of the differences in average muscle excitations, for all 23 pairs of muscles, during the stride:

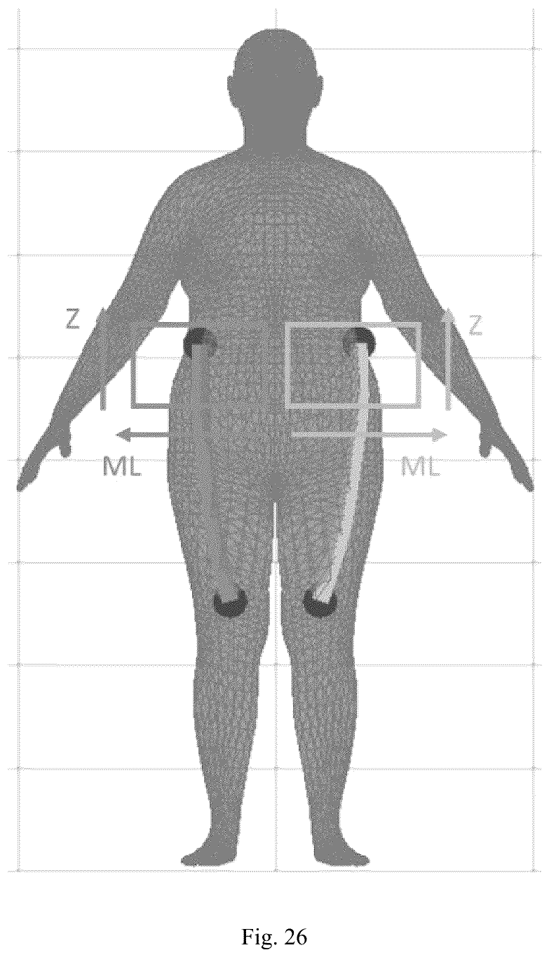

excitation asymmetry=Σᵢ₌₁²³|mean(exc_{i,Left})−mean(exc_{i,Right})| Equation 4

Where muscle excitations are values between 0 and 1, indicating no excitation and full excitation, respectively. In this exploration, we wanted to find optimal configurations of the passive hip flexion exosuit by adjusting the stiffness and pretension of the hip-spanning elastic bands as well as the waist attachment locations (both mediolaterally and vertically). These four parameters can be adjusted on both elastic bands for a total of eight optimizable variables in the analysis. Band stiffnesses were bounded between 200 and 600 N/m, a range that can be covered by typical resistance bands employed for exercise and physical therapy [M. C. Uchida, M. M. Nishida, R. A. C. Sampaio, T. Moritani, and H. Arai, “Thera-Band® elastic band tension: Reference values for physical activity,” J. Phys. Ther. Sci., vol. 28, no. 4, pp. 1266-1271, 2016, doi: 10.1589/jpts.28.1266]. Resting lengths were defined as a percentage of the inter-attachment point distance at a neutral standing posture, and bounded between 50-100%. 50% would mean the band is stretched to twice its length at a standing position (aggressive), and 100% would mean it is at equilibrium at a standing position (compliant). Mediolateral (ML) and vertical (Z) attachment point locations were discretized, forming a grid of potential attachment locations that was superimposed upon the torso. ML points were represented by integers from 1-8, with higher values indicating more lateral locations, and Z points were given a range from 1-4, with higher values indicating positions higher on the torso (FIG. 26). This gives a total of 32 possible attachment locations for each band.

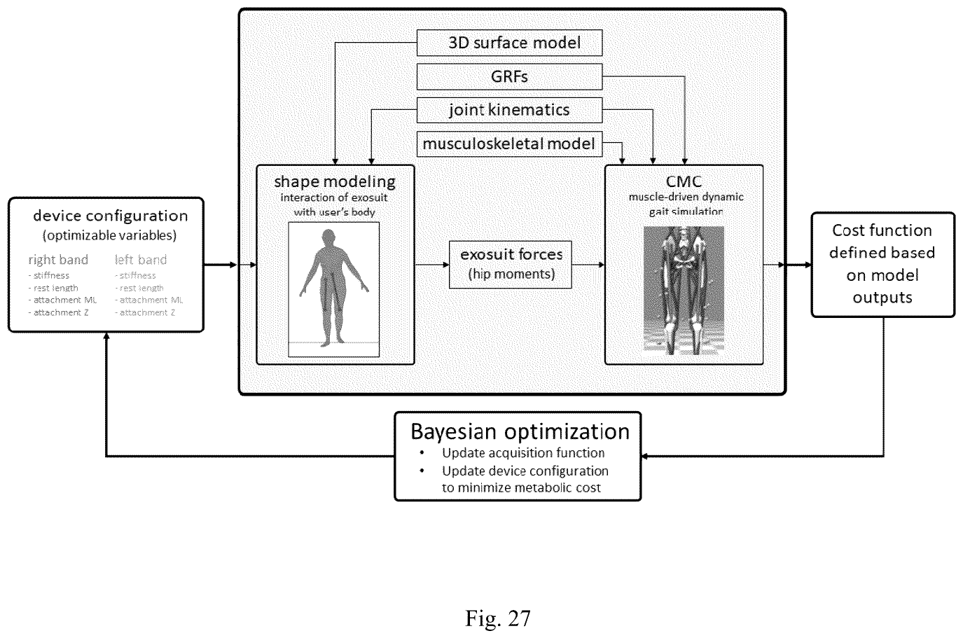

With the computational time required for each simulation (between 5-10 minutes each on an Intel Core i7-10875H CPU), and the vast parameter space covered by the 8 optimizable variables, Bayesian optimization was chosen to find the optimal configuration due to its effectiveness in finding global solutions to expensive-to-evaluate black box objective functions. From the optimizer's perspective, the entire modeling and simulation pipeline was treated as a black box, simply inputting the eight device parameters and outputting a single value for the average metabolic cost at that configuration (FIG. 27). Bayesian optimization works by fitting a surrogate “acquisition function” to the inputs and outputs observed from evaluations of the objective function. The acquisition function is used to predict where the lowest values of the unknown objective function ƒ(x) will occur, and is in turn updated with each new evaluation of ƒ(x). The acquisition function is based on a posterior distribution over functions, Q, which is obtained through Gaussian process regression—a non-parametric, kernel-based probabilistic regression model [C. E. R. & C. K. I. Williams, Gaussian Processes for Machine Learning, 2nd ed. Cambridge, Massachusetts: The MIT Press, 2006]:

Q˜GP(m(x),k(x,x′)) Equation 5

This is the same regression process as that described in Example 2 above, with mean m(x) and covariance k(x,x′), however in this case the kernel used is the “Matern 5/2” covariance function as recommended in [J. Snoek, H. Larochelle, and R. P. Adams, “Practical Bayesian Optimization of Machine Learning Algorithms,” pp. 1-12, June 2012, [Online]. Available: http://arxiv.org/abs/1206.2944]:

$$k ( {x}_{i} , {x}_{j} ) = {σ}_{f}^{2} ( 1 + \frac{\sqrt{5} r}{{σ}_{l}} + \frac{5 {r}^{2}}{e} ) exp ( - \frac{\sqrt{5} r}{{σ}_{l}} ) \qquad Equation 6$$

$$where r = \sqrt{{( {x}_{i} - {x}_{j} )}^{T} ( {x}_{i} - {x}_{j} )}$$

As described in Example 2 above, σ_{ƒ}² and σᵢ² are the signal standard deviation and characteristic length scale, respectively. Once Q is obtained, the acquisition function EI(x,Q) is used to determine where the best location for the next evaluation of the objective function will be. For this study, the “Expected-Improvement-Plus” acquisition function in MATLAB (The MathWorks) was used to guide the optimization. If x_{best} is the location of the lowest posterior mean, and μ_{Q}(x_{best}) is the lowest value of the posterior mean, the expect improvement is defined as:

EI(x,Q)=EQ[max(0,μQ(xbest)−ƒ(x)] Equation 7

The “plus” part of the “Expected-Improvement-Plus” function refers to a strategy that helps avoid over-exploitation of an area by modifying the kernel function such that the variance for points lying in between observations is artificially inflated if over-exploitation is detected [A. D. Bull, “Convergence rates of efficient global optimization algorithms,” J. Mach. Learn. Res., vol. 12, pp. 2879-2904, 2011]. In this analysis, eight random seed points were used to form the initial posterior distribution, followed by 22 iterations guided by the acquisition function, totaling 30 iterations informing each optimization. The same 8 seed points were used for both optimizations, and with the 22 subsequent evaluations for each optimization, this resulted in 52 total objective function evaluations per subject. The lowest cost values reached during the optimizations were reported as the “optimal” device configurations for the given goal.

For the purpose of assessing the correlation of the two cost functions, the symmetry cost and metabolic cost was calculated for each objective function evaluation regardless of the current optimization goal. The two costs at each of the 52 evaluation points per subject were then compared using Pearson's correlation coefficient. Pearson's r and the corresponding p-value were calculated for each subject, with p<0.05 being considered a significant correlation.

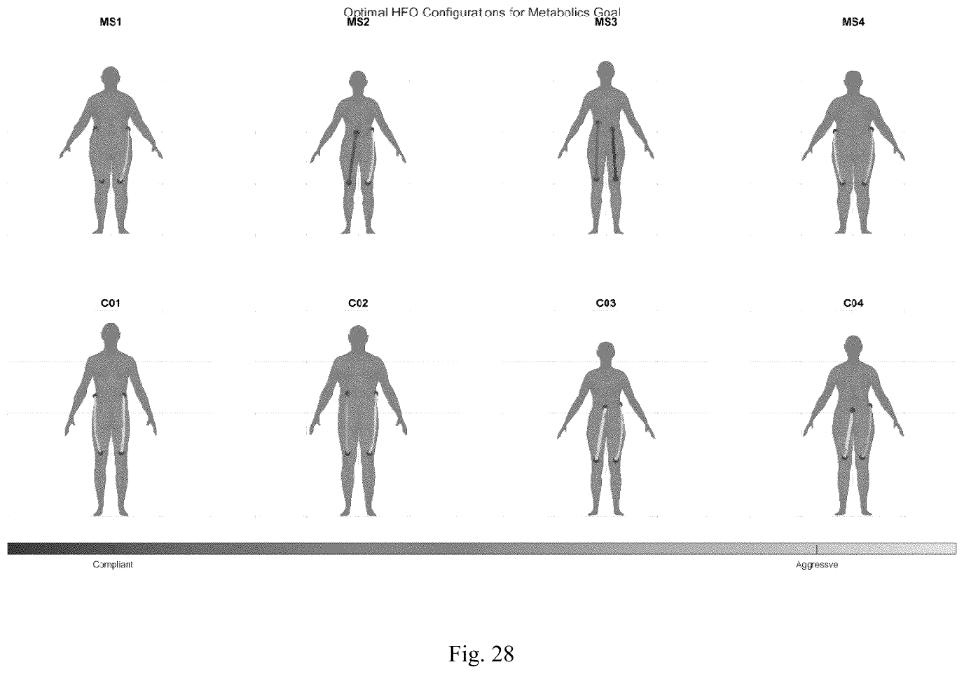

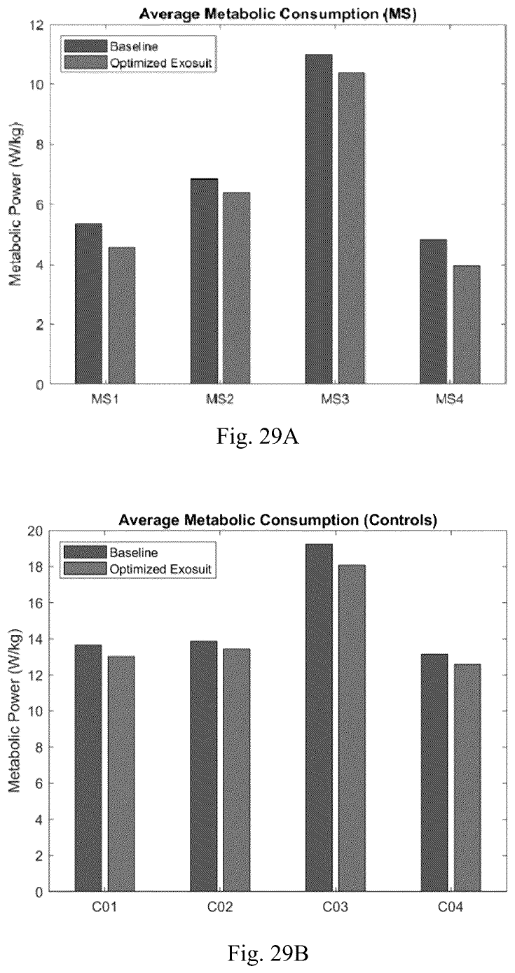

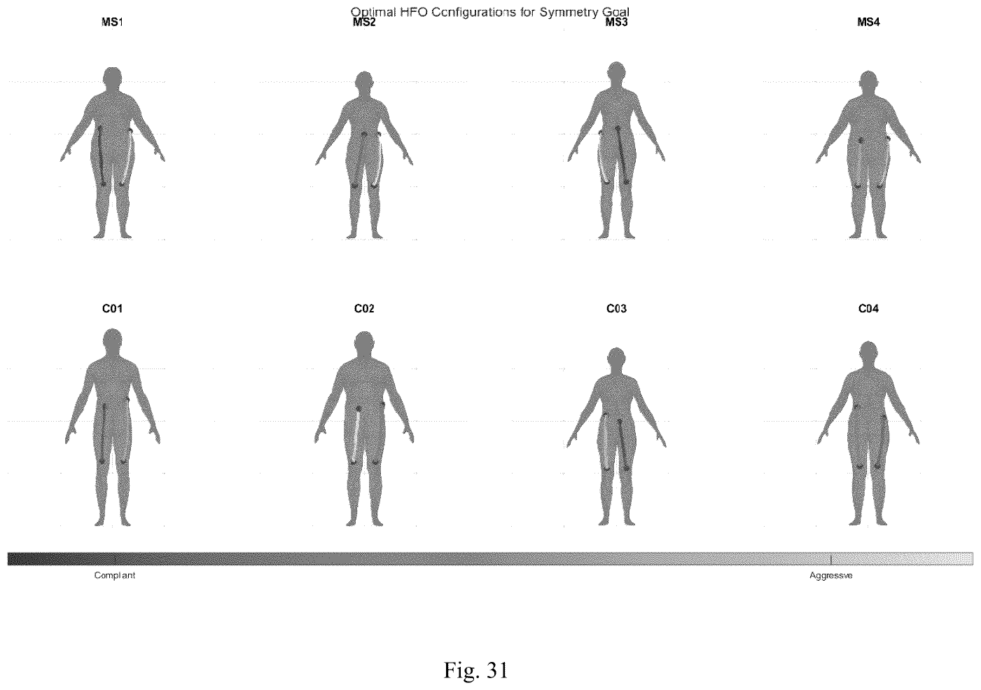

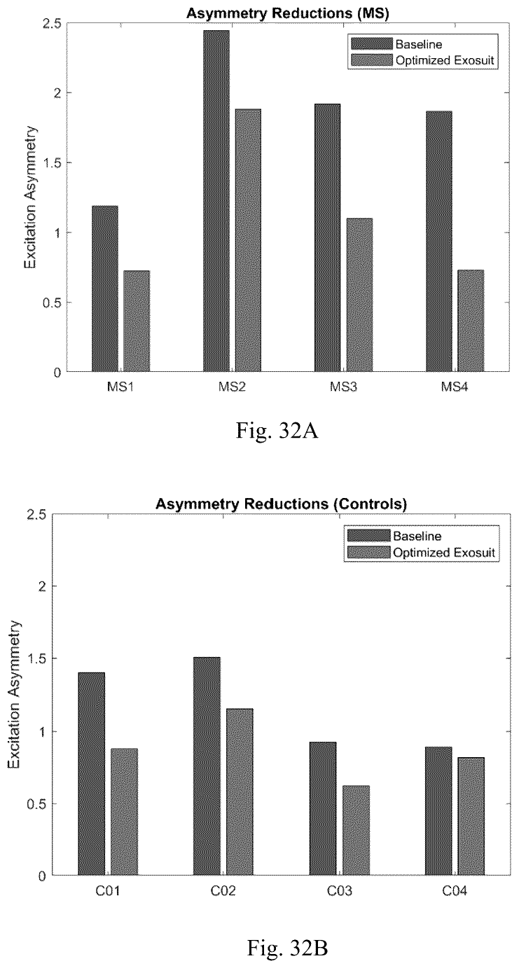

Modeling and simulations were successful at reducing both defined costs for all eight subjects when compared to the baseline cost of walking without the device (FIG. 29A, FIG. 29B, FIG. 32A & FIG. 32B). In support of the disclosed ideas, the optimal configurations varied among the different subjects (FIG. 28 & FIG. 31), suggesting that there are benefits to using a highly individualized approach when prescribing wearable assistive devices. Significant correlations were also found for 7 of the 8 subjects.

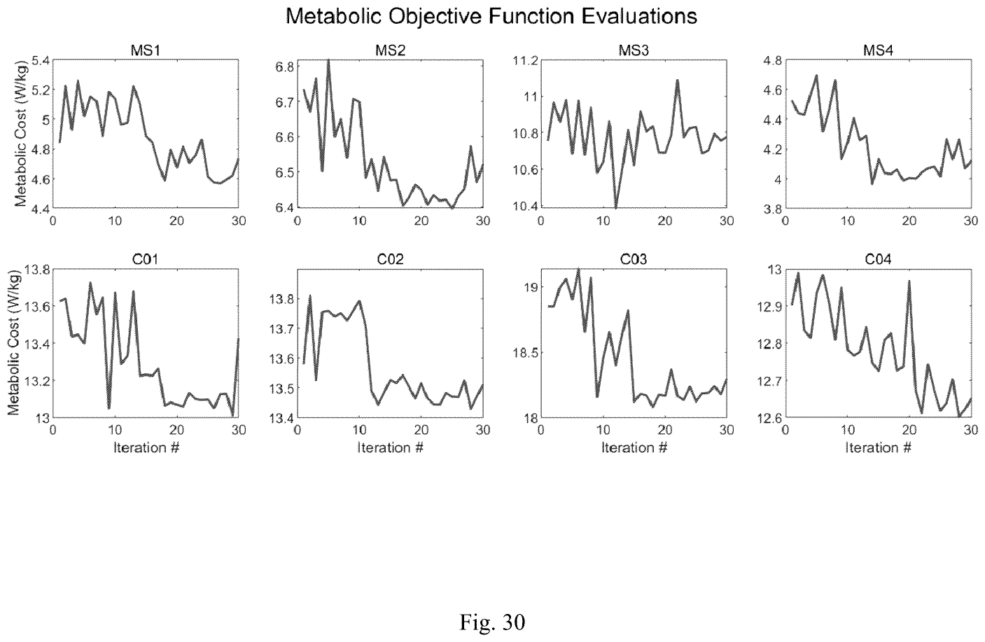

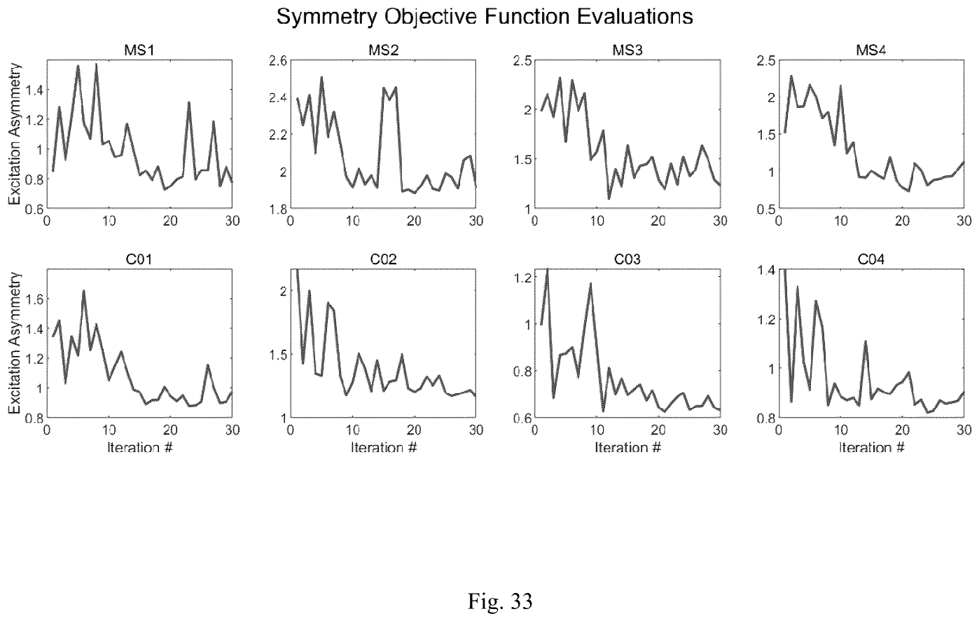

Objective function evaluation values (FIG. 30 & FIG. 33) show the exploration vs. exploitation that Bayesian optimization accomplishes. Notably, there were very few band configurations that increased the metabolic cost, suggesting that redistribution of biomechanical energy using a hip flexion strap could be a generally effective strategy for reducing the metabolic cost of walking, regardless of functional ability.

In the final configurations for the metabolic optimization, MS1 and MS4 showed similar strategies, with high, lateral mounting points and aggressive band properties. MS3 showed more medial mounting with complaint band setups (FIG. 28, Table 5). The optimal configuration for MS2 was more of a hybrid, with the strong side mounted laterally and using aggressive band settings, while the weak side was mounted more medially and used compliant band settings. For the control subjects, all four used aggressive band configurations, with C03 and C04 favoring one side of the body. Baseline metabolic costs were higher for all controls compared to MS subjects, which tracks with the considerably faster walking speeds of the controls.

TABLE 5
Optimized exosuit parameters for metabolic optimization.

| | Strong Side | | | Weak Side | | |
|---|---|---|---|---|---|---|
| | Rest | | Attachment | Rest | | Attachment |
| | Length | Stiffness | points | Length | Stiffness | points |
| ID | (%) | (N/m) | [ML, Z] | (%) | (N/m) | [ML, Z] |
| MS1 | 52.02 | 381.45 | [6, 3] | 55.41 | 597.18 | [7, 3] |
| MS2 | 52.94 | 596.36 | [8, 4] | 75.93 | 241.39 | [2, 3] |
| MS3 | 57.14 | 237.48 | [4, 4] | 83.64 | 210.96 | [3, 2] |
| MS4 | 50.90 | 537.07 | [8, 4] | 51.93 | 594.89 | [8, 3] |
| C01 | 51.58 | 574.97 | [8, 3] | 52.71 | 599.73 | [6, 3] |
| C02 | 62.83 | 553.32 | [4, 4] | 52.30 | 598.89 | [7, 4] |
| C03 | 51.97 | 598.81 | [1, 3] | 50.62 | 557.13 | [8, 4] |
| C04 | 50.33 | 577.40 | [1, 1] | 56.95 | 548.57 | [7, 2] |

In the symmetry optimization, the optimal configurations showed more variety, and tended to use a compliant configuration on one leg, and an aggressive configuration on the other (FIG. 31, Table 6). While the configuration for MS1 had the aggressive band on the weaker leg, MS2, MS3, and MS4 all had the stronger band placed on the stronger league, somewhat counterintuitively. Similarly, three of the four controls saw the aggressive band placed on their dominant leg. Baseline asymmetries for MS2, MS3, and MS4 were higher than all control baselines, while MS1 had a relatively low baseline asymmetry.

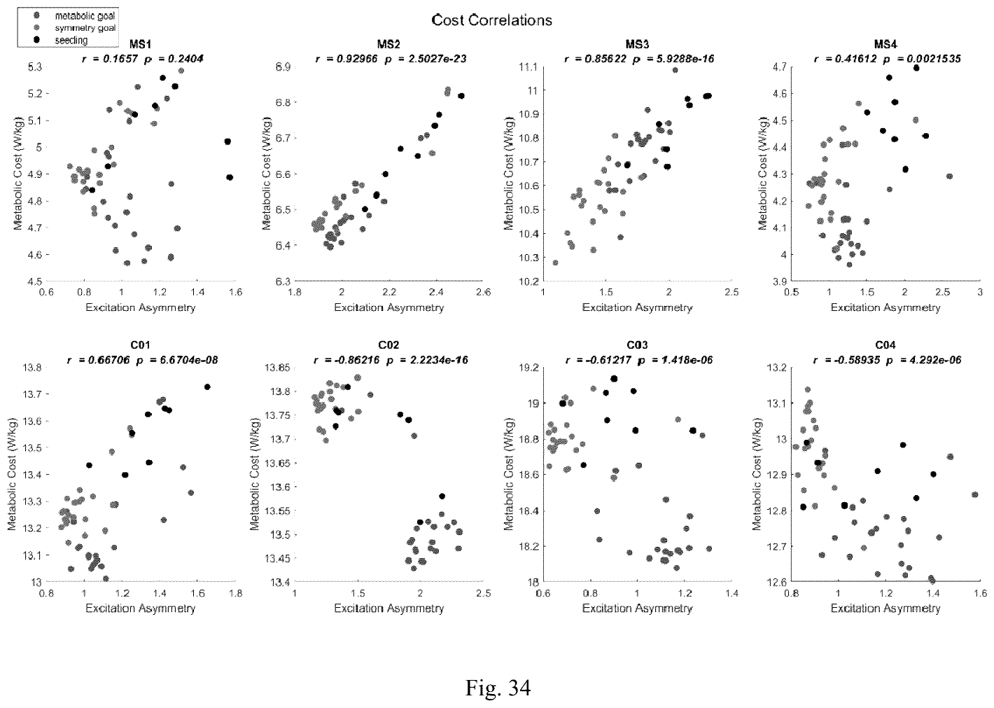

Out of the 8 subjects, 7 showed a significant (p<0.05) correlation between muscle excitation asymmetry and metabolic cost (FIG. 34). For all MS subjects, this was a positive correlation (MS1 was not shown to be significant, but did report r>1), while 3 of the 4 control subjects showed a negative correlation.

This work demonstrates a technique for combining modeling of human-device interaction based on surface geometry with dynamic gait simulation to inform the configuration of a highly-adjustable hip flexion exosuit. The results showed unique configurations for each of the 8 participants modeled in the study, which highlights the utility of making a device capable of configuring for various modes of assistance.

Furthermore, the study shows that passive hip flexion exosuits have the potential to increase walking efficiency in both unimpaired and patient populations.

The goal of reducing the metabolic cost of transport was chosen as it is a common metric in assessing the effectiveness of assistive technology [L. M. Mooney, E. J. Rouse, and H. M. Herr, “Autonomous exoskeleton reduces metabolic cost of human walking,” J. Neuroeng. Rehabil., vol. 11, no. 1, p. 151, 2014, doi: 10.1186/1743-0003-11-151], [Y. Ding, M. Kim, S. Kuindersma, and C. J. Walsh, “Human-in-the-loop optimization of hip assistance with a soft exosuit during walking,” Sci. Robot., vol. 3, no. 15, p. eaar5438, 2018, doi: 10.1126/scirobotics.aar5438], and because it demonstrates the usefulness of including muscle-driven simulations in this modeling workflow. While the optimizations were successful in reducing the estimated metabolic consumption for each of the participants, options for defining the cost function may provide more utility in this kind of analysis given the plethora of model parameters once has access to from simulation results that could not be readily obtained in physical experimentation. Recent work suggest that users may not be able to reliably tell when they are being assisted to reduce metabolic cost [R. L. Medrano, G. C. Thomas, and E. J. Rouse, “Can humans perceive the metabolic benefit provided by augmentative exoskeletons?,” J. Neuroeng. Rehabil., vol. 19, no. 1, pp. 1-13, 2022, doi: 10.1186/s12984-022-01002-w], making it doubtful that someone would go out of their way to wear a device for these effects alone. Particularly when dealing with patient populations, such as people with MS, there are often more pressing considerations such as pain incurred during movement or detrimental movement patterns. Because musculoskeletal simulation enables estimation of muscle excitations and forces that are difficult or impossible to measure during physical experiments, a system like the one presented in this work could be used for configuring devices to accomplish neuromuscular goals like targeting the activation of particular muscle groups, or the energy expenditure of individual muscles. For this reason, it was pertinent to perform the symmetry optimization and compare the outcomes.

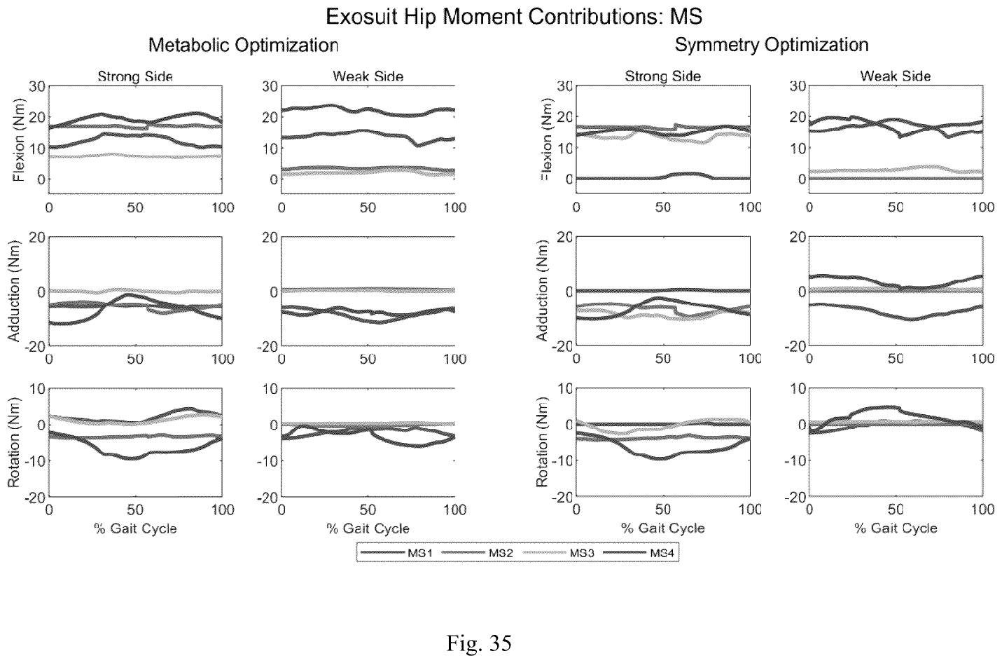

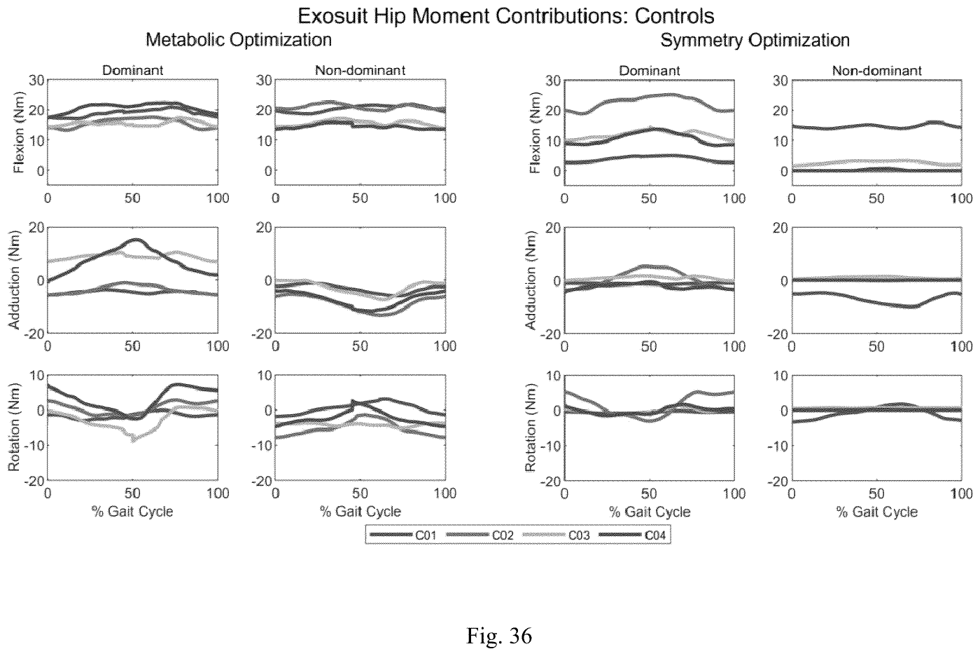

Examining the moments contributed by the exosuit (FIG. 35) shows that, surprisingly, the optimal configurations for MS2 and MS3 contributed very little hip flexion to the weaker leg. MS1, MS2, and MS4 all showed that a combination of external rotation and adduction was beneficial for reducing the metabolic cost. For the controls (FIG. 36) there tended to be an asymmetry to the exosuit assistance in rotation and adduction, even though this optimization had no explicit incentive relating to symmetry. This suggests that passive energy redistribution in an asymmetric manner could be beneficial even to unimpaired populations. It remains to be seen whether this asymmetry would hold across subsequent strides for each subject, or if the given configuration is an artifact of the specific stride that was modeled in the study. Future investigations should model additional strides for each subject and compare the effects of using the same exosuit configurations on the different strides. Depending on the outcome of such an analysis, it may prove to be worth the extra computation cost to perform multiple simulations during each optimizer iteration, taking an average of the costs.

Regarding the mechanical parameters selected, the vast majority of the optimal bands in the metabolic optimization were near the minimum allowable resting length of 50% elongation (Table 5). In other words, they were at the upper limit of allowable pre-tension. Band stiffness, by comparison, saw more variation within its allowable limits, but also tended toward higher values, particularly in the controls. These aggressive band configurations were able to produce peak torques just over 20 Nm, which is well below where others have reported optimal assistance values when using active exosuits [J. Kim et al., “Reducing the energy cost of walking with low assistance levels through optimized hip flexion assistance from a soft exosuit,” Sci. Rep., vol. 12, no. 1, pp. 1-13, 2022, doi: 10.1038/s41598-022-14784-9]. Being passive, however, one might expect diminishing returns at far lower assistance values, as the work done by the exosuit during hip flexion must be done on the exosuit by the user during hip extension. Situations like this also highlight the need for physical validation studies with user surveys, as it is possible that user discomfort would be the limiting factor before diminishing metabolic costs are incurred.

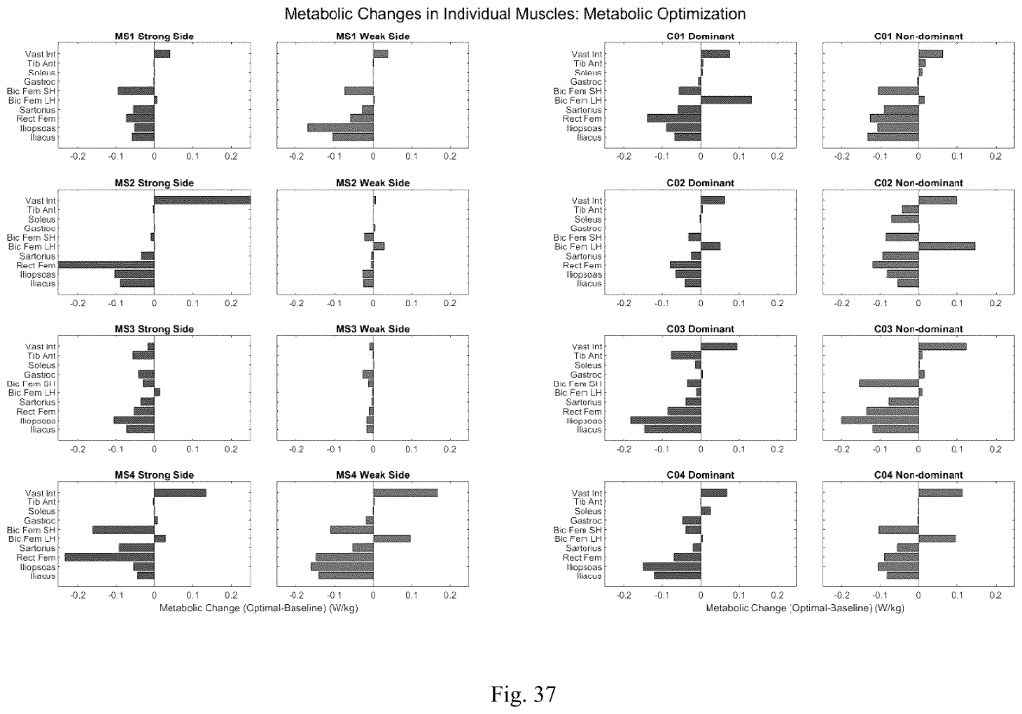

To explore individual muscle contributions to the metabolic savings, the difference (baseline minus optimal configuration) in metabolic expenditure is shown in FIG. 37. Larger reduction tended to correspond to more aggressive band profiles, and most muscles shown consumed less energy in the device trials. The hip flexors in particular showed large reductions, but surprisingly some hip extensors did as well. Interestingly, the vastus intermedialis tended to consume more energy in the optimal device configurations. A reason for this could be the function of the vasti as knee extensors-possibly compensating for the lessened activity of the rectus femoris, another knee extensor. The plantar flexors, which play a major role in swing initiation, showed very little change in metabolic expenditure, suggesting that the device did not have much of a downstream effect on the kinematic chain. This suggests that such a device may be useful for supplementing leg swing for people who use ankle-foot orthoses, which restrict plantarflexion.

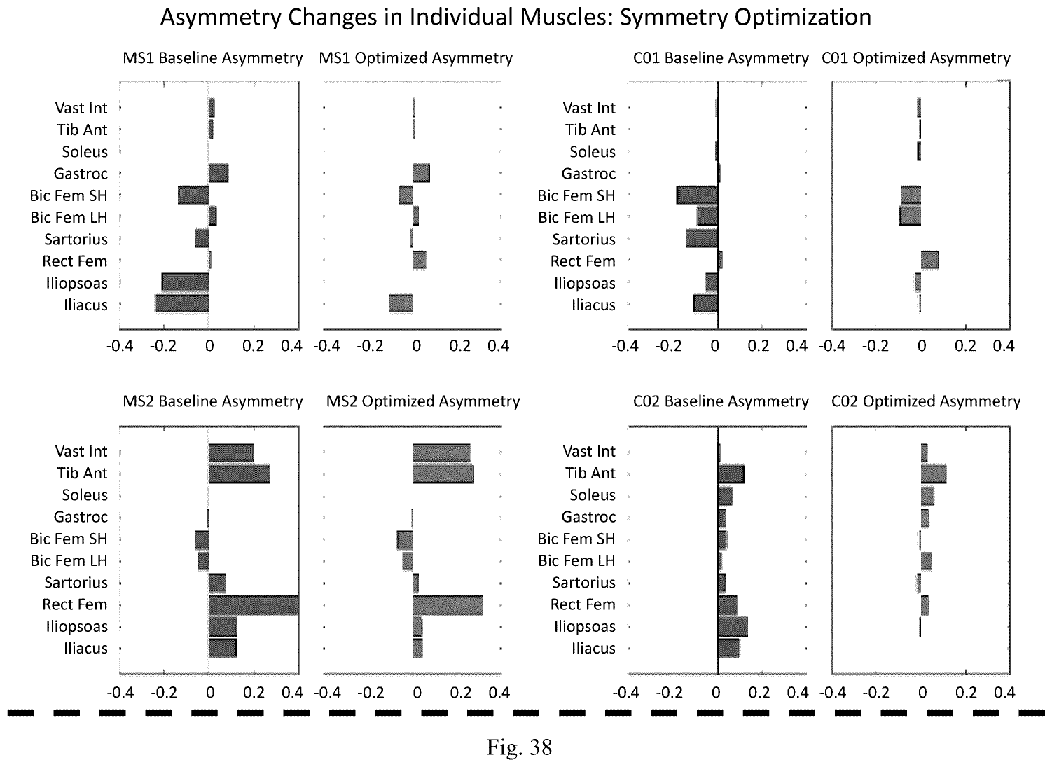

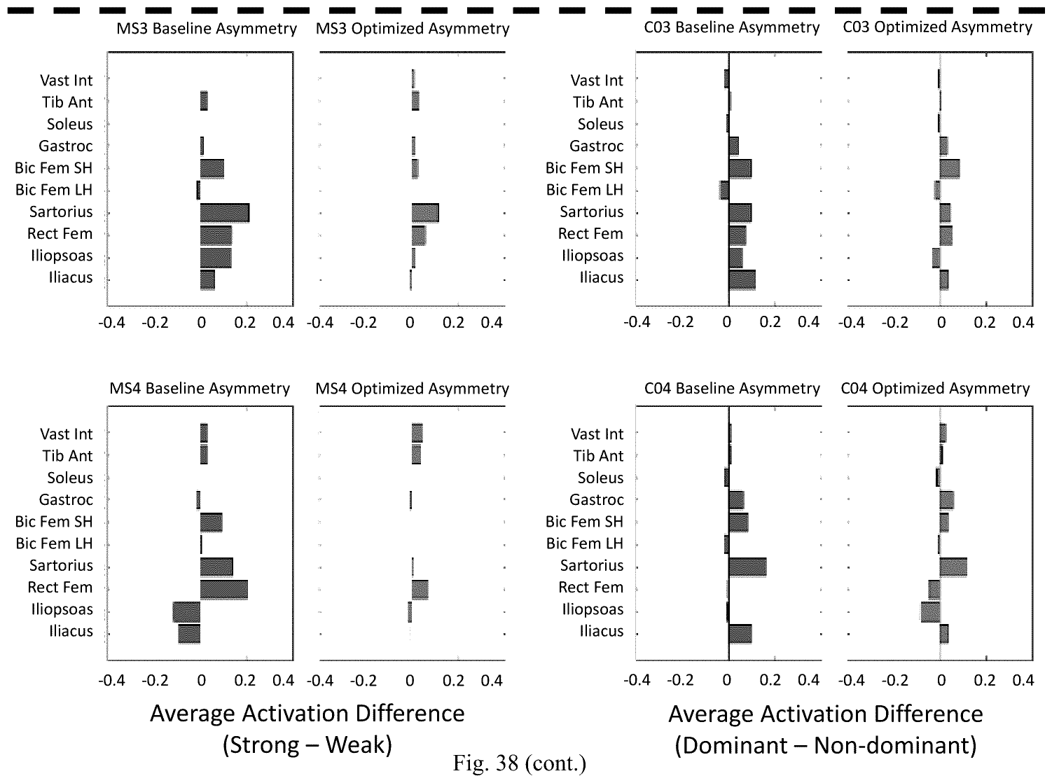

The symmetry optimizations showed more nuanced results than their metabolic counterparts, as band configurations tended to be asymmetric in both aggressiveness and attachment locations, mirroring the goal of the optimization. The fact that the aggressive band was used for the stronger or dominant side in a majority of the subjects and the responses of individual muscles (FIG. 38) suggest that the presence of a stiff band on one limb shifted the balance in muscle excitation towards the contralateral limb. In this optimization, the band setup on the weaker leg generally avoided providing adduction or rotational moments.

The correlation analysis showed that there were indeed strong correlations between inter-limb muscle excitation asymmetry and the metabolic cost of walking (FIG. 34). Three of four MS subjects supported the hypothesis that there would be a positive correlation between the two, and the fourth showed a weak correlation that was not deemed significant by the disclosed metrics. Interestingly, the opposite was true for the controls group, where three of the four subjects showed a strong negative correlation, indicating that changing the balance of muscle excitations in healthy individuals may be detrimental to efficient walking. Given the greater symmetry that is typically exhibited in unimpaired walking, it is unsurprising that a unilateral assistance approach was less effective for the control subjects.

By indicating which points arose from which optimization (FIG. 34), how much of a tradeoff is available between the two different goals can be visualized. C02, for example, shows disparate clusters where there is more of a binary choice between optimizing symmetry or optimizing metabolic cost. Others, however, would be excellent candidates for using multi-objective optimization techniques to select a “best of both worlds” configuration. For example, the correlation scatterplots could be used to form a Pareto frontier, and the balance between metabolic cost and excitation symmetry could be assessed. This technique would be particularly useful for the less positively correlated cost functions. These results further highlight the need for individualized assistance provided by highly configurable wearable devices, and show that with different strategies, populations with very different needs could be assisted by the same device under different conditions.

While this is not the first example of using computational simulation for assistive device optimization [C. L. Dembia, A. Silder, T. K. Uchida, J. L. Hicks, and S. L. Delp, “Simulating ideal assistive devices to reduce the metabolic cost of walking with heavy loads,” PLoS One, vol. 12, no. 7, pp. 1-25, 2017, doi: 10.1371/journal.pone.0180320], [D. F. N. Gordon, C. McGreavy, A. Christou, and S. Vijayakumar, “Human-in-the-Loop Optimization of Exoskeleton Assistance Via Online Simulation of Metabolic Cost,” IEEE Trans. Robot., vol. 38, no. 3, pp. 1410-1429, 2022, doi: 10.1109/TRO.2021.3133137], this work is unique in that it takes a physically-realizable soft exosuit platform and optimizes its parameters by accounting for individual surface geometry and movements. The study participants exhibited a range of functional abilities, from no impairment to significant gait deficits, and the device's means of power transmission were routed according to their individual needs. It was found that subjects with MS had strong correlations between reducing metabolic cost of walking and reducing the asymmetry in muscle excitations, while control subjects showed the opposite correlation.

A series of investigations regarding the efficacy and design of wearable assistive devices is presented, with a particular focus on the case of hip flexion assisting devices. The major findings are summarized below: a soft passive, unilateral hip flexion orthosis is well-tolerated by healthy adults and adults with MS during short bouts of level-ground walking, and under three different levels of assistance. There were statistically significant changes to both kinematic and energetic parameters of gait, MS subjects experiencing shifts toward more normative numbers. The results of this investigation motive further study of the effects of varying parameters of the passive device. For those with MS, there was a significant increase in the peak hip flexion angle, and a shift toward net positive work done by the hip while wearing the orthosis. Of the three assistance levels tested, the lowest amount of assistance (most compliant elastic resistance band) affected the greatest changes for people with MS. This is a promising result, as a less-noticeable device is less likely to be abandoned by the user.

To better understand the locomotor biomechanics relating to varied terrains and the transitions between terrains that are often encountered, a dataset of locomotor transition kinematics was amassed using a motion capture lab and terrain park. An in-depth analysis of the kinematics of transitions between level walking and stair ascent and descent was conducted, and statistical parametric mapping was used to quantify the regions of the gait cycle where the transition kinematics in the ankle, knee, and hip are unique from either level walking or stair walking. The presence of unique kinematics and information about when they occur for each joint suggest that those developing powered assistive devices such as prostheses and exoskeletons/exosuits could benefit from detecting these transitions and handling them as a special case in their control architecture. Gaussian process regression models were fit to the data, including categorical information about the transition type, to generate smooth predictive models of joint angles for a given locomotor context.

A system was developed to model the interaction between soft exosuits and the user's body, providing information on the state of the exosuit's contracting element(s), as well as the moment arm formed about the joint(s) spanned. 3D surface models representing a statistical cross-section of BMI and biological sex were used to understand the effects of body size and shape on the mechanics of soft hip flexion exosuits. It was shown that, while increased BMI results in increased moment arm about the hip, the increased body mass meant that mass-normalized power provided by exosuit decreased with greater BMI.

The human shape modeling system was combined with musculoskeletal modeling software to generate dynamic simulations of the biomechanical effects of a passive, bilateral, hip flexion exosuit. The system was applied to models of four healthy control subject and four people with MS. Eight exosuit parameters were tuned using Bayesian optimization, shedding light on the differing strategies that could be implemented with a single, highly-configurable device in order to achieve specific biomechanical goal. Two different cost functions (one metabolic, one related to muscle activation symmetry) were used in separate optimizations for each subject. It was found that for MS subjects, there was a positive correlation between reductions in metabolic cost and reductions in muscle activation asymmetry, while for control subjects the correlation was negative.

The results herein comprise both exploratory experimentation with a prototype hip flexion assistance device, and extensive computational modeling of similar devices. There are a multitude of indications that passive hip flexion assistance could be beneficial to a variety of populations. This body of work makes a strong case for the continued development and testing of these devices to realize their potential utility to society.

### Example 6: Muscle Activity

TABLE 7
Ankle Joint Kinematics. ANOVA results for ankle joint kinematics reported as mean
(std), * indicates significant (p < 0.05) difference from N1 baseline.
Device leg
Stance phase plantar flexion peak (deg)

| C01 | 7.16 (0.855) | *8.75 (0.823) | | *9.61 (0.525) | *9.24 (0.784) | 6.12 (0.791) | 6.76 (1.13) | 0.735 |
|---|---|---|---|---|---|---|---|---|
| C02 | 6.62 (1.01) | 7.36 (0.631) | 6.62 (0.877) | *7.87 (0.881) | *8.89 (0.633) | *7.87 (0.663) | *8.76 (0.559) | 0.577 |
| C04 | 13.9 (0.163) | 13.5 (0.362) | 13.7 (0.494) | 13.5 (0.425) | *14.6 (0.358) | 14.2 (0.344) | *14.6 (0.584) | 0.541 |
| C05 | 11 (0.83) | *12.3 (0.901) | *12.8 (1.14) | *13.5 (0.689) | *12.6 (0.967) | 11.3 (0.799) | 11.5 (0.554) | 0.517 |
| MS1 | 0.053 (0.664) | *1.39 (1.07) | *2.17 (0.94) | *3.47 (0.575) | *3.22 (0.784) | *3.18 (0.685) | *2.06 (0.615) | 0.699 |
| MS2 | −6.21 (1.13) | −7.11 (0.449) | −5.63 (0.639) | *−4.43 (1.15) | *−4.98 (0.441) | *−4.37 (1.2) | −5.65 (0.557) | 0.557 |
| MS3 | 3.79 (0.587) | 4.07 (0.564) | 3.63 (0.506) | 3.86 (0.392) | *4.54 (0.489) | 4.02 (0.411) | *4.83 (0.394) | 0.43 |
| MS4 | 5.6 (0.694) | 6.02 (0.883) | 5.43 (0.457) | *4.58 (0.97) | *6.96 (0.745) | *7.14 (0.705) | *8.07 (0.542) | 0.717 |
| | N1 | N2 | N3 | N4 | B1 | B2 | B3 | η\hat{ }2 |

Swing phase plantar flexion peak (deg)

| | | | | | | | | |
|---|---|---|---|---|---|---|---|---|
| C01 | 29.1 (1.86) | 28.9 (2.82) | | 28 (1.95) | 27.2 (2.89) | 25.9 (4.47) | 25.7 (2.02) | 0.195 |
| C02 | 13.5 (1.84) | 14 (1.39) | 14.9 (2.51) | 13.2 (1.65) | 14.2 (2.22) | 15.1 (1.37) | 14.2 (1.66) | 0.113 |
| C04 | 19.5 (1.36) | 18.6 (0.798) | *16.6 (0.819) | *16 (0.858) | *17.1 (1.1) | *14.8 (0.748) | 19.7 (1.08) | 0.768 |
| C05 | 22.7 (1.96) | *20.1 (0.846) | *19.7 (1.26) | *20.6 (0.993) | *20.5 (1.28) | *19 (1.35) | *19.9 (1.88) | 0.381 |
| MS1 | −0.834 (0.481) | 0.069 (1.96) | *1.49 (1.82) | *2.37 (1.77) | 1.05 (1.55) | *2 (1.89) | 0.128 (0.772) | 0.343 |
| MS2 | −6.88 (0.813) | *−8.59 (0.552 | −6.61 (0.81) | *−5.28 (0.975 | −8.21 (0.447) | *−3.76 (1.84) | −6.36 (1.24) | 0.704 |
| MS3 | 1.23 (0.402) | 1.52 (0.319) | 0.876 (0.391) | 1.28 (0.467) | 1.44 (0.557) | 0.771 (0.497) | *1.9 (0.238) | 0.442 |
| MS4 | 10.4 (0.764) | 11.6 (1.15) | 11.9 (0.8) | 10.1 (1.88) | *12.7 (1.31) | 11.2 (1.14) | *12.8 (1.61) | 0.378 |
| | N1 | N2 | N3 | N4 | B1 | B2 | B3 | η\hat{ }2 |

Dorsiflexion peak (deg)

| | | | | | | | | |
|---|---|---|---|---|---|---|---|---|
| C01 | 3.99 (0.397) | *3.22 (0.57) | | 4.4 (0.549) | 4.14 (0.553) | 3.64 (0.377) | *2.87 (0.772) | 0.506 |
| C02 | 11.5 (0.6) | 11.6 (0.476) | 12 (0.524) | *12.2 (0.458) | 12 (0.571) | *12.5 (0.451) | *12.3 (0.513) | 0.322 |
| C04 | 9.1 (0.565) | *8.13 (0.469) | 9.28 (0.338) | 9.74 (0.202) | 9.52 (0.744) | 9.54 (0.449) | *7.67 (0.767) | 0.67 |
| C05 | 13.6 (0.679) | *12.4 (0.768) | 13.3 (0.633) | 12.8 (0.563) | 13 (0.929) | 14.4 (0.89) | 13.8 (0.654) | 0.43 |
| MS1 | 13.3 (0.788) | *10.9 (1.83) | 12.3 (1.96) | 12.2 (1.98) | 12.1 (1.53) | 12 (1.31) | 12.6 (1.25) | 0.175 |
| MS2 | 16.5 (0.748) | 17.3 (0.707) | 15.4 (0.888) | 15.5 (1.23) | 15.6 (0.876) | *14.7 (1.64) | 15.2 (0.688) | 0.409 |
| MS3 | 5.92 (0.663) | 5.28 (0.961) | 5.87 (0.941) | 5.51 (0.575) | 6.66 (0.733) | 5.85 (0.621) | 6.02 (0.588) | 0.244 |
| MS4 | 13.3 (0.696) | *12.4 (0.978) | 13.1 (0.381) | *12.3 (0.82) | *11.9 (0.511) | *12.1 (0.421) | 12.6 (0.599) | 0.36 |
| | N1 | N2 | N3 | N4 | B1 | B2 | B3 | η\hat{ }2 |

Non-device leg
Stance phase plantar flexion peak (deg)

| | | | | | | | | |
|---|---|---|---|---|---|---|---|---|
| C01 | 9.74 (1.47) | 10.2 (0.568) | | *11.3 (0.849) | *11.3 (1.31) | 9.43 (0.738) | *7.49 (1.54) | 0.588 |
| C02 | 3.84 (0.946) | 4.54 (0.779) | *5.01 (0.493) | *5.62 (0.941) | *5.12 (0.67) | 3.99 (0.438) | *6.25 (0.829) | 0.557 |
| C04 | 14.8 (0.533) | 14.3 (0.466) | 14.7 (0.428) | 14.5 (0.54) | *14.1 (0.382) | 14.6 (0.342) | 14.8 (0.537) | 0.229 |
| C05 | 11.2 (1.24) | 11.5 (0.564) | 12.2 (1) | 12.3 (0.927) | 12 (0.741) | 11.7 (0.624) | 11.1 (0.689) | 0.214 |
| MS1 | −0.03 (1) | 1.99 (1.71) | *3.96 (1.13) | *4.16 (1.75) | *4.84 (1.8) | *5.5 (1.41) | 1.77 (1.48) | 0.623 |
| MS2 | −5.76 (0.973) | *−7.35 (0.286) | −6.53 (1.31) | −6.76 (0.641) | *−6.93 (0.577) | −6.11 (1.12) | *−7.69 (0.585) | 0.373 |
| MS3 | 8.72 (0.842) | 10 (1.28) | 7.07 (2.14) | 9.85 (0.798) | 10.2 (0.952) | 9.87 (0.914) | 9.72 (1.29) | 0.432 |
| MS4 | 3.29 (0.763) | *5.63 (1.11) | 3.4 (1.61) | *8.71 (0.988) | *5.66 (0.735) | 2.76 (1.15) | *5.47 (0.792) | 0.782 |
| | N1 | N2 | N3 | N4 | B1 | B2 | B3 | η\hat{ }2 |

Swing phase plantar flexion peak (deg)

| | | | | | | | | |
|---|---|---|---|---|---|---|---|---|
| C01 | 34.5 (2.45) | 33.9 (1.65) | | 34 (1.87) | 33.9 (0.906) | 36.4 (0.957) | 32.8 (1.94) | 0.31 |
| C02 | 6.62 (1.3) | 8.44 (1.01) | 7.73 (1.6) | 7.98 (1.33) | 6.53 (2.06) | 8.27 (0.95) | 6.32 (1.57) | 0.268 |
| C04 | 20.6 (1.16) | 21 (1.06) | 19.8 (0.466) | 20.2 (0.588) | 20.3 (0.613) | 19.8 (0.705) | 21.3 (1.07) | 0.297 |
| C05 | 19.1 (1.15) | 17.7 (1.14) | *17.3 (1.41) | *16.9 (0.655) | 17.4 (1.45) | 18.5 (1.75) | 17.6 (1.34) | 0.243 |
| MS1 | 7.39 (2.01) | *12.6 (3.5) | *12.1 (2.63) | *14.5 (3.4) | *17.6 (2.78) | * 18 (2.15) | *14.6 (3.73) | 0.588 |
| MS2 | −4.58 (0.65) | −4.18 (0.868) | *−1.87 (0.471 | *−1.76 (1.62) | −3.43 (0.762) | *0.424 (1.83 | *−2.25 (0.902) | 0.689 |
| MS3 | 5.68 (1.59) | 7.06 (2.33) | 5.38 (1.11) | 4.67 (0.847) | *9.55 (0.989) | 4.7 (1.07) | 7.34 (1.91) | 0.569 |
| MS4 | 11.9 (1.8) | 12.7 (1.28) | 10.7 (1.16) | *18.9 (1.67) | 12.6 (1.75) | 11.7 (1.27) | 13.9 (1.84) | 0.74 |
| | N1 | N2 | N3 | N4 | B1 | B2 | B3 | η\hat{ }2 |

Dorsiflexion peak (deg)

| | | | | | | | | |
|---|---|---|---|---|---|---|---|---|
| C01 | 2.06 (0.759) | 1.4 (0.766) | | 1.7 (0.6) | 1.26 (0.671) | *0.53 (0.542 | *1.19 (0.402) | 0.381 |
| C02 | 17.6 (0.674) | 18 (0.573) | *18.7 (0.626) | 17.9 (0.369) | 18.2 (0.493) | 17.8 (0.284) | *19.3 (0.516) | 0.539 |
| C04 | 8.06 (0.754) | 7.67 (0.332) | *8.75 (0.515) | 8.56 (0.383) | 8 (0.414) | *8.78 (0.504 | *7.12 (0.42) | 0.596 |
| C05 | 13.2 (0.486) | 13.4 (0.538) | 14 (0.863) | *14.5 (0.519) | 13.9 (0.514) | *14.4 (0.598 | 13.7 (0.847) | 0.32 |
| MS1 | 13.5 (1.21) | 13.1 (1.11) | 12.8 (1.16) | 12.6 (0.691) | 13 (0.531) | 12.9 (1.15) | 13.1 (1.63) | 0.054 |
| MS2 | 12.8 (1.57) | 11.6 (1.14) | *10.1 (0.675) | *10.7 (0.956) | 11.4 (0.89) | *10 (1.23) | 11.4 (1.04) | 0.429 |
| MS3 | 8.64 (0.567) | 8.27 (0.441) | 8.79 (0.569) | 8.72 (0.446) | 8.83 (0.585) | *9.68 (1.11) | 8.83 (0.692) | 0.281 |
| MS4 | 11 (0.663) | *9.95 (0.302) | 11 (0.418) | *9.39 (0.659) | 10.3 (0.939) | 10.4 (0.719) | *9.87 (0.892) | 0.405 |
| | N1 | N2 | N3 | N4 | B1 | B2 | B3 | η\hat{ }2 |

TABLE 8
Knee Joint Kinematics. ANOVA results for knee joint kinematics reported as mean
(std), * indicates significant (p < 0.05) difference from N1 baseline.
Device leg
Knee flexion peak (deg)

| | | | | | | | | |
|---|---|---|---|---|---|---|---|---|
| C01 | 66 (0.883) | 67.3 (0.766) | | 66.5 (1.21) | *67.8 (0.829) | 65.9 (1.57) | *67.7 (1.17) | 0.34 |
| C02 | 58.1 (0.942) | 58.6 (0.83) | *59.5 (0.674) | *59.3 (0.699) | *61.8 (0.803) | *61.9 (0.781) | *63.2 (0.682) | 0.858 |
| C04 | 58.4 (0.91) | *61 (0.725) | *61.1 (0.471) | *61.1 (0.455) | *64.8 (0.999) | *63.7 (0.753) | *67.6 (1.18) | 0.929 |
| C05 | 64.8 (0.605) | 64.9 (0.75) | *57.5 (0.98) | *49 (2.24) | *56.6 (1.1) | 64.6 (0.881) | *49.6 (1.11) | 0.97 |
| MS1 | 25.9 (1.92) | *30.2 (2.04) | *33.8 (2.4) | *35.1 (2.13) | *37.2 (2.21) | *32.8 (2.69) | *29.1 (1.95) | 0.745 |
| MS2 | 23.1 (1.94) | 21.9 (0.664) | *19.5 (2.16) | 22.8 (1.4) | *20.1 (0.573) | 21.1 (2.89) | *20.7 (1.47) | 0.359 |
| MS3 | 10.4 (1.92) | *16.3 (0.482) | *17.3 (0.831) | *16.3 (0.83) | *20.2 (1.21) | *27.8 (0.65) | *21.4 (1.66) | 0.951 |
| MS4 | 34.4 (1.92) | 33.3 (2.33) | 36.1 (1.37) | *37.5 (0.742) | *45.7 (1.67) | 34.4 (1.66) | 33.8 (1.04) | 0.872 |
| | N1 | N2 | N3 | N4 | B1 | B2 | B3 | η\hat{ }2 |

Knee extension peak (deg)

| | | | | | | | | |
|---|---|---|---|---|---|---|---|---|
| C01 | 1.3 (0.615) | 1.67 (0.68) | | 1.99 (0.468) | 1.17 (0.695) | 0.578 (0.342) | *2.94 (1.9) | 0.408 |
| C02 | 8.76 (1.01) | *10.4 (0.608) | *10.7 (0.784) | *11.3 (0.498) | 9.25 (1.01) | *7.07 (0.879) | 9.29 (1.01) | 0.728 |
| C04 | 4.61 (0.322) | *3.21 (0.58) | *3.8 (0.455) | 4.04 (0.408) | *1.27 (0.637) | *1.85 (0.447) | *2.06 (0.67) | 0.85 |
| C05 | 3.66 (0.336) | 3.79 (0.393) | *12.2 (0.939) | *8.31 (2.18) | *11.6 (0.583) | 3.26 (1.06) | *16.2 (1.03) | 0.953 |
| MS1 | 9.7 (4.49) | *15.5 (3.01) | 14 (4.01) | 10.9 (5.5) | 10.5 (3.11) | 13.3 (3.7) | 7.03 (2.59) | 0.347 |
| MS2 | 2.62 (1.16) | 2.32 (1.08) | 1.64 (1.35) | 2.44 (1.05) | 1.39 (0.923) | 1.44 (1.28) | *0.935 (0.667 | 0.244 |
| MS3 | 3.49 (0.367) | 1.53 (1.12) | 3.23 (0.423) | 1.22 (0.673) | 4.72 (2.58) | *13 (4.63) | *7.07 (0.896) | 0.783 |
| MS4 | 7.84 (1.58) | 8.55 (2.45) | 9.29 (0.563) | 7.97 (1.84) | *3.82 (1.51) | *11.6 (1.3) | 9.03 (1.92) | 0.649 |
| | N1 | N2 | N3 | N4 | B1 | B2 | B3 | η\hat{ }2 |

Knee range of motion (deg)

| | | | | | | | | |
|---|---|---|---|---|---|---|---|---|
| C01 | 67.3 (1.23) | 69 (1.17) | | 68.5 (1.26) | 68.9 (1.32) | 65.6 (1.88) | 66.3 (3.51) | 0.336 |
| C02 | 66.8 (1.57) | *69 (1.31) | *70.3 (0.944) | *70.7 (0.881) | *71.1 (0.957) | *69 (1.37) | *72.5 (1.16) | 0.692 |
| C04 | 63 (0.85) | 64.2 (0.768) | *64.9 (0.487) | *65.2 (0.497) | 63.6 (1.45) | 61.9 (0.976) | *65.5 (1.54) | 0.611 |
| C05 | 68.5 (0.871) | 68.7 (0.882) | 69.7 (1.23) | *57.4 (2.4) | 68.2 (1.39) | 67.9 (1.22) | *65.8 (1.63) | 0.89 |
| MS1 | 35.6 (4.03) | *45.8 (3.34) | *47.8 (5.03) | *46.1 (6.98) | *47.7 (4.95) | *46.1 (5.82) | 36.2 (2.6) | 0.533 |
| MS2 | 20.5 (2.22) | 19.6 (1.31) | 21.1 (2.21) | *25.2 (1.88) | 18.8 (0.851) | 21.9 (3.3) | 20.1 (2.24) | 0.486 |
| MS3 | 13.9 (1.97) | 14.9 (0.922) | 14.1 (1) | 15.1 (0.938) | 15.4 (2.23) | 14.7 (5.08) | 14.3 (1.45) | 0.048 |
| MS4 | 42.3 (2.85) | 41.9 (3.65) | 45.4 (1.35) | 45.5 (2.29) | *49.5 (2.63) | *46 (2.66) | 42.8 (1.9) | 0.513 |
| | N1 | N2 | N3 | N4 | B1 | B2 | B3 | η\hat{ }2 |

Non-device leg
Knee flexion peak (deg)

| | | | | | | | | |
|---|---|---|---|---|---|---|---|---|
| C01 | 60.8 (0.57) | 61.3 (0.669) | | *61.9 (0.709) | 61.4 (0.831) | 60.9 (0.544) | *59.5 (0.647) | 0.584 |
| C02 | 61.6 (0.551) | 62.3 (0.811) | *63.4 (1.14) | *63 (0.572) | 62.4 (0.713) | 62 (0.343) | *63 (0.677) | 0.436 |
| C04 | 63.3 (0.62) | 63.6 (0.509) | 63.9 (0.463) | 63.3 (0.691) | 63.5 (0.515) | 63.3 (0.706) | *62.1 (0.591) | 0.451 |
| C05 | 63 (0.262) | 63.2 (0.779) | *63.9 (0.827) | 63.4 (0.595) | 63.7 (0.766) | 63.5 (0.692) | 63 (0.589) | 0.202 |
| MS1 | 55.9 (0.834) | 57 (1.37) | 57.3 (1.17) | 56.5 (0.965) | 55.8 (1.54) | 56.8 (1.52) | 56.5 (0.971) | 0.161 |
| MS2 | 40.9 (1.44) | 39.4 (1.64) | *38.1 (0.723) | *38.5 (0.877) | *36.3 (0.847) | *38 (1.39) | *37.3 (1.04) | 0.591 |
| MS3 | 64.5 (1.15) | 65.8 (0.98) | 63.6 (1.28) | 65.1 (1.04) | *67.2 (0.756) | 63.9 (1.38) | 65.8 (0.999) | 0.555 |
| MS4 | 72.1 (0.951) | *69.8 (0.736) | *70.9 (1.03) | 71.1 (0.365) | *69.6 (0.733) | *68.9 (0.745) | *69.5 (0.944) | 0.642 |
| | N1 | N2 | N3 | N4 | B1 | B2 | B3 | η\hat{ }2 |

Knee extension peak (deg)

| | | | | | | | | |
|---|---|---|---|---|---|---|---|---|
| C01 | 0.576 (0.409 | 0.927 (0.407) | | 0.842 (0.824) | 0.552 (0.417) | 0.949 (0.86) | 0.655 (0.404) | 0.077 |
| C02 | 5.83 (1.8) | 6.06 (1.67) | 7.8 (2) | 4.34 (0.935) | 7.56 (1.77) | 3.83 (2.95) | 7.26 (2) | 0.379 |
| C04 | 1.89 (0.481) | 1.62 (0.516) | 1.38 (0.472) | *2.81 (0.604) | 1.46 (0.753) | *2.75 (0.373) | 2.23 (0.889) | 0.475 |
| C05 | 4.38 (1.49) | 4.29 (0.645) | 4.8 (0.845) | 4.98 (1.19) | 3.8 (1.72) | 5.07 (1.13) | *2.55 (1.12) | 0.334 |
| MS1 | 1.03 (0.617) | 1.39 (1.2) | 1.98 (1.91) | 0.818 (0.813) | 2.22 (2.36) | 3.18 (2.31) | 1.52 (0.751) | 0.197 |
| MS2 | 10.1 (1.96) | 7.82 (0.921) | *4.52 (1.81) | *1.91 (3.02) | *7.02 (1.39) | *4.06 (1.93) | *6.97 (1.19) | 0.674 |
| MS3 | 10.7 (2.27) | 9.79 (1.14) | 11.7 (1.48) | 11 (1.82) | *7.92 (0.891) | 11.7 (1.23) | 9.34 (2.72) | 0.367 |
| MS4 | 15.6 (0.491) | *13.6 (0.457) | *13.1 (0.53) | *13.3 (0.452) | *12.2 (0.227) | *13.2 (0.428) | *12.5 (0.51) | 0.847 |
| | N1 | N2 | N3 | N4 | B1 | B2 | B3 | η\hat{ }2 |

Knee range of motion (deg)

| | | | | | | | | |
|---|---|---|---|---|---|---|---|---|
| C01 | 60.3 (0.812) | *62 (0.983) | | *62.2 (1.52) | 61.3 (1.19) | 60.1 (1.13) | 59.8 (0.964) | 0.436 |
| C02 | 67.4 (2.1) | 68.3 (1.63) | *71.2 (1.9) | 67.4 (1.25) | 70 (1.65) | 65.6 (3.43) | *70.3 (1.96) | 0.462 |
| C04 | 65.2 (0.667) | 65.2 (0.862) | 65.3 (0.366) | 66.1 (1.14) | 64.9 (1) | 66.1 (0.665) | 64.4 (1.01) | 0.328 |
| C05 | 67.4 (1.62) | 67.5 (1.08) | 68.7 (1.24) | 68.4 (1.36) | 67.5 (1.43) | 68.5 (1.23) | *65.5 (1.36) | 0.383 |
| MS1 | 54.8 (1.09) | *58 (1.94) | *59 (2.47) | 56.9 (1.13) | *57.9 (2.95) | *59.6 (2.58) | 55 (1.39) | 0.434 |
| MS2 | 30.7 (2.13) | 31.6 (1.78) | 33.5 (1.84) | *36.6 (3.04) | 29.3 (1.65) | *34 (2.26) | 30.4 (1.42) | 0.585 |
| MS | 53.8 (2.27) | 56 (1.25) | 51.9 (1.88) | 54 (1.71) | *59.3 (1.46) | 52.2 (1.52) | 56.5 (3.21) | 0.62 |
| MS4 | 56.5 (1.14) | 56.2 (0.49) | *57.8 (0.937) | *57.8 (0.566) | 57.3 (0.709) | 55.7 (0.6) | 57 (0.828) | 0.507 |
| | N1 | N2 | N3 | N4 | B1 | B2 | B3 | η\hat{ }2 |

TABLE 9
Hip Joint Kinematics. ANOVA results for hip joint kinematics reported as mean (std), *
indicates significant (p < 0.05) difference from N1 baseline.
Device leg
Hip flexion peak (deg)

| | | | | | | | | |
|---|---|---|---|---|---|---|---|---|
| C01 | 16 (0.643) | *17.8 (0.298) | | *14.7 (0.575) | *17.2 (0.853) | 15.3 (0.987) | *18.4 (0.826) | 0.784 |
| C02 | 16.2 (0.645) | 16.9 (0.647) | *17.2 (0.87) | 16.2 (0.667) | *20.2 (0.696) | *18.7 (0.527) | *18.7(0.397) | 0.839 |
| C04 | 26.3 (0.854) | *27.8 (0.817) | 27.2 (0.588) | *27.8 (0.589) | *33.7(0.973) | *22.4 (0.3) | *23.9 (0.984) | 0.955 |
| C05 | 29.4 (0.684) | 29 (0.372) | *21.5 (0.816) | *21.2 (2.19) | *22.3 (0.696) | *31.2 (0.514) | *16.7 (0.55) | 0.965 |
| MS1 | 10.4 (1.11) | *12.3 (1.7) | 11 (1.54) | 11.8 (1.36) | *16.7(1.1) | *12.5 (0.979) | *13.3(0.723) | 0.722 |
| MS2 | 10.4 (0.932) | 10.6 (0.841) | *8.32 (1.33) | *7.57 (1.39) | *12.2 (0.543) | 9.37 (0.86) | 10 (0.491) | 0.704 |
| MS3 | 15.5 (0.956) | *23.6 (1.95) | *22.3 (2.19) | *23.1 (2.33) | *28.1 (1.78) | *35 (1.26) | *28.7 (1.19) | 0.922 |
| MS4 | 18.1 (0.477) | *17 (0.968) | *17.1 (1.12) | *21.6 (0.381) | *30.9 (0.595) | 17.9 (0.599) | 18.2 (0.392) | 0.98 |
| | N1 | N2 | N3 | N4 | B1 | B2 | B3 | η\hat{ }2 |

Hip extension peak (deg)

| | | | | | | | | |
|---|---|---|---|---|---|---|---|---|
| C01 | 18.8 (0.374) | *17.5 (0.315) | | *20.2 (0.429) | *16.1(0.346) | *15.9 (0.309) | *15.4 (1.07) | 0.916 |
| C02 | 16.1 (0.919) | *15.1 (0.439) | 16.4 (0.379) | *17.7 (0.87) | *14.4(0.298) | *14.9 (0.481) | 16.8 (0.308) | 0.794 |
| C04 | 15.4 (0.558) | 15.6 (0.41) | 15.2 (0.349) | *14 (0.549) | *12.6 (0.895) | 15.9 (1) | 14.7 (1.1) | 0.688 |
| C05 | 15.8 (0.536) | 16.1 (0.371) | *24.7(0.313) | *22.7 (2.46) | *24.4 (0.417) | *12.9 (0.645) | *28.8(0.722) | 0.967 |
| MS1 | 20.5 (1.31) | 21.3 (0.967) | 21.3 (1.08) | 20.9 (0.664) | *16 (0.999) | 20.8 (0.656) | *17.1 (1.43) | 0.803 |
| MS2 | 9.8 (1.11) | *7.62 (0.903) | *14 (1.19) | *12.6 (1.36) | *7.53 (1.39) | 11 (1.72) | 8.7(0.939) | 0.788 |
| MS3 | 9.49 (0.882) | *3.35 (0.855) | *3.79 (0.797) | *4.58 (0.673) | *2.7(0.612) | *−7.34 (2.78) | *1.88 (1.03) | 0.935 |
| MS4 | 14.2 (0.585) | *16 (1.26) | *16.2 (1.11) | *12.5 (1.12) | *7.52 (0.986) | 15 (1.12) | 13.3 (0.935) | 0.887 |
| | N1 | N2 | N3 | N4 | B1 | B2 | B3 | η\hat{ }2 |

Hip range of motion (deg)

| | | | | | | | | |
|---|---|---|---|---|---|---|---|---|
| C01 | 34.8 (0.84) | 35.3 (0.498) | | 34.9 (0.717) | *33.3 (1.05) | *31.2 (0.997) | 33.8 (0.765) | 0.752 |
| C02 | 32.4 (1.34) | 32 (0.848) | 33.6 (1.06) | *33.9 (0.99) | *34.6(0.683) | *33.7 (0.514) | *35.5 (0.504) | 0.642 |
| C04 | 41.7 (0.906) | *43.4 (1.02) | 42.4 (0.363) | 41.7(0.791) | *46.4 (1.02) | *38.3 (0.978) | *38.5 (1.65) | 0.876 |
| C05 | 45.2 (0.907) | 45.1 (0.52) | 46.2 (0.878) | 43.9 (3.36) | 46.7 (0.679) | 44.1 (0.953) | 45.5 (1) | 0.306 |
| MS1 | 30.9 (1.54) | *33.6 (1.59) | 32.3 (2.29) | 32.6 (1.35) | 32.8 (1.39) | *33.4 (1.28) | 30.4 (1.49) | 0.356 |
| MS2 | 20.2 (1.22) | 18.2 (1.17) | 22.3 (2.1) | 20.2 (1.97) | 19.7 (1.3) | 20.4 (1.74) | 18.7 (1.05) | 0.413 |
| MS3 | 25 (1.52) | 27 (1.94) | 26.1 (2.33) | 27.7 (2.3) | *30.8 (2.01) | 27.6 (3.73) | *30.5 (1.73) | 0.45 |
| MS4 | 32.3 (0.722) | 33.1 (1.34) | 33.3 (1.53) | *34.1 (1.28) | *38.5 (1.37) | 32.9 (1.37) | 31.5 (1.09) | 0.754 |
| | N1 | N2 | N3 | N4 | B1 | B2 | B3 | η\hat{ }2 |

Non-device leg
Hip flexion peak (deg)

| | | | | | | | | |
|---|---|---|---|---|---|---|---|---|
| C01 | 15.5 (0.523) | 15.8 (0.302) | | *13.5 (1.07) | *17.2 (0.522) | *17.1 (0.527) | *17.7 (0.294) | 0.86 |
| C02 | 19.6 (0.465) | *21.3 (0.689) | 19.8 (0.439) | 19.8 (0.511) | *21.3 (0.549) | *21.6(0.883) | *20.4 (0.434) | 0.675 |
| C04 | 23.7 (0.549) | 24.7 (0.445) | 24.2 (0.353) | 24.7 (0.524) | *28.4 (0.949) | *17.1 (1.12) | *18 (1.1) | 0.962 |
| C05 | 23.8 (0.565) | 23.6 (0.492) | 23.6 (0.403) | 23.3 (0.43) | *25.1 (0.282) | *25.4 (0.501) | *25.3 (0.463) | 0.793 |
| MS1 | 16.6 (0.604) | *15.3 (0.905) | *14.5 (0.595) | *15.2 (1.07) | 16.4 (0.822) | 15.7 (1.04) | 16 (1.24) | 0.382 |
| MS2 | 18.4 (0.846) | 18.5 (1.11) | 18.1 (0.854) | 18.5 (0.908) | 18.1 (1.29) | 19 (1.25) | 18.2 (1.09) | 0.081 |
| MS3 | 30.7 (1.79) | 32.4 (0.568) | 30.7 (1.44) | 32.2 (1.06) | *33.1 (1.29) | *34.9 (1.6) | *33.4 (0.686) | 0.566 |
| MS4 | 37.9 (0.597) | *36.5 (0.865) | 36.9 (0.743) | 38 (1.17) | *39.3 (0.682) | 36.8 (0.629) | 37.1 (1.12) | 0.547 |
| | N1 | N2 | N3 | N4 | B1 | B2 | B3 | η\hat{ }2 |

Hip extension peak (deg)

| | | | | | | | | |
|---|---|---|---|---|---|---|---|---|
| C01 | 17.5 (0.634) | *16.7 (0.485) | | *19.7 (0.46) | * 16 (0.483) | *16.5 (0.454) | 17.1 (0.783) | 0.833 |
| C02 | 14.4 (0.675) | 14.4 (0.421) | *15.1 (0.404) | *16.8(0.463) | 14.5 (0.238) | 14.2 (0.533) | *16.1 (0.191) | 0.827 |
| C04 | 10.7 (0.96) | *8.97 (0.493) | *9.14 (0.399) | *8.29 (0.64) | *8.47 (0.846) | *19.3 (0.709) | *19 (0.659) | 0.98 |
| C05 | 11.4 (0.415) | 11.6 (0.328) | 11.2 (0.336) | 11.8 (0.522) | *10.6 (0.389) | *10.5 (0.634) | 11.4 (0.42) | 0.513 |
| MS1 | 8.58 (0.726) | *10.1 (1.29) | *11.3 (0.805) | *13.5 (0.779) | *13.4 (0.713) | *13.3 (0.446) | *11.2 (0.714) | 0.834 |
| MS2 | 7.1 (1.69) | 8.39 (1.24) | *11.6(0.862) | *10.2 (2.43) | *10.3 (0.712) | *12.2 (1.86) | *9.79 (0.95) | 0.568 |
| MS3 | 5.11 (1.01) | *7.48 (1.56) | 4.14 (1.21) | *2.92 (1.09) | *2.38 (1.3) | *1.47 (1.17) | *2.9 (0.701) | 0.738 |
| MS4 | −1.03 (0.735) | *1.12 (0.564) | −0.413 (1.06) | −0.411 (0.536) | *−3.4(0.493) | −0.368 (0.903) | *1.23 (0.987) | 0.787 |
| | N1 | N2 | N3 | N4 | B1 | B2 | B3 | η\hat{ }2 |

Hip range of motion (deg)

| | | | | | | | | |
|---|---|---|---|---|---|---|---|---|
| C01 | 33 (0.684) | 32.4 (0.485) | | 33.2 (1.04) | 33.2 (0.714) | 33.5 (0.475) | *34.8(0.923) | 0.518 |
| C02 | 34 (0.849) | *35.7(0.925) | 34.9 (0.66) | *36.5 (0.694) | *35.8 (0.567) | *35.8 (0.703) | *36.6 (0.427) | 0.609 |
| C04 | 34.5 (1.22) | 33.6 (0.668) | 33.3 (0.538) | *33 (0.87) | *36.9 (1.44) | *36.4 (1.09) | *37 (0.989) | 0.742 |
| C05 | 35.2 (0.734) | 35.2 (0.611) | 34.9 (0.477) | 35.1 (0.553) | 35.7 (0.59) | 36 (0.799) | *36.7 (0.687) | 0.486 |
| MS1 | 25.1 (0.796) | 25.4 (0.931) | 25.8 (0.688) | *28.6 (1.33) | *29.8 (0.84) | *29 (1.18) | *27.2 (1.35) | 0.757 |
| MS2 | 25.5 (1.85) | 26.9 (1.9) | *29.8 (1.37) | *28.7 (2.49) | *28.5 (1.44) | *31.3 (1.81) | 28 (1.36) | 0.509 |
| MS3 | 35.8 (2) | *39.9 (1.54) | 34.9 (2.17) | 35.1 (1.48) | 35.4 (1.46) | 36.4 (1.91) | 36.3 (0.538) | 0.502 |
| MS4 | 36.8 (1.08) | 37.6 (0.943) | 36.5 (1.47) | 37.6 (1.02) | 35.9 (0.822) | 36.4 (1.23) | 38.3 (1.52) | 0.33 |
| | N1 | N2 | N3 | N4 | B1 | B2 | B3 | η\hat{ }2 |

TABLE 10
Ankle Joint Work. ANOVA results for ankle joint work reported as mean (std), *
indicates significant (p < 0.05) difference from N1 baseline.
Ankle positive work (J/kg)

| | | | | | | | | |
|---|---|---|---|---|---|---|---|---|
| C01 | 0.168 (0.021) | 0.164 (0.016) | | 0.172 (0.014) | 0.185 (0.021) | 0.174 (0.015) | 0.173 (0.022) | 0.12 |
| C02 | 0.067 (0.011) | 0.078 (0.01) | 0.071 (0.01) | *0.087 (0.011) | 0.07 (0.009) | 0.078 (0.006) | 0.066 (0.006) | 0.39 |
| C04 | 0.16 (0.016) | 0.156 (0.011) | 0.17 (0.036) | 0.158 (0.009) | 0.166 (0.009) | 0.153 (0.014) | 0.148 (0.017) | 0.14 |
| C05 | 0.134 (0.009) | 0.137 (0.008) | 0.129 (0.016) | 0.133 (0.009) | 0.128 (0.017) | 0.133 (0.014) | 0.129 (0.008) | 0.07 |
| MS1 | 0.035 (0.004) | 0.035 (0.006) | 0.042 (0.005) | 0.046 (0.009) | 0.044 (0.008) | *0.054 (0.009) | *0.048 (0.012) | 0.4 |
| MS2 | 0.042 (0.006) | *0.031 (0.004) | *0.033 (0.008) | *0.031 (0.008) | *0.026 (0.004) | 0.038 (0.007) | 0.036 (0.008) | 0.4 |
| MS3 | 0.026 (0.003) | 0.03 (0.002) | 0.025 (0.004) | *0.03 (0.004) | *0.032 (0.004) | 0.023 (0.003) | *0.032 (0.003) | 0.53 |
| MS4 | 0.063 (0.006) | 0.065 (0.008) | 0.066 (0.004) | 0.056 (0.009) | 0.061 (0.004) | 0.061 (0.005) | 0.064 (0.01) | 0.19 |
| | N1 | N2 | N3 | N4 | B1 | B2 | B3 | η\hat{ }2 |

Ankle negative work (J/kg)

| | | | | | | | | |
|---|---|---|---|---|---|---|---|---|
| C01 | 0.099 (0.016) | 0.098 (0.01) | | 0.099 (0.016) | 0.097 (0.014) | 0.097 (0.012) | 0.094 (0.008) | 0.02 |
| C02 | 0.135 (0.015) | 0.148 (0.009) | *0.158 (0.009) | *0.166 (0.016) | *0.158 (0.011) | 0.132 (0.011) | *0.16 (0.012) | 0.53 |
| C04 | 0.128 (0.012) | 0.141 (0.01) | 0.138 (0.01) | 0.135 (0.009) | 0.141 (0.012) | 0.135 (0.013) | 0.131 (0.014) | 0.15 |
| C05 | 0.201 (0.01) | 0.204 (0.013) | 0.198 (0.013) | 0.21 (0.012) | 0.204 (0.015) | 0.213 (0.016) | 0.219 (0.015) | 0.21 |
| MS1 | 0.018 (0.007) | 0.026 (0.007) | 0.028 (0.008) | 0.021 (0.011) | 0.021 (0.006) | 0.022 (0.007) | 0.015 (0.004) | 0.26 |
| MS2 | 0.043 (0.006) | 0.039 (0.005) | *0.031 (0.008) | *0.032 (0.007) | *0.031 (0.006) | *0.028 (0.01) | 0.041 (0.007) | 0.4 |
| MS3 | 0.035 (0.006) | *0.045 (0.006) | 0.034 (0.006) | *0.044 (0.005) | *0.048 (0.006) | 0.038 (0.006) | *0.049 (0.005) | 0.51 |
| MS4 | 0.037 (0.006) | 0.04 (0.005) | 0.033 (0.004) | 0.041 (0.003) | 0.041 (0.005) | 0.04 (0.002) | 0.041 (0.004) | 0.31 |
| | N1 | N2 | N3 | N4 | B1 | B2 | B3 | η\hat{ }2 |

Ankle net work (J/kg)

| | | | | | | | | |
|---|---|---|---|---|---|---|---|---|
| C01 | 0.069 (0.032) | 0.066 (0.018) | | 0.073 (0.018) | 0.088 (0.028) | 0.077 (0.025) | 0.08 (0.023) | 0.08 |
| C02 | −0.068 (0.021) | −0.07 (0.016) | −0.087 (0.014) | −0.079 (0.022) | −0.087 (0.018) | −0.054 (0.016) | *−0.095 | 0.39 |
| C04 | 0.032 (0.018) | 0.015 (0.016) | 0.033 (0.033) | 0.023 (0.016) | 0.025 (0.016) | 0.018 (0.016) | 0.018 (0.017) | 0.11 |
| C05 | −0.067 (0.014) | −0.067 (0.014) | −0.069 (0.021) | −0.077 (0.015) | −0.077 (0.028) | −0.08 (0.022) | −0.09 (0.018) | 0.15 |
| MS1 | 0.017 (0.01) | 0.009 (0.009) | 0.014 (0.008) | 0.025 (0.017) | 0.023 (0.01) | 0.032 (0.014) | 0.033 (0.012) | 0.35 |
| MS2 | −0.001 (0.006) | −0.009 (0.006) | 0.001 (0.007) | −0.001 (0.005) | −0.006 (0.005) | *0.009 (0.012) | −0.005 (0.007) | 0.4 |
| MS3 | −0.009 (0.005) | −0.016 (0.005) | −0.009 (0.003) | −0.014 (0.006) | −0.016 (0.006) | −0.015 (0.007) | *−0.017 | 0.26 |
| MS4 | 0.026 (0.007) | 0.025 (0.012) | 0.033 (0.004) | 0.015 (0.01) | 0.02 (0.006) | 0.021 (0.006) | 0.023 (0.012) | 0.29 |
| | N1 | N2 | N3 | N4 | B1 | B2 | B3 | η\hat{ }2 |

Non-device leg
Ankle positive work (J/kg)

| | | | | | | | | |
|---|---|---|---|---|---|---|---|---|
| C01 | 0.155 (0.013) | 0.175 (0.013) | | 0.169 (0.015) | 0.173 (0.012) | 0.167 (0.021) | 0.153 (0.017) | 0.25 |
| C02 | 0.064 (0.013) | 0.077 (0.012) | 0.067 (0.007) | 0.072 (0.009) | 0.064 (0.01) | 0.069 (0.007) | 0.072 (0.009) | 0.19 |
| C04 | 0.239 (0.112) | 0.204 (0.047) | 0.29 (0.1) | 0.323 (0.121) | 0.155 (0.02) | 0.185 (0.041) | 0.203 (0.08) | 0.33 |
| C05 | 0.119 (0.015) | 0.119 (0.015) | 0.124 (0.02) | 0.121 (0.013) | 0.118 (0.013) | 0.124 (0.015) | 0.128 (0.01) | 0.06 |
| MS1 | 0.058 (0.009) | *0.076 (0.017) | *0.077 (0.012) | *0.09 (0.014) | *0.093 (0.017) | *0.102 (0.013) | *0.084 (0.009) | 0.53 |
| MS2 | 0.014 (0.007) | *0.006 (0.003) | 0.011 (0.007) | 0.011 (0.004) | 0.013 (0.005) | 0.013 (0.005) | 0.015 (0.004) | 0.22 |
| MS3 | 0.052 (0.004) | 0.055 (0.014) | 0.054 (0.006) | 0.047 (0.01) | *0.078 (0.014) | 0.042 (0.007) | 0.059 (0.012) | 0.54 |
| MS4 | 0.074 (0.007) | *0.087 (0.008) | 0.073 (0.011) | *0.05 (0.007) | *0.092 (0.007) | 0.076 (0.01) | 0.084 (0.005) | 0.73 |
| | N1 | N2 | N3 | N4 | B1 | B2 | B3 | η\hat{ }2 |

Ankle negative work (J/kg)

| | | | | | | | | |
|---|---|---|---|---|---|---|---|---|
| C01 | 0.062 (0.008) | 0.069 (0.01) | | 0.073 (0.008) | 0.073 (0.011) | 0.055 (0.008) | 0.052 (0.009) | 0.49 |
| C02 | 0.186 (0.019) | 0.187 (0.016) | 0.195 (0.009) | 0.193 (0.012) | 0.203 (0.015) | 0.174 (0.015) | 0.206 (0.014) | 0.34 |
| C04 | 0.178 (0.029) | 0.151 (0.007) | 0.154 (0.024) | 0.169 (0.025) | 0.152 (0.018) | *0.148 (0.014) | 0.169 (0.013) | 0.25 |
| C05 | 0.182 (0.011) | 0.189 (0.01) | 0.19 (0.016) | 0.192 (0.012) | 0.191 (0.013) | 0.18 (0.013) | 0.191 (0.019) | 0.1 |
| MS1 | 0.059 (0.01) | 0.055 (0.016) | 0.058 (0.009) | 0.062 (0.009) | 0.064 (0.008) | 0.063 (0.007) | 0.058 (0.008) | 0.09 |
| MS2 | 0.018 (0.006) | 0.019 (0.006) | 0.016 (0.007) | 0.013 (0.005) | 0.02 (0.004) | *0.01 (0.005) | 0.015 (0.005) | 0.27 |
| MS3 | 0.083 (0.008) | 0.084 (0.014) | *0.069 (0.014) | 0.075 (0.007) | 0.075 (0.009) | 0.083 (0.012) | 0.079 (0.01) | 0.22 |
| MS4 | 0.03 (0.004) | 0.03 (0.003) | 0.032 (0.002) | *0.054 (0.007) | 0.033 (0.005) | 0.03 (0.003) | 0.034 (0.004) | 0.8 |
| | N1 | N2 | N3 | N4 | B1 | B2 | B3 | η\hat{ }2 |

Ankle net work (J/kg)

| | | | | | | | | |
|---|---|---|---|---|---|---|---|---|
| C01 | 0.093 (0.013) | 0.106 (0.018) | | 0.096 (0.02) | 0.1 (0.013) | 0.112 (0.023) | 0.101 (0.019) | 0.12 |
| C02 | −0.122 (0.028) | −0.11 (0.021) | −0.128 (0.012) | −0.121 (0.018) | −0.139 (0.02) | −0.105 (0.02) | −0.134 (0.018) | 0.26 |
| C04 | 0.061 (0.095) | 0.054 (0.046) | 0.136 (0.08) | 0.154 (0.101) | 0.003 (0.019) | 0.037 (0.033) | 0.034 (0.069) | 0.38 |
| C05 | −0.062 (0.02) | −0.07 (0.018) | −0.066 (0.024) | −0.071 (0.02) | −0.073 (0.021) | −0.056 (0.022) | −0.063 (0.021) | 0.07 |
| MS1 | −0.001 (0.013) | 0.022 (0.028) | 0.019 (0.018) | *0.028 (0.017) | *0.03 (0.02) | *0.04 (0.009) | *0.025 (0.013) | 0.33 |
| MS2 | −0.004 (0.007) | −0.012 (0.007) | −0.005 (0.011) | −0.002 (0.006) | −0.008 (0.006) | 0.003 (0.009) | 0 (0.005) | 0.29 |
| MS3 | −0.032 (0.008) | −0.029 (0.014) | −0.015 (0.014) | −0.028 (0.012) | *0.003 (0.009) | −0.042 (0.011) | −0.02 (0.016) | 0.56 |
| MS4 | 0.043 (0.01) | *0.057 (0.008) | 0.041 (0.012) | *−0.004 (0.011) | *0.059 (0.005) | 0.046 (0.011) | 0.05 (0.008) | 0.83 |
| | N1 | N2 | N3 | N4 | B1 | B2 | B3 | η\hat{ }2 |

TABLE 11
Knee Joint Work. ANOVA results for knee joint work reported as mean (std), *
indicates significant (p < 0.05) difference from N1 baseline.
Device leg
Knee positive work (J/kg)

| | | | | | | | | |
|---|---|---|---|---|---|---|---|---|
| C01 | 0.027 (0.006) | 0.035 (0.008) | | 0.029 (0.008) | 0.022 (0.007) | 0.027 (0.008) | 0.027 (0.011) | 0.191 |
| C02 | 0.071 (0.01) | 0.061 (0.007) | 0.072 (0.008) | 0.084 (0.013) | 0.07 (0.008) | 0.076 (0.012) | 0.081 (0.008) | 0.392 |
| C04 | 0.039 (0.009) | 0.041 (0.006) | 0.036 (0.007) | 0.047 (0.005) | 0.035 (0.006) | 0.039 (0.01) | 0.034 (0.005) | 0.286 |
| C05 | 0.064 (0.007) | *0.081 (0.009) | *0.081 (0.008) | *0.09 (0.006) | *0.08 (0.01) | 0.065 (0.006) | *0.086 (0.006) | 0.614 |
| MS1 | 0.058 (0.014) | 0.076 (0.018) | *0.088 (0.012) | *0.092 (0.021) | *0.097 (0.021) | *0.091 (0.018) | 0.07 (0.008) | 0.41 |
| MS2 | 0.03 (0.009) | 0.043 (0.011) | 0.046 (0.015) | 0.035 (0.016) | 0.027 (0.012) | 0.023 (0.01) | 0.035 (0.011) | 0.313 |
| MS3 | 0.065 (0.004) | *0.054 (0.008) | 0.057 (0.006) | *0.049 (0.01) | 0.063 (0.011) | 0.056 (0.004) | 0.057 (0.006) | 0.355 |
| MS4 | 0.059 (0.012) | 0.047 (0.01) | 0.056 (0.01) | 0.051 (0.011) | 0.048 (0.007) | *0.045 (0.008) | *0.041 (0.008) | 0.293 |
| | N1 | N2 | N3 | N4 | B1 | B2 | B3 | η\hat{ }2 |

Knee negative work (J/kg)

| | | | | | | | | |
|---|---|---|---|---|---|---|---|---|
| C01 | 0.406 (0.027) | 0.403 (0.033) | | 0.409 (0.026) | 0.441 (0.034) | *0.461 (0.023) | 0.425 (0.03) | 0.368 |
| C02 | 0.359 (0.023) | *0.316 (0.021) | *0.317 (0.015) | *0.323 (0.014) | *0.302 (0.021) | *0.333 (0.026) | *0.328 (0.014) | 0.45 |
| C04 | 0.265 (0.016) | 0.265 (0.016) | 0.267 (0.024) | 0.284 (0.018) | 0.245 (0.016) | 0.251 (0.013) | *0.214 (0.021) | 0.592 |
| C05 | 0.238 (0.012) | 0.222 (0.012) | 0.228 (0.017) | *0.196 (0.01) | 0.238 (0.016) | 0.252 (0.011) | 0.235 (0.019) | 0.594 |
| MS1 | 0.128 (0.014) | 0.132 (0.017) | *0.173 (0.022) | *0.177 (0.019) | *0.164 (0.014) | *0.189 (0.022) | 0.131 (0.023) | 0.626 |
| MS2 | 0.106 (0.017) | 0.115 (0.016) | 0.101 (0.015) | 0.111 (0.025) | 0.086 (0.012) | 0.113 (0.019) | *0.135 (0.015) | 0.413 |
| MS3 | 0.038 (0.011) | 0.032 (0.005) | *0.027 (0.005) | 0.027 (0.009) | 0.047 (0.006) | 0.042 (0.007) | 0.037 (0.009) | 0.473 |
| MS4 | 0.078 (0.011) | 0.075 (0.007) | 0.067 (0.007) | *0.06 (0.01) | 0.075 (0.004) | 0.079 (0.008) | 0.086 (0.007) | 0.528 |
| | N1 | N2 | N3 | N4 | B1 | B2 | B3 | η\hat{ }2 |

Knee net work (J/kg)

| | | | | | | | | |
|---|---|---|---|---|---|---|---|---|
| C01 | −0.379 (0.028) | −0.369 (0.035) | | −0.38 (0.028) | *−0.419 (0.037 | *−0.435 (0.023 | −0.398 (0.026) | 0.791 |
| C02 | −0.288 (0.024) | *−0.255 (0.026) | *−0.245 (0.02) | *−0.239 (0.022 | *−0.232 (0.023 | −0.257 (0.033) | *−0.247 (0.019) | 0.356 |
| C04 | −0.225 (0.022) | −0.225 (0.018) | −0.231 (0.028) | −0.237 (0.017) | −0.209 (0.018) | −0.212 (0.018) | *−0.18 (0.023) | 0.75 |
| C05 | −0.175 (0.016) | *−0.142 (0.02) | *−0.147 (0.015 | *−0.106 (0.012 | −0.157 (0.018) | −0.187 (0.013) | *−0.149 (0.019) | 0.974 |
| MS1 | −0.07 (0.021) | −0.056 (0.027) | −0.085 (0.023) | −0.084 (0.028) | −0.067 (0.02) | −0.098 (0.029) | −0.061 (0.025) | 0.639 |
| MS2 | −0.077 (0.017) | −0.072 (0.01) | −0.055 (0.023) | −0.076 (0.031) | −0.059 (0.014) | −0.091 (0.023) | −0.1 (0.015) | 0.604 |
| MS3 | 0.028 (0.011) | 0.021 (0.006) | 0.03 (0.007) | 0.022 (0.009) | 0.016 (0.011) | *0.013 (0.006) | 0.02 (0.009) | 0.897 |
| MS4 | −0.019 (0.013) | −0.027 (0.01) | −0.011 (0.013) | −0.009 (0.016) | −0.026 (0.006) | −0.035 (0.011) | *−0.046 (0.006) | 0.894 |
| | N1 | N2 | N3 | N4 | B1 | B2 | B3 | η\hat{ }2 |

Non-device leg
Knee positive work (J/kg)

| | | | | | | | | |
|---|---|---|---|---|---|---|---|---|
| C01 | 0.029 (0.009) | 0.031 (0.01) | | 0.03 (0.006) | 0.027 (0.009) | 0.023 (0.005) | 0.03 (0.008) | 0.116 |
| C02 | 0.043 (0.008) | 0.034 (0.009) | 0.037 (0.006) | 0.053 (0.009) | 0.035 (0.009) | 0.05 (0.016) | 0.042 (0.011) | 0.346 |
| C04 | 0.123 (0.166) | 0.057 (0.016) | 0.071 (0.047) | 0.113 (0.076) | 0.054 (0.012) | 0.062 (0.012) | 0.056 (0.011) | 0.134 |
| C05 | 0.033 (0.005) | 0.038 (0.007) | 0.033 (0.006) | *0.043 (0.007) | 0.039 (0.006) | 0.039 (0.005) | *0.044 (0.008) | 0.329 |
| MS1 | 0.133 (0.021) | 0.135 (0.023) | 0.119 (0.029) | 0.1 (0.031) | 0.13 (0.041) | 0.103 (0.023) | 0.119 (0.03) | 0.18 |
| MS2 | 0.17 (0.039) | *0.223 (0.014) | *0.208 (0.033) | *0.23 (0.022) | 0.18 (0.017) | *0.217 (0.03) | *0.225 (0.019) | 0.431 |
| MS3 | 0.163 (0.026) | 0.182 (0.026) | 0.183 (0.029) | 0.193 (0.023) | *0.215 (0.049) | 0.155 (0.02) | *0.222 (0.028) | 0.397 |
| MS4 | 0.213 (0.021) | 0.186 (0.037) | 0.24 (0.037) | 0.216 (0.021) | 0.203 (0.028) | 0.229 (0.026) | 0.207 (0.028) | 0.258 |
| | N1 | N2 | N3 | N4 | B1 | B2 | B3 | η\hat{ }2 |

Knee negative work (J/kg)

| | | | | | | | | |
|---|---|---|---|---|---|---|---|---|
| C01 | 0.38 (0.03) | *0.416 (0.024) | | 0.405 (0.019) | 0.404 (0.023) | 0.398 (0.025) | 0.395 (0.031) | 0.168 |
| C02 | 0.464 (0.029) | 0.458 (0.022) | 0.453 (0.032) | 0.451 (0.023) | 0.451 (0.024) | *0.41 (0.019) | 0.448 (0.02) | 0.327 |
| C04 | 0.207 (0.052) | 0.209 (0.025) | 0.215 (0.04) | 0.205 (0.033) | 0.235 (0.011) | 0.222 (0.016) | 0.234 (0.024) | 0.136 |
| C05 | 0.265 (0.022) | *0.239 (0.016) | 0.257 (0.018) | 0.264 (0.019) | 0.26 (0.016) | 0.275 (0.017) | 0.244 (0.017) | 0.317 |
| MS1 | 0.252 (0.028) | 0.276 (0.037) | 0.283 (0.029) | 0.267 (0.043) | 0.269 (0.036) | 0.283 (0.044) | 0.249 (0.024) | 0.125 |
| MS2 | 0.16 (0.017) | 0.167 (0.022) | 0.166 (0.017) | 0.148 (0.018) | 0.14 (0.014) | 0.155 (0.029) | 0.169 (0.018) | 0.219 |
| MS3 | 0.222 (0.023) | 0.249 (0.014) | 0.223 (0.026) | 0.225 (0.009) | *0.253 (0.029) | 0.212 (0.023) | 0.221 (0.024) | 0.318 |
| MS4 | 0.205 (0.016) | 0.192 (0.014) | 0.207 (0.02) | 0.208 (0.013) | 0.197 (0.011) | 0.19 (0.024) | 0.192 (0.017) | 0.167 |
| | N1 | N2 | N3 | N4 | B1 | B2 | B3 | η\hat{ }2 |

Knee net work (J/kg)

| | | | | | | | | |
|---|---|---|---|---|---|---|---|---|
| C01 | −0.351 (0.031) | −0.385 (0.026) | | −0.375 (0.022) | −0.377 (0.023) | −0.376 (0.024) | −0.365 (0.03) | 0.627 |
| C02 | −0.421 (0.031) | −0.424 (0.023) | −0.416 (0.034) | −0.398 (0.03) | −0.416 (0.027) | *−0.36 (0.022) | −0.406 (0.025) | 0.329 |
| C04 | −0.084 (0.218) | −0.152 (0.038) | −0.144 (0.081) | −0.092 (0.103) | −0.182 (0.02) | −0.16 (0.023) | −0.179 (0.028) | 0.755 |
| C05 | −0.233 (0.024) | *−0.201 (0.016) | −0.224 (0.016) | −0.22 (0.019) | −0.221 (0.015) | −0.236 (0.02) | *−0.2 (0.022) | 0.335 |
| MS1 | −0.12 (0.025) | −0.141 (0.055) | 0.164 (0.031) | −0.167 (0.054) | −0.139 (0.058) | −0.179 (0.047) | −0.13 (0.039) | 0.528 |
| MS2 | 0.01 (0.043) | *0.056 (0.026) | 0.041 (0.039) | *0.081 (0.029) | 0.04 (0.016) | *0.062 (0.044) | *0.057 (0.019) | 0.441 |
| MS3 | −0.059 (0.041) | −0.068 (0.025) | −0.04 (0.042) | −0.032 (0.029) | −0.038 (0.056) | −0.057 (0.03) | *0.001 (0.041) | 0.467 |
| MS4 | 0.009 (0.031) | −0.005 (0.046) | 0.033 (0.05) | 0.008 (0.027) | 0.007 (0.031) | 0.039 (0.035) | 0.015 (0.032) | 0.46 |
| | N1 | N2 | N3 | N4 | B1 | B2 | B3 | η\hat{ }2 |

TABLE 12
Hip Joint Work. ANOVA results for hip joint work reported as mean (std), * indicates
significant (p < 0.05) difference from N1 baseline.
Hip positive work (J/kg)

| | | | | | | | | |
|---|---|---|---|---|---|---|---|---|
| C01 | 0.217 (0.013) | 0.207 (0.018) | | 0.211 (0.012) | 0.237 (0.023) | *0.241 (0.018) | *0.266 | 0.64 |
| C02 | 0.242 (0.022) | *0.199 (0.017) | 0.228 (0.017) | 0.235 (0.022) | 0.226 (0.017) | 0.218 (0.019) | 0.223 (0.013) | 0.347 |
| C04 | 0.26 (0.024) | *0.295 (0.023) | 0.262 (0.038) | *0.305 (0.029) | *0.302 (0.02) | *0.36 (0.021) | *0.338 | 0.663 |
| C05 | 0.179 (0.009) | 0.164 (0.008) | *0.133 (0.012) | *0.088 (0.024) | *0.157 (0.01) | *0.198 (0.014) | *0.109 | 0.888 |
| MS1 | 0.11 (0.017) | 0.11 (0.016) | 0.129 (0.019) | 0.124 (0.022) | *0.139 (0.014) | *0.132 (0.011) | 0.105 (0.005) | 0.394 |
| MS2 | 0.043 (0.006) | 0.04 (0.006) | 0.053 (0.012) | 0.046 (0.012) | 0.048 (0.008) | 0.055 (0.019) | 0.054 (0.007) | 0.206 |
| MS3 | 0.051 (0.013) | 0.046 (0.005) | *0.037 (0.006) | *0.039 (0.006) | *0.062 (0.009) | *0.062 (0.007) | *0.064 | 0.648 |
| MS4 | 0.055 (0.004) | 0.059 (0.005) | 0.062 (0.005) | 0.062 (0.007) | *0.088 (0.004) | *0.083 (0.004) | *0.085 | 0.864 |
| | N1 | N2 | N3 | N4 | B1 | B2 | B3 | η\hat{ }2 |

Hip negative work (J/kg)

| | | | | | | | | |
|---|---|---|---|---|---|---|---|---|
| C01 | 0.167 (0.007) | 0.161 (0.008) | | 0.176 (0.007) | *0.151 (0.008) | *0.144 (0.009) | *0.14 (0.013) | 0.692 |
| C02 | 0.147 (0.021) | 0.142 (0.014) | 0.14 (0.01) | 0.157 (0.019) | *0.123 (0.008) | 0.138 (0.009) | 0.129 (0.009) | 0.389 |
| C04 | 0.024 (0.009) | *0.042 (0.009) | *0.034 (0.008) | 0.029 (0.005) | *0.046 (0.008) | *0.006 (0.003) | *0.004 | 0.849 |
| C05 | 0.126 (0.008) | 0.13 (0.012) | *0.298 (0.012) | *0.334 (0.043) | *0.332 (0.011) | 0.126 (0.01) | *0.466 | 0.977 |
| MS1 | 0.28 (0.018) | 0.309 (0.03) | *0.316 (0.03) | 0.307 (0.033) | 0.26 (0.014) | 0.297 (0.011) | 0.256 (0.018) | 0.508 |
| MS2 | 0.131 (0.007) | *0.105 (0.012) | *0.156 (0.017) | 0.147 (0.021) | *0.109 (0.012) | 0.131 (0.022) | 0.12 (0.013) | 0.578 |
| MS3 | 0.145 (0.013) | *0.084 (0.009) | *0.084 (0.008) | *0.106 (0.01) | *0.093 (0.013) | *0.045 (0.012) | *0.084 | 0.874 |
| MS4 | 0.147 (0.008) | 0.163 (0.014) | *0.181 (0.016) | 0.157 (0.016) | *0.096 (0.011) | 0.138 (0.011) | *0.124 | 0.778 |
| | N1 | N2 | N3 | N4 | B1 | B2 | B3 | η\hat{ }2 |

Hip net work (J/kg)

| | | | | | | | | |
|---|---|---|---|---|---|---|---|---|
| C01 | 0.05 (0.015) | 0.046 (0.019) | | 0.035 (0.013) | *0.086 (0.021) | *0.097 (0.02) | *0.126 | 0.791 |
| C02 | 0.095 (0.021) | *0.057 (0.016) | 0.089 (0.018) | 0.078 (0.026) | 0.103 (0.021) | 0.081 (0.018) | 0.093 (0.015) | 0.356 |
| C04 | 0.236 (0.028) | 0.254 (0.027) | 0.228 (0.04) | *0.276 (0.03) | 0.256 (0.023) | *0.354 (0.02) | *0.334 | 0.75 |
| C05 | 0.053 (0.013) | 0.034 (0.012) | *−0.166 (0.014) | *−0.246 (0.057) | *−0.174 (0.016) | 0.072 (0.02) | *−0.357 | 0.974 |
| MS1 | −0.171 (0.017) | *−0.199 (0.023) | −0.187 (0.026) | −0.184 (0.024) | *−0.121 (0.011) | −0.165 (0.013) | −0.151 | 0.639 |
| MS2 | 0.087 (0.009) | *−0.065 (0.013) | −0.103 (0.018) | −0.101 (0.014) | *−0.061 (0.009) | 0.076 (0.017) | *−0.066 | 0.604 |
| MS3 | −0.094 (0.014) | *−0.038 (0.008) | *−0.047 (0.006) | *−0.067 (0.009) | *−0.031 (0.011) | *0.016 (0.017) | *−0.02 | 0.897 |
| MS4 | −0.092 (0.009). | −0.103 (0.013) | *−0.119 (0.012) | −0.095 (0.015) | *−0.008 (0.013) | *−0.055 | *−0.04 (0.02) | 0.894 |
| | N1 | N2 | N3 | N4 | B1 | B2 | B3 | η\hat{ }2 |

Non-device leg
Hip positive work (J/kg)

| | | | | | | | | |
|---|---|---|---|---|---|---|---|---|
| C01 | 0.189 (0.01) | *0.169 (0.016) | | 0.196 (0.013) | 0.189 (0.013) | 0.19 (0.012) | 0.197 (0.017) | 0.325 |
| C02 | 0.288 (0.015) | 0.275 (0.017) | 0.274 (0.011) | 0.288 (0.013) | 0.28 (0.021) | 0.272 (0.012) | 0.281 (0.012) | 0.152 |
| C04 | 0.21 (0.054) | 0.185 (0.019) | 0.212 (0.04) | 0.226 (0.051) | 0.171 (0.015) | 0.183 (0.016) | 0.228 (0.071) | 0.207 |
| C05 | 0.161 (0.009) | 0.158 (0.014) | 0.159 (0.01) | 0.16 (0.009) | *0.144 (0.009) | *0.141 (0.011) | 0.172 (0.012) | 0.49 |
| MS1 | 0.134 (0.018) | 0.125 (0.024) | 0.136 (0.012) | 0.12 (0.02) | 0.107 (0.019) | 0.132 (0.03) | 0.122 (0.017) | 0.183 |
| MS2 | 0.074 (0.013) | 0.08 (0.013) | 0.071 (0.016) | 0.07 (0.017) | 0.071 (0.009) | 0.074 (0.015) | 0.075 (0.012) | 0.059 |
| MS3 | 0.107 (0.008) | 0.116 (0.009) | 0.11 (0.045) | 0.09 (0.006) | 0.092 (0.01) | 0.108 (0.01) | 0.091 (0.008) | 0.235 |
| MS4 | 0.088 (0.005) | 0.093 (0.007) | 0.088 (0.009) | 0.095 (0.004) | 0.082 (0.005) | 0.088 (0.007) | 0.094 (0.006) | 0.345 |
| | N1 | N2 | N3 | N4 | B1 | B2 | B3 | η\hat{ }2 |

Hip negative work (J/kg)

| | | | | | | | | |
|---|---|---|---|---|---|---|---|---|
| C01 | 0.129 (0.008) | *0.164 (0.011) | | *0.143 (0.012) | *0.152 (0.008) | *0.15 (0.007) | *0.17 (0.013) | 0.668 |
| C02 | 0.151 (0.008) | 0.164 (0.009) | 0.14 (0.014) | 0.153 (0.01) | 0.157 (0.007) | *0.168 (0.009) | 0.162 (0.012) | 0.449 |
| C04 | 0.059 (0.01) | 0.06 (0.007) | 0.063 (0.009) | 0.067 (0.009) | 0.068 (0.009) | *0.211 (0.012) | *0.223 (0.017) | 0.979 |
| C05 | 0.101 (0.012) | 0.115 (0.013) | 0.105 (0.009) | 0.106 (0.007) | 0.109 (0.014) | 0.111 (0.011) | *0.128 (0.01) | 0.36 |
| MS1 | 0.109 (0.017) | *0.135 (0.017) | *0.149 (0.014) | *0.168 (0.019) | *0.161 (0.021) | *0.175 (0.012) | *0.147 (0.019) | 0.621 |
| MS2 | 0.195 (0.03) | 0.193 (0.014) | 0.211 (0.024) | 0.184 (0.026) | 0.205 (0.014) | *0.228 (0.021) | *0.229 (0.014) | 0.388 |
| MS3 | 0.083 (0.014) | *0.137 (0.017) | 0.081 (0.014) | *0.104 (0.014) | 0.091 (0.009) | *0.064 (0.009) | 0.091 (0.008) | 0.767 |
| MS4 | 0.054 (0.004) | *0.072 (0.008) | *0.074 (0.006) | 0.058 (0.01) | 0.052 (0.002) | *0.067 (0.012) | *0.079 (0.01) | 0.621 |
| | N1 | N2 | N3 | N4 | B1 | B2 | B3 | η\hat{ }2 |

Hip net work (J/kg)

| | | | | | | | | |
|---|---|---|---|---|---|---|---|---|
| C01 | 0.059 (0.014) | *0.005 (0.017) | | 0.053 (0.01) | *0.037 (0.016) | *0.04 (0.011) | *0.026 (0.017) | 0.627 |
| C02 | 0.136 (0.017) | *0.111 (0.02) | 0.134 (0.01) | 0.135 (0.012) | 0.123 (0.026) | *0.103 (0.013) | 0.119 (0.021) | 0.329 |
| C04 | 0.151 (0.052) | 0.124 (0.02) | 0.148 (0.033) | 0.159 (0.046) | 0.103 (0.014) | *−0.029 (0.017) | *0.004 (0.075) | 0.755 |
| C05 | 0.06 (0.014) | 0.043 (0.017) | 0.054 (0.011) | 0.053 (0.01) | *0.035 (0.014) | *0.03 (0.02) | 0.045 (0.016) | 0.335 |
| MS1 | 0.026 (0.022) | *−0.01 (0.026) | *−0.013 (0.018) | *−0.048 (0.028) | *−0.054 (0.023) | *−0.043 (0.033) | *−0.025 (0.027) | 0.528 |
| MS2 | −0.12 (0.022) | −0.113 (0.013) | −0.14 (0.017) | −0.114 (0.019) | −0.134 (0.017) | *−0.155 (0.029) | *−0.153 (0.014) | 0.441 |
| MS3 | 0.024 (0.017) | *−0.021 (0.014) | 0.029 (0.057) | *−0.015 (0.011) | 0.001 (0.013) | 0.044 (0.013) | −0.001 (0.012) | 0.467 |
| MS4 | 0.035 (0.005) | *0.021 (0.007) | *0.014 (0.011) | 0.038 (0.011) | 0.03 (0.007) | *0.021 (0.012) | *0.016 (0.014) | 0.46 |
| | N1 | N2 | N3 | N4 | B1 | B2 | B3 | η\hat{ }2 |

TABLE 13
Muscle activity ANOVA results for muscle activity in the device-wearing leg
reported as mean (std), * indicates significant (p < 0.05) difference from N1 baseline.
Tibialis anterior (TA) average normalized muscle activity

| | | | | | | | | |
|---|---|---|---|---|---|---|---|---|
| C01 | 0.235 (0.019) | 0.225 (0.016) | | 0.22 (0.015) | 0.235 (0.021) | *0.261 (0.024) | *0.271 (0.02) | 0.504 |
| C02 | 0.292 (0.02) | | 0.293 (0.052) | 0.289 (0.043) | 0.322 (0.029) | 0.329 (0.023) | 0.276 (0.022) | 0.261 |
| C03 | 0.254 (0.017) | 0.233 (0.016) | 0.23 (0.016) | 0.223 (0.024) | 0.236 (0.039) | 0.244 (0.016) | *0.22 (0.026) | 0.201 |
| C04 | 0.271 (0.016) | *0.252 (0.019) | *0.248 (0.012) | *0.233 (0.013) | *0.233 (0.009) | *0.241 (0.014) | *0.235 (0.012) | 0.495 |
| MS1 | 0.307 (0.022) | *0.25 (0.022) | *0.208 (0.007) | *0.229 (0.016) | *0.232 (0.016) | *0.228 (0.011) | *0.232 (0.016) | 0.777 |
| MS2 | 0.338 (0.025) | | 0.356 (0.038) | 0.341 (0.025) | *0.412 (0.021) | 0.35 (0.038) | 0.357 (0.029) | 0.427 |
| MS3 | 0.312 (0.01) | 0.327 (0.008) | 0.31 (0.023) | *0.342 (0.011) | *0.332 (0.016) | 0.303 (0.01) | *0.341 (0.008) | 0.569 |
| MS4 | 0.329 (0.031) | 0.327 (0.012) | *0.289 (0.018) | *0.281 (0.016) | *0.282 (0.021) | 0.356 (0.014) | 0.327 (0.026) | 0.652 |
| MS5 | 0.261 (0.037) | 0.312 (0.039) | 0.297 (0.048) | 0.259 (0.023) | *0.337 (0.018) | 0.278 (0.07) | 0.278 (0.024) | 0.319 |
| | N1 | N2 | N3 | N4 | B1 | B2 | B3 | η\hat{ }2 |

Gastrocnemius lateralis (GAS) average normalized muscle activity

| | | | | | | | | |
|---|---|---|---|---|---|---|---|---|
| C01 | 0.38 (0.037) | *0.329 (0.024) | | *0.327 (0.031) | 0.354 (0.029) | 0.349 (0.023) | 0.353 (0.028) | 0.296 |
| C02 | 0.318 (0.049) | | 0.336 (0.051) | *0.395 (0.062) | *0.415 (0.036) | *0.389 (0.034) | 0.372 (0.045) | 0.364 |
| C03 | 0.328 (0.031) | 0.348 (0.021) | *0.373 (0.027) | *0.427 (0.03) | 0.34 (0.043) | *0.405 (0.024) | 0.354 (0.033) | 0.575 |
| C04 | 0.207 (0.022) | 0.223 (0.014) | 0.206 (0.017) | 0.188 (0.019) | 0.195 (0.012) | 0.187 (0.016) | 0.205 (0.022) | 0.33 |
| MS1 | 0.419 (0.05) | *0.339 (0.044) | 0.417 (0.039) | *0.327 (0.026) | *0.307 (0.027) | 0.352 (0.025) | 0.425 (0.102) | 0.476 |
| MS2 | 0.476 (0.026) | | *0.393 (0.022) | *0.377 (0.026) | *0.367 (0.034) | *0.426 (0.037) | 0.466 (0.051) | 0.629 |
| MS4 | 0.52 (0.029) | 0.501 (0.036) | 0.507 (0.022) | 0.496 (0.031) | *0.455 (0.021) | *0.463 (0.028) | 0.512 (0.036) | 0.406 |
| MS5 | 0.472 (0.017) | *0.62 (0.033) | *0.606 (0.035) | *0.665 (0.045) | *0.637 (0.023) | *0.599 (0.021) | *0.66 (0.038) | 0.802 |
| | N1 | N2 | N3 | N4 | B1 | B2 | B3 | η\hat{ }2 |

Soleus (SOL) average normalized muscle activity

| | | | | | | | | |
|---|---|---|---|---|---|---|---|---|
| C01 | 0.282 (0.048) | *0.233 (0.014) | | *0.187 (0.007) | 0.263 (0.039) | *0.238 (0.018) | *0.161 (0.01) | 0.719 |
| C02 | 0.609 (0.026) | | 0.635 (0.027) | *0.719 (0.041) | *0.703 (0.058) | 0.651 (0.019) | 0.651 (0.026) | 0.564 |
| C03 | 0.307 (0.021) | *0.254 (0.014) | 0.297 (0.018) | *0.262 (0.017) | *0.266 (0.013) | *0.249 (0.017) | *0.224 (0.011) | 0.746 |
| C04 | 0.357 (0.027) | 0.341 (0.03) | 0.332 (0.018) | 0.336 (0.021) | 0.359 (0.031) | 0.336 (0.021) | 0.344 (0.019) | 0.155 |
| MS1 | 0.517 (0.027) | 0.535 (0.036) | 0.498 (0.032) | 0.517 (0.039) | 0.483 (0.031) | 0.49 (0.026) | 0.479 (0.031) | 0.286 |
| MS2 | 0.41 (0.026) | | *0.335 (0.023) | *0.328 (0.018) | *0.324 (0.026) | 0.381 (0.034) | *0.371 (0.016) | 0.646 |
| MS3 | 0.381 (0.015) | 0.383 (0.027) | *0.347 (0.015) | 0.407 (0.024) | 0.401 (0.019) | 0.403 (0.04) | *0.441 (0.021) | 0.572 |
| MS4 | 0.484 (0.026) | 0.497 (0.034) | 0.492 (0.028) | 0.454 (0.025) | 0.49 (0.023) | 0.471 (0.018) | 0.52 (0.034) | 0.349 |
| MS5 | 0.423 (0.098) | 0.371 (0.023) | 0.417 (0.016) | 0.434 (0.032) | 0.437 (0.011) | 0.419 (0.02) | *0.481 (0.032) | 0.356 |
| | N1 | N2 | N3 | N4 | B1 | B2 | B3 | η\hat{ }2 |

Vastus lateralis (VAS) normalized muscle activity

| | | | | | | | | |
|---|---|---|---|---|---|---|---|---|
| C01 | 0.189 (0.024) | *0.154 (0.012) | | *0.139 (0.021) | *0.218 (0.013) | *0.225 (0.02) | *0.227 (0.016) | 0.805 |
| C02 | 0.21 (0.016) | | | 0.202 (0.028) | *0.449 (0.271) | *0.638 (0.036) | 0.245 (0.036) | 0.676 |
| C03 | 0.413 (0.024) | 0.4 (0.021) | 0.381 (0.019) | 0.381 (0.034) | 0.426 (0.023) | 0.445 (0.022) | *0.45 (0.03) | 0.545 |
| C04 | 0.184 (0.015) | 0.192 (0.018) | 0.204 (0.014) | *0.219 (0.016) | *0.221 (0.022) | *0.228 (0.025) | 0.188 (0.028) | 0.415 |
| MS1 | 0.474 (0.034) | 0.46 (0.038) | *0.421 (0.037) | 0.45 (0.034) | 0.466 (0.049) | *0.53 (0.024) | 0.465 (0.025) | 0.458 |
| MS2 | 0.533 (0.017) | | *0.464 (0.029) | *0.502 (0.03) | *0.566 (0.014) | *0.638 (0.027) | *0.597 (0.013) | 0.879 |
| MS3 | 0.48 (0.027) | 0.444 (0.045) | *0.619 (0.031) | *0.554 (0.04) | *0.562 (0.034) | 0.495 (0.039) | 0.514 (0.025) | 0.728 |
| MS4 | 0.317 (0.011) | *0.29 (0.023) | 0.306 (0.013) | 0.311 (0.016) | *0.279 (0.013) | 0.302 (0.016) | 0.305 (0.011) | 0.41 |
| MS5 | 0.592 (0.049) | *0.736 (0.09) | 0.649 (0.047) | 0.656 (0.034) | *0.761 (0.052) | *0.908 (0.136) | *0.711 (0.079) | 0.628 |
| | N1 | N2 | N3 | N4 | B1 | B2 | B3 | η\hat{ }2 |

Rectus femoris (RF) average normalized muscle activity

| | | | | | | | | |
|---|---|---|---|---|---|---|---|---|
| C01 | 0.351 (0.019) | 0.321 (0.021) | | *0.299 (0.018) | *0.418 (0.03) | *0.496 (0.045) | *0.446 (0.049) | 0.837 |
| C02 | 0.551 (0.065) | | 0.526 (0.064) | *0.446 (0.038) | *0.657 (0.043) | *0.464 (0.047) | *0.283 (0.021) | 0.859 |
| C03 | 0.463 (0.024) | *0.412 (0.022) | 0.479 (0.028) | 0.486 (0.021) | 0.448 (0.021) | 0.444 (0.027) | 0.466 (0.02) | 0.521 |
| C04 | 0.374 (0.02) | 0.36 (0.011) | 0.376 (0.019) | 0.39 (0.013) | 0.36 (0.018) | 0.364 (0.022) | *0.344 (0.014) | 0.411 |
| MS1 | 0.579 (0.024) | *0.517 (0.02) | *0.492 (0.019) | | *0.486 (0.019) | *0.501 (0.023) | *0.525 (0.017) | 0.721 |
| MS2 | 0.578 (0.031) | | 0.604 (0.022) | 0.605 (0.028) | 0.6 (0.023) | 0.586 (0.021) | *0.627 (0.036) | 0.269 |
| MS3 | 0.554 (0.015) | 0.533 (0.027) | 0.574 (0.02) | 0.55 (0.03) | *0.594 (0.026) | 0.57 (0.022) | *0.593 (0.028) | 0.451 |
| MS4 | 0.507 (0.019) | *0.476 (0.025) | 0.48 (0.018) | *0.452 (0.022) | *0.444 (0.024) | 0.486 (0.016) | 0.486 (0.031) | 0.462 |
| MS5 | 0.614 (0.034) | 0.642 (0.048) | 0.579 (0.05) | *0.512 (0.025) | 0.63 (0.033) | 0.657 (0.038) | 0.588 (0.047) | 0.587 |
| | N1 | N2 | N3 | N4 | B1 | B2 | B3 | η\hat{ }2 |

Biceps femoris (HAM) average normalized muscle activity

| | | | | | | | | |
|---|---|---|---|---|---|---|---|---|
| C01 | 0.313 (0.024) | 0.285 (0.012) | | | 0.343 (0.021) | *0.352 (0.032) | 0.326 (0.032) | 0.493 |
| C02 | 0.346 (0.016) | | 0.319 (0.032) | *0.466 (0.032) | 0.328 (0.012) | 0.337 (0.02) | 0.323 (0.018) | 0.847 |
| C03 | 0.291 (0.056) | *0.206 (0.032) | | *0.173 (0.022) | *0.192 (0.028) | *0.196 (0.016) | *0.146 (0.014) | 0.695 |
| C04 | 0.233 (0.022) | 0.257 (0.027) | 0.207 (0.014) | *0.192 (0.009) | *0.273 (0.021) | 0.257 (0.032) | *0.315 (0.026) | 0.763 |
| MS1 | 0.46 (0.059) | | *0.352 (0.05) | *0.327 (0.044) | *0.301 (0.048) | *0.317 (0.039) | *0.361 (0.051) | 0.459 |
| MS2 | 0.427 (0.034) | | 0.396 (0.038) | 0.464 (0.025) | 0.389 (0.044) | *0.526 (0.028) | 0.442 (0.047) | 0.556 |
| MS3 | 0.526 (0.03) | 0.5 (0.025) | 0.531 (0.028) | 0.493 (0.019) | 0.494 (0.021) | *0.565 (0.032) | *0.661 (0.026) | 0.632 |
| MS5 | 0.588 (0.019) | 0.619 (0.028) | 0.628 (0.021) | 0.612 (0.047) | *0.668 (0.042) | 0.619 (0.032) | 0.627 (0.035) | 0.329 |
| | N1 | N2 | N3 | N4 | B1 | B2 | B3 | η\hat{ }2 |

Abdominal obliques (AB) normalized muscle activity

| | | | | | | | | |
|---|---|---|---|---|---|---|---|---|
| C01 | 0.363 (0.017) | 0.377 (0.028) | | *0.425 (0.028) | 0.387 (0.035) | 0.375 (0.024) | 0.366 (0.032) | 0.379 |
| C02 | 0.891 (0.032) | | 0.911 (0.045) | 0.931 (0.026) | 0.884 (0.033) | 0.923 (0.052) | 0.944 (0.072) | 0.193 |
| C03 | 0.45 (0.028) | *0.36 (0.023) | *0.389 (0.018) | *0.406 (0.019) | *0.391 (0.023) | *0.405 (0.028) | *0.379 (0.035) | 0.538 |
| C04 | 0.683 (0.044) | 0.677 (0.033) | *0.835 (0.07) | *0.915 (0.062) | 0.65 (0.045) | *0.607 (0.034) | *0.596 (0.044) | 0.851 |
| MS | 0.6 (0.049) | *0.38 (0.018) | *0.363 (0.017) | *0.503 (0.043) | *0.439 (0.029) | *0.351 (0.018) | *0.352 (0.013) | 0.905 |
| MS2 | 0.378 (0.031) | | 0.383 (0.032) | 0.385 (0.037) | *0.465 (0.046) | 0.342 (0.039) | *0.444 (0.047) | 0.561 |
| MS3 | 0.71 (0.015) | 0.746 (0.019) | | 0.703 (0.032) | *3.05 (3.23) | | | 0.304 |
| MS4 | 0.737 (0.019) | 0.711 (0.023) | *0.686 (0.02) | *0.693 (0.029) | *0.683 (0.021) | *0.693 (0.027) | *0.687 (0.024) | 0.393 |
| MS5 | 0.625 (0.071) | 0.7 (0.074) | *0.476 (0.041) | 0.568 (0.051) | 0.698 (0.063) | *0.533 (0.08) | 0.647 (0.063) | 0.621 |
| | N1 | N2 | N3 | N4 | B1 | B2 | B3 | η\hat{ }2 |

Latissimus dorsi (LAT) normalized muscle activity

| | | | | | | | | |
|---|---|---|---|---|---|---|---|---|
| C01 | 0.409 (0.027) | *0.375 (0.021) | | *0.205 (0.014) | *0.265 (0.013) | *0.341 (0.019) | *0.367 (0.017) | 0.938 |
| C02 | 0.56 (0.037) | | *0.648 (0.046) | *0.817 (0.063) | 0.592 (0.057) | 0.57 (0.034) | *0.665 (0.037) | 0.793 |
| C03 | 0.332 (0.042) | 0.349 (0.045) | *0.428 (0.042) | *0.434 (0.044) | 0.344 (0.02) | *0.472 (0.026) | 0.346 (0.071) | 0.61 |
| C04 | 0.315 (0.032) | 0.29 (0.034) | 0.302 (0.012) | *0.364 (0.045) | 0.338 (0.038) | 0.313 (0.021) | 0.311 (0.041) | 0.337 |
| MS1 | 0.669 (0.027) | *0.55 (0.041) | *0.548 (0.026) | | 0.717 (0.05) | *0.761 (0.049) | *0.578 (0.028) | 0.844 |
| MS2 | 0.537 (0.031) | | *0.605 (0.046) | *0.589 (0.03) | 0.576 (0.026) | 0.521 (0.036) | 0.507 (0.018) | 0.583 |
| MS3 | 0.316 (0.032) | 0.323 (0.041) | *0.387 (0.03) | 0.3 (0.036) | 0.281 (0.016) | *0.265 (0.013) | 0.347 (0.042) | 0.613 |
| MS4 | 0.495 (0.035) | *0.458 (0.019) | 0.474 (0.017) | 0.508 (0.018) | 0.493 (0.018) | *0.452 (0.013) | 0.512 (0.02) | 0.545 |
| MS5 | 0.292 (0.037) | 0.343 (0.045) | 0.246 (0.019) | 0.241 (0.009) | *0.359 (0.089) | 0.268 (0.014) | *0.356 (0.054) | 0.545 |
| | N1 | N2 | N3 | N4 | B1 | B2 | B3 | η\hat{ }2 |

### Example 7: Use of Bayesian Optimization and Neuromusculoskeletal Simulation to Configure a Personalizable and Bilateral Hip Flexion Exosuit that Minimizes Asymmetric Hip Muscle Activity of Individuals with MS

Soft “exosuits” are assistive devices that deliver parallel joint torques to the user while maintaining a clothing-like form factor. Exosuits are flexible, providing assistance with fewer restrictions to range of motion and user size and shape than rigid designs. This flexibility also produces a dauntingly large design space to explore-parameters ranging from the placement and control of actuators to the anthropometrics and movement abilities of the user. To create exosuits capable of targeting an individual's specific needs, it is important to develop methods for efficiently narrowing down these design spaces, particularly regarding users who may not be able to perform sustained walking bouts, which are typically used for real-time optimization of a device in experimental settings. Therefore, a predictive system for selecting the configurations of soft exosuits was presented that best satisfy specific goals of altering the muscle activations of individual users by using Bayesian optimization with musculoskeletal simulation.

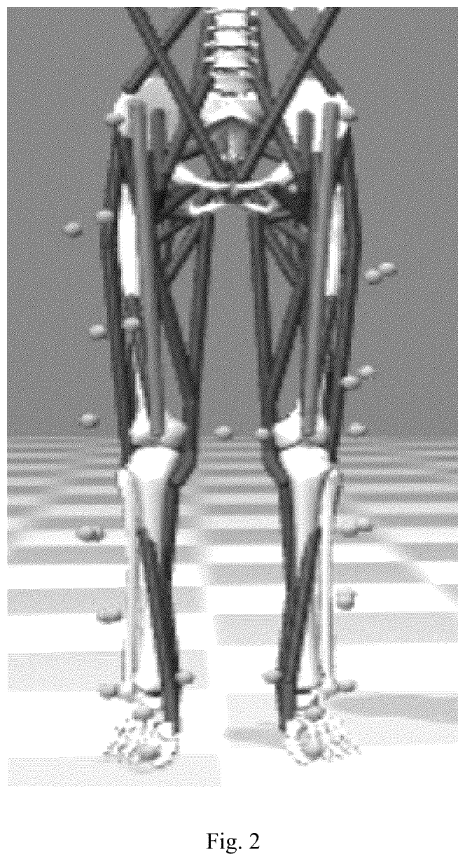

The performance of a passive, bilateral, hip flexion assistance device (FIG. 2) was optimized by simulating its performance on neuromusculoskeletal models of people with MS. The device must be adjusted to meet the needs of the individual user, and should account for factors including the user's functional abilities as well as their size and shape. User surface geometry is used to inform the behavior of the device [B. Park and M. P. Reed, “BioHuman Human Shapes,” 2020. humanshape.org (accessed Aug. 6, 2021)], and the resting length and stiffness of the passive elements on each leg of the device are iteratively adjusted using Bayesian optimization, a technique that is useful for problems where the cost function is expensive to evaluate [E. Brochu, V. M. Cora, and N. de Freitas, “A Tutorial on Bayesian Optimization of Expensive Cost Functions, with Application to Active User Modeling and Hierarchical Reinforcement Learning,” 2010, [Online]. Available: http://arxiv.org/abs/1012.2599], such as computationally intensive simulations or human-in-the-loop physical experiments [M. Kim et al., “Human-in-the-loop Bayesian optimization of wearable device parameters,” PLoS One, vol. 12, no. 9, pp. 6-8, 2017, doi: 10.1371/journal.pone.0184054] where the subjects may fatigue quickly, as is common in people with MS [A. R. Salter, G. R. Cutter, T. E. Bacon, and J. Herbert, “Disability in multiple sclerosis,” Neurology, vol. 80, pp. 1018-1024, 2013].

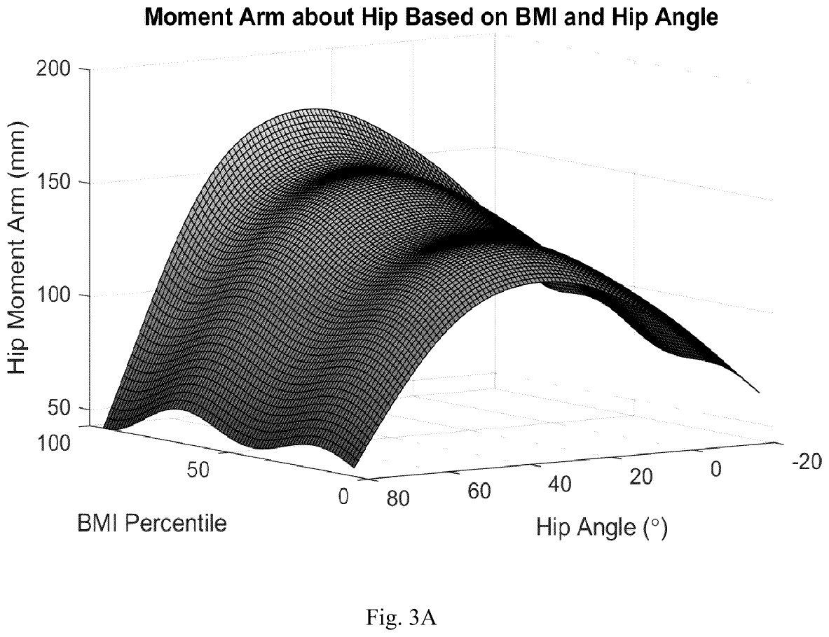

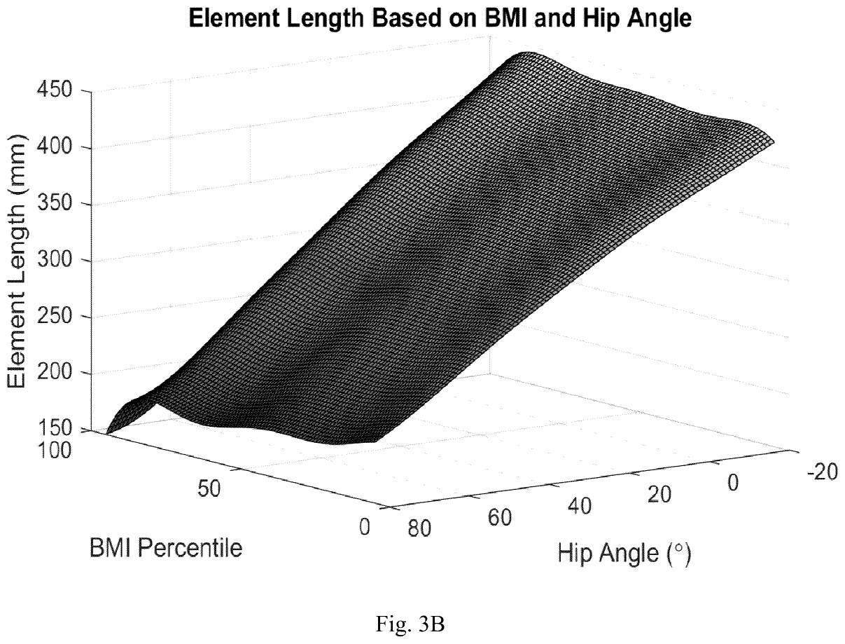

Experimentally-recorded kinematics are input into the model, which inform the position of bones in a skeleton that controls deformation of the mesh representing a subject's body surface. After deforming the mesh, a wrapping algorithm is used to determine the path that the actuator/contracting element takes between prescribed attachment locations—the actuator must conform to the shape the body, but still take the shortest path over concavities, as a flexible element under tension would. Finally, the length of the actuator and its moment arm about the joint(s) it spans are calculated to inform device performance. For this modeling pipeline, Gaussian process regression was used to make smooth predictive surfaces that output the moment arm and contracting element length based on user BMI and hip angle (FIG. 3A & FIG. 3B).

Experimental data collected from human subjects with MS walking at a self-selected pace was used to scale a musculoskeletal model and run inverse kinematics (IK) and inverse dynamics (ID) to obtain estimates of the moments generated at each joint. Using device parameters (resting length and stiffness of passive elements), the contributions of the device to hip moments were calculated and subtracted from the hip moments calculated in ID. Static optimization is performed to obtain a solution for the muscle activations that matches the adjusted ID moments, which are then used to calculate the cost function for the Bayesian optimization of device parameters. This cost function is calculated as the difference in average activations of the modeled hip flexors (sartorius, iliacus, psoas, rectus femoris) between the left and right legs. Bayesian optimization is used to iteratively update device parameters until the ideal device configuration for reducing hip flexor asymmetry is obtained (FIG. 4A).

The optimization workflow was able to reduce the hip flexor asymmetries in all three subjects modeled, with MS2 essentially removing asymmetry in average hip flexor activations. In 20 iterations performed after seeding, the best configurations were reached in 11, 14, and 2 optimizer iterations (Table 14, FIG. 6A, FIG. 6B & FIG. 6C), which demonstrates the efficiency of Bayesian optimization for minimizing expensive cost functions. Both MS2 and MS3 used stiffer bands on the stronger leg, while MS1 used stiffer bands on the weaker leg. Most rest lengths were close to the upper limit of 0.5 m, with the exception of the weaker leg on MS2.

TABLE 14
Optimization Results

| Subject ID | MS1 | MS2 | MS3 |
|---|---|---|---|
| Inter-limb hip flexion | 0.7613 | 0.1527 | 0.1849 |
| asymmetry (no device) | | | |
| Inter-limb hip flexion | 0.3799 | 0.0019 | 0.1584 |
| asymmetry (minimized) | | | |
| Rest length | 0.477/0.481 | 0.465/0.289 | 0.500/0.409 |
| strong/weak (m) | | | |
| Stiffness strong/weak (N/m) | 356.6/446.3 | 562.6/486.4 | 597.2/535.25 |
| # Iterations | 11 | 14 | 2 |

The problem of efficiently optimizing walking assistive devices has been explored before, primarily in the context of improving metabolic cost of walking during experiments. These human-in-the-loop approaches to tuning devices are an important development in addressing user-specific assistive needs, however the amount of walking required for metabolic studies exceeds what some patient populations are capable of, and metabolic consumption does not reflect the activations of specific muscle groups that may be the target of device assistance. In this work, it was demonstrated how a single device may need to be configured quite differently to assist different people within the same patient population, and a way to estimate these setups efficiently using computational musculoskeletal simulations and Bayesian optimization was shown. This work gives motivation to extend this framework to include parameters such as actuator locations and neuromuscular considerations like activation time constants as seen in Example 4 above.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A soft exosuit device, comprising:
a belt comprising a plurality of loops attached thereto, and a plurality of attachment regions between each loop on the belt, configured to be positioned around a subject;
one or more brackets slidably attached to the belt and positionable within the one or more attachment regions, each bracket comprising one or more belt attachment points;
at least one brace comprising one or more brace attachment points configured to be positioned around a body part of the subject;
at least one element comprising a first fastener at a proximal end removably attached to a belt attachment point and a second fastener at a distal end, removably attached to a brace attachment point.

2. The device of claim 1, wherein the belt comprises a base layer and an outer belt, both extending the length of the belt, the base layer comprising the plurality of loops, and the outer belt passing through the loops of the base layer, with the brackets slidably attached to the outer belt, each bracket positioned within an attachment region.

3. The device of claim 1, wherein the one or more brackets comprise a first bracket positioned in a medial attachment region on the belt providing a medial belt attachment point, and a second bracket positioned in a lateral attachment region on the belt providing a lateral belt attachment point.

4. The device of claim 3, wherein the one or more attachment points on the brace comprise a left lateral brace attachment point and a right lateral brace attachment point.

5. The device of claim 4, wherein the at least one element comprises a first element attached to the medial belt attachment point and the right lateral brace attachment point, and a second element attached to the lateral belt attachment point and the left lateral brace attachment point.

6. The device of claim 1, further comprising a pair of adjustable suspenders fixedly attached to the belt and configured to be positioned over shoulders of the subject.

7. The device of claim 1, wherein the elements are elastic resistance bands having a stiffness ranging between 1 N/m and 1000 N/m.

8. The device of claim 1, wherein the elements comprise elements selected from the group consisting of: elastic bands, resistance bands, linear actuators, motor-actuated cables, springs and struts.

9. The device of claim 2, wherein the belt has a total number of loops ranging between 2 and 40 loops.

10. The device of claim 2, wherein the base layer comprises neoprene and the outer belt comprises nylon.

11. The device of claim 1, wherein the belt comprises one or more adjusters along the length of the belt configured to adjust the length of the belt.

12. The device of claim 1, wherein the elements comprise one or more adjusters along the length of the elements configured to adjust the length of the elements.

13. The device of claim 1, wherein the fasteners are selected from the group consisting of hooks, clips, buckles, clasps, buttons, snaps, toggles and hook and loop.

14. A method of designing a soft exosuit device, comprising the steps of:
providing one or more biomechanical goals for a subject;
providing an exosuit device of claim 1 to the subject;
positioning the one or more brackets to one or more attachment regions along the length of the belt;
adjusting the elements to achieve the one or more biomechanical goals.

15. The method of claim 14, wherein configuring the device comprises adjusting the position of the device on the subject vertically or rotating the device mediolaterally.

16. The method of claim 14, wherein positioning the one or more brackets to the one or more attachment regions comprises positioning a first bracket to a medial attachment region on the belt, and a second bracket to a lateral attachment region on the belt.

17. The method of claim 14, wherein adjusting the elements comprises applying a preload to the elements.

18. The method of claim 14, wherein adjusting the elements comprises any of adjusting the stiffness, elongation or rest length of the elements.

19. The method of claim 14, wherein adjusting the elements comprises adjusting the length or width of the bands.

20. The method of claim 14, wherein the one or more biomechanical goals are selected from the group consisting of: a kinematic goal, influencing the kinematics of a limb, influencing a desired motion in a limb, increasing/decreasing flexion of a joint, increasing/decreasing extension of a joint, modulating internal/external rotation of a joint, increasing/decreasing kinematic asymmetry between the limbs, increasing/decreasing inter-limb muscle activation asymmetry, reducing the metabolic cost of movement in the subject, and reducing the swinging of a limb on the subject.

21. A method of fabricating an exosuit for assisting at least one movement of a subject, comprising:
generating an estimated surface mesh of a subject;
calculating an estimated controlling skeleton within the surface mesh, comprising a set of joint vertices and edges;
calculating a set of poses which, performed successively, form the at least one movement;
calculating a set of lines of action, each having a first and second attachment point on the surface mesh and a corresponding moment arm about a corresponding joint vertex of the set of joint vertices;
calculating a maximum power generating ability of each line of action;
selecting a desired line of action from the set of lines of action having the maximum power generating ability about the corresponding joint vertex across the poses in the set of poses; and
building an exosuit having an element attached at the first and second attachment points of the desired line of action.

22. The method of claim 21, wherein the element comprises a hip flexion element, a spring, a linear actuator, a motor-actuated cable, an elastic band, or a strut configured to assist in movement of a hip of the subject.

23. The method of claim 21, wherein the exosuit is configured to be anchored to a waist of the subject.

24. The method of claim 21, wherein the at least one movement is a stride.

25. The method of claim 24, wherein the stride is selected from a level stride, an inclined stride, or a staircase climbing stride.

26. The method of claim 21, wherein the first and second attachment points are on a waist and a thigh of the subject, respectively.

27. An exosuit produced by the method of claim 21, further comprising at least one motor configured to dynamically modulate the first or second attachment position.

28. The exosuit of claim 27, wherein the at least one motor is configured to dynamically modulate the first or second attachment position during ambulation of the subject.
